(19) United States
(12) Patent Application Publication
(10) Pub. No.: US 2015/0138086 A1
(43) Pub. Date: May 21, 2015

(54) CALIBRATING CONTROL DEVICE FOR USE WITH SPATIAL OPERATING SYSTEM

(71) Applicants: John S. UNDERKOFFLER, Los Angeles, CA (US); Kwindla Hultman KRAMER, Los Angeles, CA (US)

(72) Inventors: John S. UNDERKOFFLER, Los Angeles, CA (US); Kwindla Hultman KRAMER, Los Angeles, CA (US)

(21) Appl. No.: 14/206,800

(22) Filed: Mar. 12, 2014

Related U.S. Application Data
(63) Continuation-in-part of application No. 12/572,689, filed on Oct. 2, 2009, now Pat. No. 8,866,740.
Application No. 12/572,689 is a continuation-in-part of application No. 12/572,698, filed on Oct. 2, 2009, now Pat. No. 8,830,168.
Application No. 12/572,698 is a continuation-in-part of application No. 13/850,837, filed on Mar. 26, 2013.
Application No. 13/850,837 is a continuation-in-part of application No. 12/417,252, filed on Apr. 2, 2009.
Application No. 12/417,252 is a continuation-in-part of application No. 12/487,623, filed on Jun. 18, 2009.
Application No. 12/487,623 is a continuation-in-part of application No. 12/553,845, filed on Sep. 3, 2009, now Pat. No. 8,531,396.
Application No. 12/553,845 is a continuation-in-part of application No. 12/553,902, filed on Sep. 3, 2009, now Pat. No. 8,537,111.
Application No. 12/553,902 is a continuation-in-part of application No. 12/553,929, filed on Sep. 3, 2009, now Pat. No. 8,537,112.
Application No. 12/553,929 is a continuation-in-part of application No. 12/557,464, filed on Sep. 10, 2009.
Application No. 12/557,464 is a continuation-in-part of application No. 12/579,340, filed on Oct. 14, 2009.
Application No. 12/579,340 is a continuation-in-part of application No. 13/759,472, filed on Feb. 5, 2013.
Application No. 13/759,472 is a continuation-in-part of application No. 12/579,372, filed on Oct. 14, 2009.
Application No. 12/579,372 is a continuation-in-part of application No. 12/773,605, filed on May 4, 2010, now Pat. No. 8,681,098.
Application No. 12/773,605 is a continuation-in-part of application No. 12/773,667, filed on May 4, 2010, now Pat. No. 8,723,795.
Application No. 12/773,667 is a continuation-in-part of application No. 12/789,129, filed on May 27, 2010.
Application No. 12/789,129 is a continuation-in-part of application No. 12/789,262, filed on May 27, 2010, now Pat. No. 8,669,939.
Application No. 12/789,262 is a continuation-in-part of application No. 12/789,302, filed on May 27, 2010, now Pat. No. 8,665,213.
Application No. 12/789,302 is a continuation-in-part of application No. 13/430,509, filed on Mar. 26, 2012, now Pat. No. 8,941,588.
Application No. 13/430,509 is a continuation-in-part of application No. 13/430,626, filed on Mar. 26, 2012, now Pat. No. 8,896,531.
Application No. 13/430,626 is a continuation-in-part of application No. 13/532,527, filed on Jun. 25, 2012, now Pat. No. 8,941,589.
Application No. 13/532,527 is a continuation-in-part of application No. 13/532,605, filed on Jun. 25, 2012.
Application No. 13/532,605 is a continuation-in-part of application No. 13/532,628, filed on Jun. 25, 2012, now Pat. No. 8,941,590.
Application No. 13/532,628 is a continuation-in-part of application No. 13/888,174, filed on May 6, 2013, now Pat. No. 8,890,813.
Application No. 13/888,174 is a continuation-in-part of application No. 13/909,980, filed on Jun. 4, 2013.
Application No. 13/909,980 is a continuation-in-part of application No. 14/048,747, filed on Oct. 8, 2013.
Application No. 14/048,747 is a continuation-in-part of application No. 14/064,736, filed on Oct. 28, 2013, now abandoned.
Application No. 14/064,736 is a continuation-in-part of application No. 14/078,259, filed on Nov. 12, 2013.
Application No. 14/078,259 is a continuation-in-part of application No. 14/145,016, filed on Dec. 31, 2013.
(60) Provisional application No. 61/787,792, filed on Mar. 15, 2013.
(60) Provisional application No. 61/785,053, filed on Mar. 14, 2013.
(60) Provisional application No. 61/787,650, filed on Mar. 15, 2013.

(51) Int. Cl. G06F 3/01; G06K 9/00

(52) U.S. Cl. CPC G06F 3/017; G06K 9/00375; G06K 9/00355
USPC 345/158

(57) ABSTRACT

Systems and methods comprise an input device. A detector is coupled to a processor and detects an orientation of the input device. The input device has modal orientations corresponding to the orientation, and the modal orientations correspond to a input modes of a gestural control system. The detector is coupled to the gestural control system and automatically controls selection of an input mode in response to the orientation. A calibration object comprises a plurality of sensors, and the calibration object receives data used to calibrate the input device.

### RELATED APPLICATIONS

This application claims the benefit of U.S. (US) Patent Application No. 61/787,792, filed Mar. 15, 2013.

This application claims the benefit of U.S. Patent Application No. 61/785,053, filed Mar. 14, 2013.

This application claims the benefit of U.S. Patent Application No. 61/787,650, filed Mar. 15, 2013.

This application is a continuation in part application of U.S. patent application Ser. Nos. 12/572,689, 12/572,698, 13/850,837, 12/417,252, 12/487,623, 12/553,845, 12/553,902, 12/553,929, 12/557,464, 12/579,340, 13/759,472, 12/579,372, 12/773,605, 12/773,667, 12/789,129, 12/789,262, 12/789,302, 13/430,509, 13/430,626, 13/532,527, 13/532,605, 13/532,628, 13/888,174, 13/909,980, 14/048,747, 14/064,736, 14/078,259, and 14/145,016.

### TECHNICAL FIELD

Embodiments are described relating to control systems and devices including the representation, manipulation, and exchange of data within and between computing processes.

### BACKGROUND

Real-time control of computational systems requires the physical actions of a user to be translated into input signals. For example, a television remote control generates specific signals in response to button presses, a computer keyboard generates signals in response to key presses, and a mouse generates signals representing two-axis movement and button presses. In a spatial or gestural input system, the movement of hands and objects in three-dimensional space is translated as signals capable of representing up to six degrees of spatial freedom and a large number of modalities or poses.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 shows the wand-shaped multi-modal input device (MMID), under an embodiment.

FIG. 2 is a block diagram of a MMID using magnetic field tracking, under an embodiment.

FIG. 3 is a block diagram of the MMID in a tracking environment, under an embodiment.

FIGS. 4a and 4b show input states of the MMID with infrared (IR) light-emitting diodes (LEDs) (IR LEDs), under an embodiment.

FIGS. 5a and 5b show input states of the MMID with IR LEDs, under an alternative embodiment.

FIG. 6 is a block diagram of a gestural control system, under an embodiment.

FIG. 7 is a diagram of marking tags, under an embodiment.

FIG. 8 is a diagram of poses in a gesture vocabulary, under an embodiment.

FIG. 9 is a diagram of orientation in a gesture vocabulary, under an embodiment.

FIG. 10 is a diagram of two hand combinations in a gesture vocabulary, under an embodiment.

FIG. 11 is a diagram of orientation blends in a gesture vocabulary, under an embodiment.

FIG. 12 is a flow diagram of system operation, under an embodiment.

FIGS. 13A and 13B show example commands, under an embodiment.

FIG. 14 is a block diagram of a processing environment including data representations using slawx, proteins, and pools, under an embodiment.

FIG. 15 is a block diagram of a protein, under an embodiment.

FIG. 16 is a block diagram of a descrip, under an embodiment.

FIG. 17 is a block diagram of an ingest, under an embodiment.

FIG. 18 is a block diagram of a slaw, under an embodiment.

FIG. 19A is a block diagram of a protein in a pool, under an embodiment.

FIGS. 19B1 and 19B2 show a slaw header format, under an embodiment.

FIG. 19C is a flow diagram for using proteins, under an embodiment.

FIG. 19D is a flow diagram for constructing or generating proteins, under an embodiment.

FIG. 20 is a block diagram of a processing environment including data exchange using slawx, proteins, and pools, under an embodiment.

FIG. 21 is a block diagram of a processing environment including multiple devices and numerous programs running on one or more of the devices in which the Plasma constructs (i.e., pools, proteins, and slaw) are used to allow the numerous running programs to share and collectively respond to the events generated by the devices, under an embodiment.

FIG. 22 is a block diagram of a processing environment including multiple devices and numerous programs running on one or more of the devices in which the Plasma constructs (i.e., pools, proteins, and slaw) are used to allow the numerous running programs to share and collectively respond to the events generated by the devices, under an alternative embodiment.

FIG. 23 is a block diagram of a processing environment including multiple input devices coupled among numerous programs running on one or more of the devices in which the Plasma constructs (i.e., pools, proteins, and slaw) are used to allow the numerous running programs to share and collectively respond to the events generated by the input devices, under another alternative embodiment.

FIG. 24 is a block diagram of a processing environment including multiple devices coupled among numerous programs running on one or more of the devices in which the Plasma constructs (i.e., pools, proteins, and slaw) are used to allow the numerous running programs to share and collectively respond to the graphics events generated by the devices, under yet another alternative embodiment.

FIG. 25 is a block diagram of a processing environment including multiple devices coupled among numerous programs running on one or more of the devices in which the Plasma constructs (i.e., pools, proteins, and slaw) are used to allow stateful inspection, visualization, and debugging of the running programs, under still another alternative embodiment.

FIG. 26 is a block diagram of a processing environment including multiple devices coupled among numerous programs running on one or more of the devices in which the Plasma constructs (i.e., pools, proteins, and slaw) are used to allow influence or control the characteristics of state information produced and placed in that process pool, under an additional alternative embodiment.

FIG. 27 is a flow diagram of a tracking system's components, and their data flow, under an embodiment.

FIG. 28 is a plot diagram shown to the user at the end of a calibration run which shows a snapshot in time analyzing several views, under an embodiment.

FIG. 29 is a plot diagram shown to the user at the end of a calibration run which shows the uncertainties analyzing several views, under an embodiment.

FIG. 30 is a plot diagram displaying various runtime performance characteristics, under an embodiment.

FIG. 31 is a diagram of the mezzanine tracking system components, under an embodiment.

FIG. 32 is a block diagram of the MMID device, under an embodiment.

FIGS. 33A, 33B, 33C, 33D and 33E are a block diagram of the ultrasonic wand tracking system calibration rig, under an embodiment.

FIG. 34 is a flow diagram of the ultrasonic calibration method, under an embodiment.

FIG. 35 is a flow diagram of the optical calibration method, under an embodiment.

FIG. 36 is a flow diagram of the tag calibration method, under an embodiment.

### DETAILED DESCRIPTION

Systems and methods are described herein for providing multi-modal input to a spatial or gestural computing system. Embodiments of the systems and methods are provided in the context of a Spatial Operating Environment (SOE), described in detail below. The SOE, which includes a gestural control system, or gesture-based control system, can alternatively be referred to as a Spatial User Interface (SUI) or a Spatial Interface (SI).

Numerous embodiments of a multi-modal input device (MMID) are described herein, where the MMID allows the user of a spatial or gestural input system to access a range of input functionalities intuitively and in an ergonomically efficient manner. The MMID of an embodiment is a hand-held input device. The MMID of an embodiment comprises a means of accurately, and in real time, tracking the position and orientation of the device. The MMID of an embodiment comprises a physical and mechanical structure such that the person holding and operating the device may easily rotate it about one or more of its axes. The MMID of an embodiment comprises a physical and mechanical structure such that the device may be held and operated comfortably in more than one rotational grip. The MMID of an embodiment comprises a software component(s) or mechanism capable of interpreting and translating into user input signals both the rotational grip state in which the user is maintaining and operating the device and transitions between these operational rotation states. This software component relies on the tracking data corresponding to the device. In addition, such an input device may have other input capabilities integrated into its form, such as buttons, joysticks, sliders and wheels. The device may also have integrated output capabilities, such as lights, audio speakers, raster displays, and vibrating motors.

As suggested herein, a large variety of specific configurations are possible for the multi-modal input device of the various embodiments. Devices may differ in physical shape, mechanicals, and ergonomics. Devices may also differ in the number of discreet modalities supported by the combination of physical design, tracking technology, and software processing. Furthermore, MMIDs may differ in the design of supplementary on-board input (i.e. beyond position, orientation, and modality), and in on-board output capabilities.

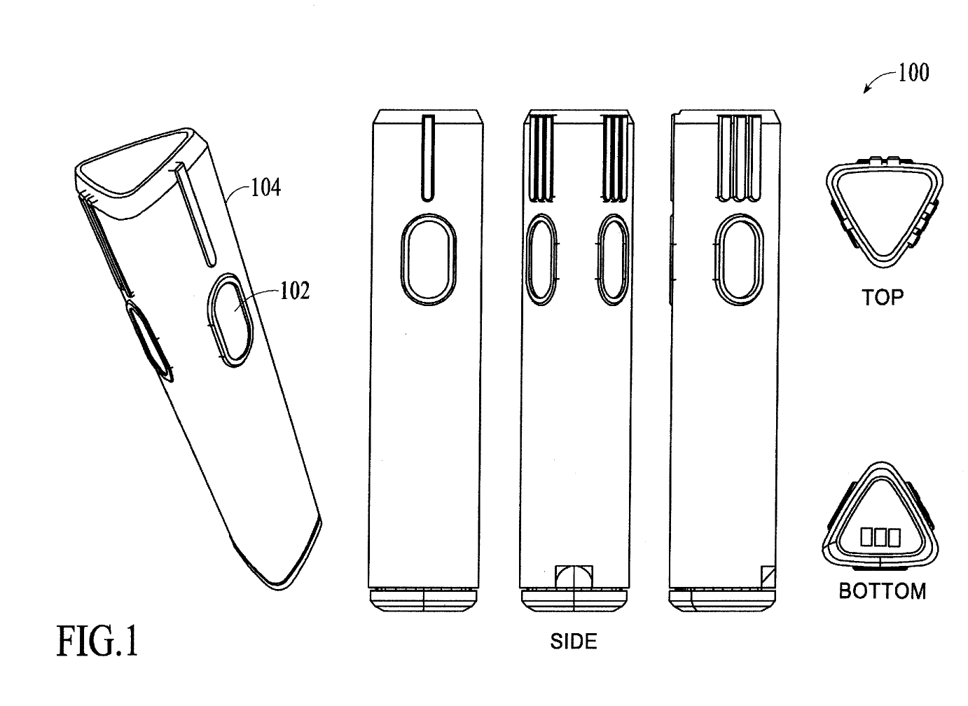

The MMID of an embodiment includes a wand-shaped device with a housing having a form factor similar to a consumer electronics remote control. FIG. 1 shows the wand-shaped MMID 100, under an embodiment. The MMID 100 is approximately five inches long and one and one-half inches wide with a triangular cross-section, but is not so limited. Each face of the MMID 100 housing includes a single input sensor, which in an embodiment comprises an electro-mechanical button, but alternative embodiments can have a greater or lesser number of buttons, or different types of buttons, on each face. When a user holds the MMID 100 one of the triangular prism's long edges 104 naturally faces downward in the user's hand, resting in the bend of the user's fingers, while the prism's opposite face is oriented upward and sits under the user's thumb. The MMID 100 may be rotated 120 degrees about the long axis with a minimal movement of the fingers and thumb, bringing an adjacent face of the prism into the upward orientation. The prism thus includes three distinct, easily accessed modal orientations corresponding to the faces of the prism. The MMID 100 can be rotated through all (e.g., three) orientations rapidly, repeatably and repeatedly, even by users experimenting with the device for the first time.

Position of the MMID 100 of an embodiment is tracked using magnetic field tracking, as described below, but can be tracked using other tracking technologies (some of which are described herein). The MMID 100 comprises circuitry, a microcontroller, and program code for tracking the device relative to an alternating current (AC) magnetic field, or electromagnetic field (EMF). The EMF of an embodiment is generated or emitted by a compatible base station proximate to the MMID, but is not so limited. The MMID 100 comprises one or more mechanical buttons, also referred to as input sensors, along with corresponding electronics to digitize the state of the one or more buttons. Furthermore, the MMID 100 includes circuitry that provides a radio link to report the tracking data (e.g., orientation data, position data, etc.) and button press raw data to a host system. Additionally, the MMID 100 includes a battery and power supply circuitry.

Input processing software translates the raw tracking and button press data into data comprising six degrees of spatial position and orientation, button down transition, button up transition, and a running account of button state. The input processing software of an embodiment executes in part on the device and in part as application code on the host system, but is not so limited and can run in a distributed manner on any number/combination of processing devices or solely on a single processor. This data is delivered to application software as a series of programmatic “events” (processing of the programmatic events is described in detail below). In addition, this input processing layer provides mode transition and running mode state events to application software. Three states (e.g., i, ii, and iii), and six transitions (e.g., i->ii, i->iii, ii->iii, iii->i, and iii->ii) are possible, as described in detail below.

The processing layer of an embodiment uses hysteresis to allow a user to access a maximum of rotation along the MMID's long axis without leaving a given mode, and to avoid rapid, undesirable flip-flopping between modal states when the MMID is near the edge of a transition angle. Using this hysteresis, to trigger a transition between modes, the MMID of an embodiment should be rotated more than 120 degrees relative to the center angle of the previous mode. So if the MMID is in mode (i), with an absolute angular center of zero degrees, the MMID remains logically in the mode (i) state until a rotation is detected about the long axis of more than, say, 150 degrees in either direction. When the MMID is rotated 151 degrees, it transitions to modal state (ii), which has an angular center of 120 degrees. To effect a return to state (i) the MMID must be rotated in the opposite sense past this angular center by −150 degrees, bringing it past an absolute angle of −30 (or 330) degrees. The hysteresis band, given above as 30 degrees (150 degrees minus 120), is programmatically settable, and may be adjusted by application code or by user preference setting. This hysteresis example if provided for a three-sided MMID, as described above, but is not limited to the values described herein for the three-sided device; the rotation angles and/or hysteresis bands of alternative embodiments are determined according to a form-factor of the housing or wand and to designer/user preferences.

In addition, certain modes can be selectively disabled by application code. So the MMID can be treated by application code as a single-mode device outputting a constant modal state of (i), (ii), or (iii). Or, any one of the modes may be disabled, either by mapping the disabled mode to either of the two remaining modes exclusively, or by treating the disabled mode as an additional area of the hysteresis band.

Further, the system may be configured to immutably associate a physical face of the MMID (e.g., triangular prism) with each mode, the faces being optionally labeled as to mode association by means of active or passive markings. Alternatively, the system may be configured to assign modes to faces in a contextual way. As an example of this latter case, the MMID can be configured so that, when it is first picked up by a user after a period of inactivity, the initially upward face is associated with mode (i). In such cases an indicator of the active mode can be provided on the MMID, on the graphical display to which the user is attending, or on a combination of the MMID and the graphical display.

Each face of the MMID includes a single button, also referred to as an input sensor. These buttons are treated identically by application-level software, but are not so limited. From the user's perspective, the device may be considered as having a single logical button, with three physical incarnations for reasons of ergonomic practicality. The circuitry and software of the MMID does distinguish manipulation of different physical buttons, however, and the system may be arranged so that pressing the buttons in specific combinations places the device in various configuration and reset states.

The MMID of an embodiment functions using magnetic field tracking technology (see, for example, U.S. Pat. No. 3,983,474). The use of orthogonal coils for generating and sensing magnetic fields has been used in locating and tracking remote objects. For example, U.S. Pat. No. 3,644,825 teaches generating and sensing coils which move with respect to each other. Alternatively, the magnetic field can be made to rotate as taught in Kalmus, “A New Guiding and Tracking System”, IRE Transactions on Aerospace and Navigational Electronics, March 1962, pages 7 through 10.

The use of coordinate transformers to determine the orientation of a first coordinate system with respect to a second coordinate system has also been used. For example, U.S. Pat. Nos. 3,474,241 and 3,660,648 disclose transformers which transform angular rates or angular errors measured in a first coordinate frame into angular rates defined about the axes of an intermediate coordinate frame about whose axes the angular rotations or rates are defined and then integrate to determine the angles defining the angle-axis sequence which defines the orientation of the first coordinate frame with respect to a second coordinate frame through the use of Euler angles.

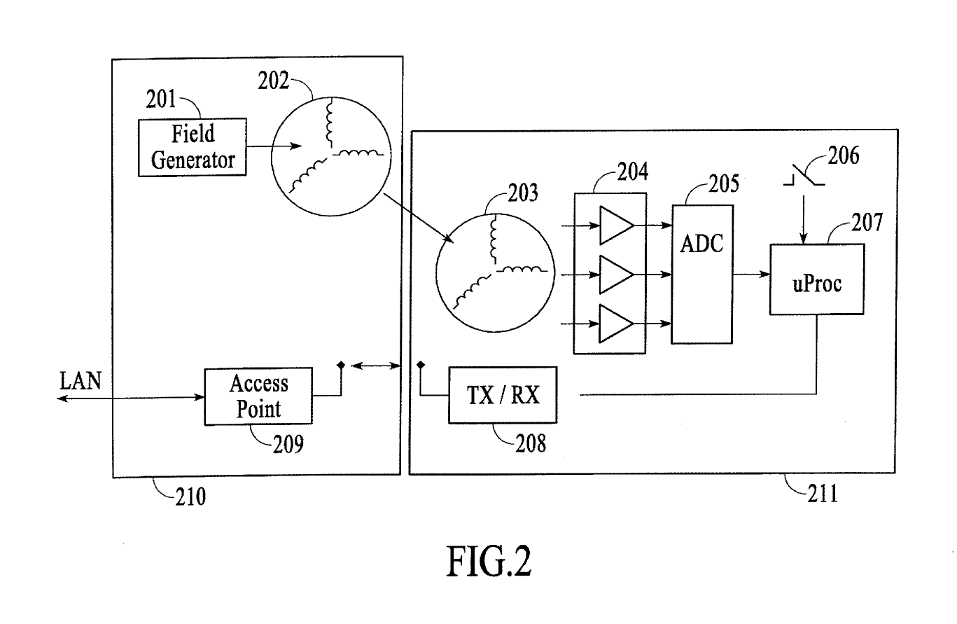

FIG. 2 is a block diagram of a MMID using magnetic field tracking, under an embodiment. A base station 210 located proximate or in the tracking environment of the MMID both provides the tracking field, as well as communicates with the MMID 211. In the base station, a signal generator creates magnetic fields by using a field generator circuit 201 to produce a wave form alternately in three orthogonal coils 202. The electromagnetic signals generated by these coils are received by three orthogonal coils 203 in the MMID. The received signals from the three coils are typically amplified using operational amplifiers 204 and converted to digital signals 205 which can be sampled by a microprocessor 207. The microprocessor analyzes the input of the three coils using digital signal processing (DSP) techniques. The DSP process provides a location vector projecting the distance and direction of the MMID from the base station, as well as an orientation matrix that determines the orientation of the MMID.

Additional information (e.g., time stamp, universal ID, etc.) can also be combined with the MMID location data. One or more user input sensors 206 are also sensed for state. The input sensors 206 can be momentary switches, toggle switches, joystick style input devices, and/or touch sensors to name a few. The sample data from these switches includes a single bit (for a touch button) or a more complex data value, such as a floating point x,y coordinate for a touch sensor.

In an embodiment, the microprocessor communicates data including location data and orientation data from the MMID wirelessly to a host process. The MMID has a radio frequency transmitter and receiver (TX/RX) 208 for data communication to the network through an Access Point 209. This radio link can use any wireless protocol (e.g., Bluetooth, 802.11, Wireless USB, proprietary solutions, Nordic Semiconductor nRF24L01 low power radio solution, etc.). The access point can communicate the received data stream to one or more host computers through a local area network (e.g., Wired Internet 10/100/1000BaseT, 802.11, etc.) or other interface (e.g., USB, etc.).

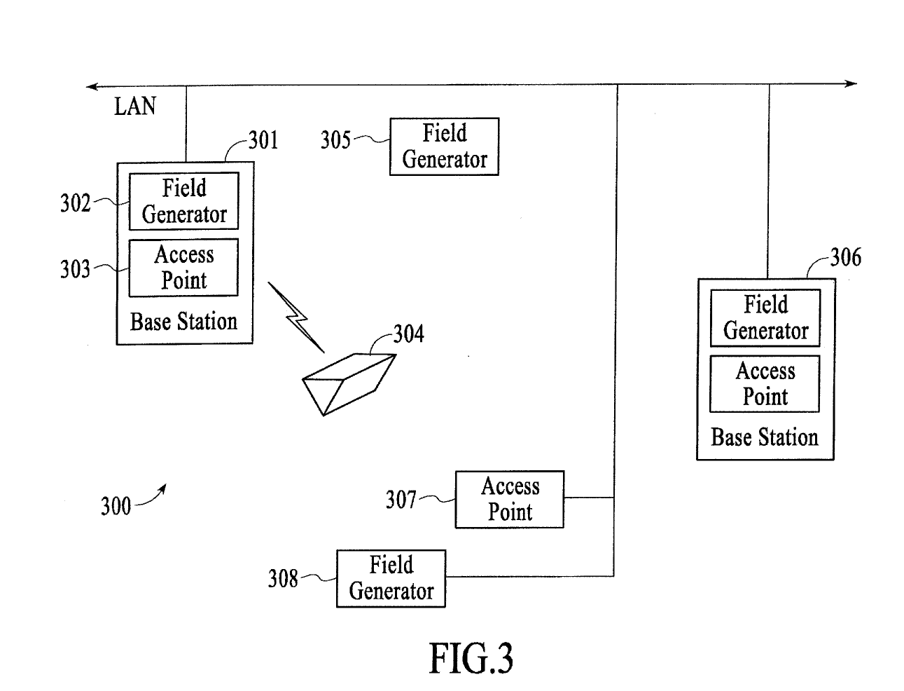

FIG. 3 is a block diagram of the MMID in a tracking environment, under an embodiment. The MMID 304 is shown in relation to the tracking environment 300. The MMID is communicating with a base station 301, as described above, but the MMID can communicate with any number of different types and/or combinations of electronic devices in the tracking environment 300. The tracking environment is not limited to a particular size because, as the range of the radio frequency communications channel may be different from the range of the AC magnetic field, additional AC magnetic field generators 305/306/308 with coils can be provided to create additional tracking beacons. These beacons can operate at different frequencies and/or transmit at different times. As the user of the MMID moves away from field generator 302 and towards generator 305 the MMID will use whichever signal is instantaneously stronger to determine location and orientation, but will still communicate this data back to the network using access point 303.

As the MMID moves out of range of the access point 303 and towards base station 306, the MMID will associate the radio link with the access point in base station 306. The ability to roam among magnetic field generators and data access points ultimately allows the MMID to be used in an arbitrarily large tracking environment. Note that the access points and magnetic field generators need not be at the same location 307/308. While both the access points and field generators have means of communication with one or more host devices over a local area network, the frequency generators can operate autonomously 305 allowing for easier installation.

Following is an operational example of a person using the MMID of an embodiment. During operation, an operator stands some distance (e.g., ten feet) before a triptych-format wide aspect ratio projection screen, roughly two meters high and four meters wide; a one-point-five meter wide table stands immediately before her. The table is itself also a projection surface treated by a projector ceiling-mounted immediately overhead. The operator holds the MMID having the triangular-cross-section MMID comfortably in her right hand, with flat side “i” pointing upward. As she aims the MMID toward and about the front screen, a partially transparent graphical cursor indicates the intersection of the MMID's pointing vector with the screen surface. The input system's high frame rate and low latency contribute to a strong sense of causal immediacy: as the operator changes the MMID's aim, the cursor's corresponding movement on the forward screen does not apparently lag behind; the perception is of waving a flashlight or laser pointer.

The application in use by the operator is a product packaging preview system, and is configured to make use of the MMID in a way identical to many similar applications; the MMID modalities are thus well familiar to the operator. Mode “i” allows direct manipulation of application elements at the fully detailed level; mode “ii” performs meta-manipulation of elements (e.g. at the group level); and mode “iii” permits three-dimensional manipulations. At any instant, the appearance of the cursor reflects not only the current mode but also indicates visually the direction of axial rotation that would be necessary to switch the MMID's modes. At present, the cursor shows that a clockwise rotation of the MMID would cause a modal transition to “ii”, while counterclockwise rotation would transition to mode “iii”.

Arranged on the left third of the forward screen triptych is an array of small object groupings. The operator rotates the MMID axially clockwise until the next face is aimed upward, under her thumb, and the cursor changes to indicate the modal transition to state “ii”. She aims the MMID leftward, and as the cursor travels over each object grouping a highlight border fades up, subsequently fading down as the cursor exits the grouping's convex hull. The operator allows the cursor to rest on a particular grouping and then depresses the button immediately under her thumb. The cursor indicates that the object grouping has been grabbed and, as she swings the MMID toward the center of the forward screen, the grouping moves so as to track along with the cursor. The operator releases the button when she has brought the miniature grouping to a position directly in front of her. The grouping rapidly expands to fill the full extent of the center third of the forward screen, revealing a collection of variously shaped plastic bottles and the textual indication “Pet Energy Beverages”.

The operator once again rotates the MMID clockwise about its long axis, whereupon the cursor changes to indicate that mode “iii” is now operational and, thus, that 3D manipulation is enabled. The operator aims the cursor at a particularly bulbous bottle shaped like a coiffured poodle leg, and the bottle visually highlights; the operator then depresses the button. The system now enters a direct-manipulation mode in which translation and rotation of the MMID controls translation and rotation of the selected object in the virtual space being rendered. So, as the operator pulls the MMID toward herself (directly along the geometric normal to the forward screen), the bottle grows larger, verging toward the virtual camera. Similarly, left-right movement of the MMID translates to left-right movement of the rendered bottle (along the screen's lateral axis), and up-down translation of the MMID results in vertical translation of the bottle. An appropriate scale factor, customizable for each operator, is applied to these translations so that modest movements of the MMID effect larger movements of virtual objects; the full extent of the graphical/virtual environment is thereby made accessible without exceeding an operator's range of comfortable hand-movement.

A similar scaling function is applied to the mapping of MMID orientation to absolute rotational position of the rendered bottle. In the present example, the operator's preferences dictate a four-times scale, so that a ninety degree rotation of the MMID around any axis results in a full three hundred sixty degree rotation of the virtual object (90 degrees multiplied by four (4) results in 360 degrees). This insures that wrist- and arm-based MMID rotations remain within a comfortable range as the operator examines the bottle from every possible angular vantage. So, for example, as she rotates the MMID upward, tipping it ninety degrees around a local x-axis so that it evolves from forward-pointing to upward-pointing, the bottle executes a full rotation around the screen-local x-axis, returning to its initial orientation just as the MMID achieves a fully upward attitude. Note that an appropriate mode-locking effect is applied so long as the MMID's button remains depressed: the operator may rotate the MMID one hundred seventy clockwise degrees around the MMID's long axis (producing a five hundred ten degree “in-screen” rotation of the virtual object) without causing the MMID to switch to mode “i”.

When the operator releases the MMID's button, the rendered bottle is released from direct manipulation and retains its instantaneous position and rotation. If at the moment of button release the MMID is in a rotational attitude that would ordinarily correspond to a MMID-mode other than “iii”, the operator is granted a one-second temporal hysteresis (visually indicated as part of the on-screen cursor's graphical state) before the mode switch is actually effected; if the operator returns the MMID rotationally to an attitude corresponding to mode “iii”, then direct 3D manipulation mode persists. She may then perform additional positional and attitudinal adjustments by superimposing the cursor atop the bulbous bottle and again depressing the button; if instead she aims the cursor at a different bottle, that object will be subject to her manipulations.

The operator eventually switches the MMID to mode “ii” and, using a dragging modality identical to that by which she brought the bottle grouping to the center screen, brings a color-palette from the right screen to the center screen; when she releases the button, the palette expands and positions itself to the side of the bulbous bottle. She then rotates the MMID to select mode “i” and manipulates the color palette's selection interface; when the crimson hue she desires has been selected, she depresses the button and drags a color swatch from the palette downward and leftward until it overlies the clear material forming the bulbous bottle. When she releases the button, the color is applied and the bottle's material adopts a transparent crimson.

Still in mode “i”, the operator points the MMID directly at the bulbous bottle, which highlights in response, and, depressing the button, swings the MMID downward to drag the image of the bottle from the front screen to the surface of the table immediately before her. She releases the button and thereby the bottle, leaving it in position on the table. The operator then rotates back to mode “ii” and points the MMID forward at the collection of other pet energy beverage bottles; she depresses the button and immediately flicks the MMID leftward, releasing the button a fraction of a second later. The collection of bottles flies leftward, diminishing in size as it travels, until it comes to rest in the location and at the overall scale at which it started. The operator then selects a different grouping of pet care products, bringing it to the center display region as before in order to select, inspect, and modify one of the items. She eventually adds the selected object to the table display. The operator continues this curatorial process.

At a certain point, the operator elects to modify the physical geometry of a canister of pet massage oil using a simple geometry editor, also pulled from the collection of tools appearing on the right third of the forward screen triptych. The description of many manipulations involved in the use of this editor is omitted here, for the sake of clarity, except as regards the simultaneous use of two MMIDs. In the present instance, the operator uses a second MMID, held in her left hand, in order to put a twist in the canister (originally a simple extruded shape with rectangular cross section) by using one MMID to grab the top part of the canister's geometry and the other MMID to grab the canister's bottom part (both MMIDs in mode “iii”). With the top and bottom thereby separately “affixed”, the operator rotates the MMIDs in opposite directions; this introduces a linear twist about the canister's main axis. The operator finishes these geometry modifications and returns the editing module to the right display; she adds the modified canister to the table's growing assortment.

At last there are a dozen objects being rendered on the table, and the forward center display is empty once more—the operator has mode-“ii”-flicked the last grouping leftward (and the color palette rightward). She then points the MMID, still in mode “ii”, at the table, but her aim avoids the product renderings there; instead, she depresses the right button and describes a circular trajectory with the MMID, as if drawing a curved corral shape around the displayed objects. In response, the system applies a grouping operation to the formerly distinct product renderings, organizing their layout and conforming their relative sizes. Finally, the operator uses mode-“ii”-dragging to elastically extend the input aperture of a graphical “delivery tube” from the right display to the center; she then picks up the table's customized product collection, drags it up to the center screen, and deposits it in the mouth of the delivery tube. The tube ingests the collection and retracts back to the right display; the collection will be delivered to the operator's colleague, who is expecting to review her work and use it to construct an interactive visualization of a pet shop aisle.

The MMID of an alternative embodiment includes a housing having a rectangular form-factor. The pointer of this alternative embodiment is five inches long, one and one half inches wide, and one half inch deep, for example, but many other sizes and/or configurations are possible hereunder. The MMID includes optically tracked tags, described in detail below. The MMID does not include electronics as the processing software runs in a host system environment, but the embodiment is not so limited.

A user most naturally holds the pointer such that the long axis serves to point at objects (including virtual objects) in the user's environment. The pointer can be rotated around the long axis to transition between two modal orientations (e.g., modes i and ii). Four modal transitions are possible, even though there are only two modes, because the system can distinguish between the direction of rotation during a transition: transition from mode i to mode ii/clockwise; transition from mode i to mode ii/counter-clockwise; transition from mode ii to mode i/clockwise; transition from mode ii to mode i/counter-clockwise. As with the MMID described above, these rotational transitions are tracked in input processing software, and can be subject to hysteretic locking.

The optical tags are mounted on the “front” portion (e.g., front half) of the pointer, in the area extending outwards from the user's hand, for example, but are not so limited. On each of the two sides of the pointer, two tags are mounted. The forward-most tag on each side is fixed in position. The rear-most tag on each side is positioned a distance (e.g., five (5) centimeters) behind the forward tag and is aligned along and oriented according to the same axis. This rear tag is affixed to a spring-mounted sliding mechanism (the direction of translation aligned with the pointer's long axis) such that the user's thumb may push forward on the mechanism to decrease the distance between the two tags by approximately one centimeter.

The input processing software interprets the logical button state of the device to be in state (0) when the distance between the two tags is five centimeters. To effect a transition to state (1), the rear tag is moved a distance closer to the front tag (e.g., to within 4.2 centimeters of the front tag). The transition back to button state (1) is triggered only when the distance between the tags exceeds 4.8 centimeters. This is similar to the hysteresis applied to the device's principal (rotational) mode transitions. Again, the size of the hysteresis band is configurable.

In the embodiment of an optically tracked MMID, an optical tracking tag is used where a number of dots are aligned on a tag. These dots may be small spheres covered with retroreflectors, for example, allowing an IR tracking system (described below) to determine the location and orientation of a tagged object. In the case that this tagged object is an input MMID, it may be desired to provide a means for the tracking system to determine when a user has provided a non-geometric, state-change input, such as pressing a button.

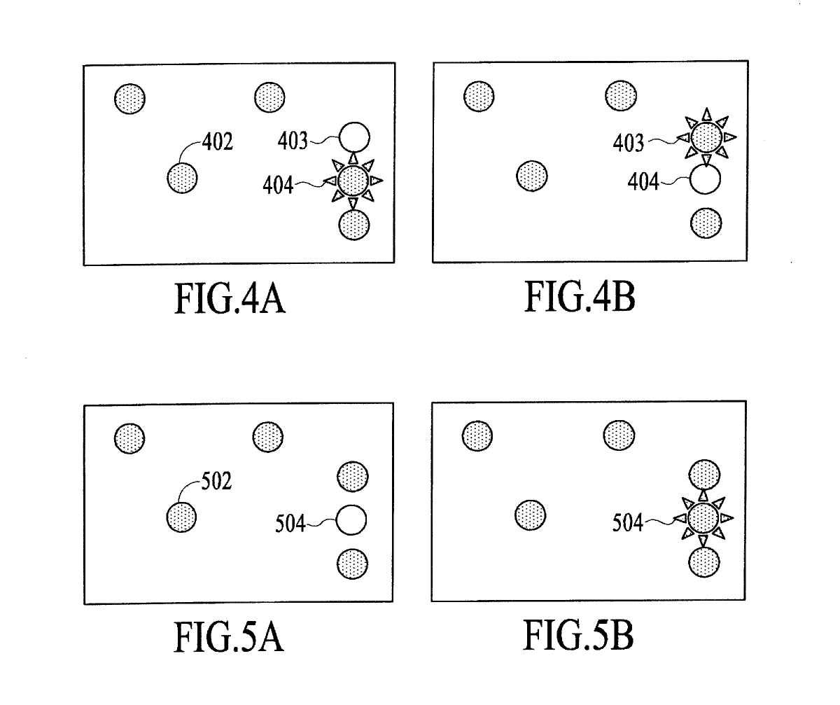

The MMID of various alternative embodiments operates using infrared (IR) light-emitting diodes (LEDs) (IR LEDs) to provide tracking dots that are only visible to a camera at certain states based on the user input. The MMID of these alternative embodiments includes a battery and LED driving circuitry controlled by the input button. FIGS. 4a and 4b show input states of the MMID with IR LEDs, under an embodiment. The tag of this embodiment comprises numerous retro-reflective dots 402 (shown as a solid filled dot) and two IR LEDs 403 and 404. In FIG. 4a, the tag is shown in a state in which the button on the MMID is not pressed, and IR LED 403 is in the non-illuminated state, while IR LED 404 is in the illuminated state. In FIG. 4b, the user has pressed a button on the MMID and, in response, IR LED 403 is in the illuminated state while IR LED 404 is in the non-illuminated state. The optical processing system detects the difference in the two tags and from the state of the two tags determines the user's intent.

FIGS. 5a and 5b show input states of the MMID with IR LEDs, under another alternative embodiment. In this embodiment, only one LED is switched. Thus, referring to FIG. 5a, LED 504 is in the non-illuminated state when the user has not pressed the button. In FIG. 5b, the user has pressed the button and LED 504 is thus illuminated.

Additional methods are also enabled using similar approaches. In one alternative embodiment, a complete tag is constructed using LEDs and the presence or absence of that tag provides input of the user. In another embodiment, two identical tags are created either overlaid (offset by, for example 0.5 cm) or adjacent. Illuminating one tag or the other, and determining the location of that tag with respect to another tag, allows the input state of the user to be determined.

The MMID of other alternative embodiments can combine the use of tag tracking with EMF tracking. These alternative embodiments combine aspects of the EMF tracking with the tag tracking using various types of tags, as described herein.

The MMID of another alternative embodiment includes a controller used in conjunction with two infrared light sources, one located in front of the user and one positioned behind the user. These two light sources each have three individual infrared emitters, and the emitter of each source is configured in a different pattern. The MMID of this embodiment makes use of inertial tracking, includes two modes, and includes multiple mechanical input buttons, as described below.

The MMID of this embodiment might be thought of as a modification of a Nintendo® Wii™ remote control device that supports two modal orientations, with the modes determined by the directional orientation of the controller relative to its environment. The Wii™ controller is a small device used to play video games on the Nintendo′ Wii™ platform, and an associated infrared light source. The controller tracks its motion in space inertially, using a set of low-accuracy accelerometers. The accelerometers are not accurate enough to provide good position and orientation data over more than a few tenths of seconds, because of the errors that accumulate during numerical integration, so an optical tracking system (in conjunction with the light source component) is also used. The optical tracking system of the Wii™ controller therefore further comprises an internal, front-facing infrared camera capable of locating four bright infrared light sources in a two-dimensional image plane. Therefore, the camera is embedded in the tracked device and the objects that are optically located are fixed-position environmental referents. By measuring the perceived size and position of known infrared light sources in the environment it is possible to determine the direction in which the controller is pointing and to triangulate the controllers distance from those sources. This infrared tracking technology may be viewed as an inversion of the tracking technology described herein, because the infrared tracking technology of the embodiment herein uses cameras placed in the environment to optically locate points arranged on devices, surfaces, gloves, and other objects.

In a typical use with the Nintendo Wii™ console, the controller is always pointing towards a display screen. An infrared light source is placed above or below the display screen, providing the controller with a screen-relative orientation. In contrast, the controller of an embodiment is used in conjunction with two infrared light sources, one positioned in front of the user and one positioned behind the user. These two light sources each have three individual infrared emitters, and each source's emitters are configured in a different pattern.

The controller of an embodiment communicates by bluetooth radio with input processing software or components running on a host computer. The input processing software identifies which emitter pattern is detected and therefore whether the controller is pointing forwards or backwards. Two modal orientations are derived from this forwards/backwards determination. In modal state (i) the controller is oriented forwards. In modal state (ii) the controller is oriented backwards. In each case, the user is logically pointing forwards. The user controls the mode by turning the controller around “back to front”. This is in contrast to the embodiments described above, in which the mode control is a long-axis “rolling” of the device. The controller of an embodiment can include an embedded speaker, providing sound output, several lights, and a vibration (or “rumble”) output.

Numerous modifications of the embodiments described herein are possible under this description. The controller of an embodiment may, for example, have two cameras, one on each end of the device, thereby obviating the need for two light sources. The light sources may be differentiated by timing, rather than spatial, patterns.

### Spatial Operating Environment (SOE)

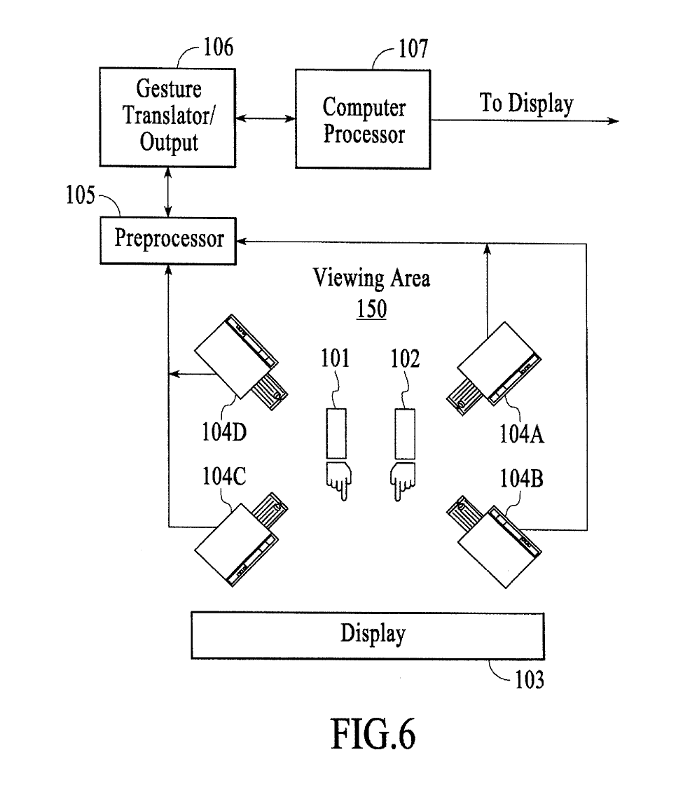

Embodiments of a spatial-continuum input system are described herein in the context of a Spatial Operating Environment (SOE). As an example, FIG. 6 is a block diagram of a Spatial Operating Environment (SOE), under an embodiment. A user locates his hands 101 and 102 in the viewing area 150 of an array of cameras 104A-104D. The cameras detect location, orientation, and movement of the fingers and hands 101 and 102, as spatial tracking data, and generate output signals to pre-processor 105. Pre-processor 105 translates the camera output into a gesture signal that is provided to the computer processing unit 107 of the system. The computer 107 uses the input information to generate a command to control one or more on screen cursors and provides video output to display 103.

Although the system is shown with a single user's hands as input, the SOE 100 may be implemented using multiple users. In addition, instead of or in addition to hands, the system may track any part or parts of a user's body, including head, feet, legs, arms, elbows, knees, and the like.

In the embodiment shown, four cameras or sensors are used to detect the location, orientation, and movement of the user's hands 101 and 102 in the viewing area 150. It should be understood that the SOE 100 may include more (e.g., six cameras, eight cameras, etc.) or fewer (e.g., two cameras) cameras or sensors without departing from the scope or spirit of the SOE. In addition, although the cameras or sensors are disposed symmetrically in the example embodiment, there is no requirement of such symmetry in the SOE 100. Any number or positioning of cameras or sensors that permits the location, orientation, and movement of the user's hands may be used in the SOE 100.

In one embodiment, the cameras used are motion capture cameras capable of capturing grey-scale images. In one embodiment, the cameras used are those manufactured by Vicon, such as the Vicon MX40 camera. This camera includes on-camera processing and is capable of image capture at 1000 frames per second. A motion capture camera is capable of detecting and locating markers.

In the embodiment described, the cameras are sensors used for optical detection. In other embodiments, the cameras or other detectors may be used for electromagnetic, magnetostatic, RFID, or any other suitable type of detection.

Pre-processor 105 generates three dimensional space point reconstruction and skeletal point labeling. The gesture translator 106 converts the 3D spatial information and marker motion information into a command language that can be interpreted by a computer processor to update the location, shape, and action of a cursor on a display. In an alternate embodiment of the SOE 100, the pre-processor 105 and gesture translator 106 are integrated or combined into a single device.

Computer 107 may be any general purpose computer such as manufactured by Apple, Dell, or any other suitable manufacturer. The computer 107 runs applications and provides display output. Cursor information that would otherwise come from a mouse or other prior art input device now comes from the gesture system.

### Marker Tags

The SOE or an embodiment contemplates the use of marker tags on one or more fingers of the user so that the system can locate the hands of the user, identify whether it is viewing a left or right hand, and which fingers are visible. This permits the system to detect the location, orientation, and movement of the user's hands. This information allows a number of gestures to be recognized by the system and used as commands by the user.

The marker tags in one embodiment are physical tags comprising a substrate (appropriate in the present embodiment for affixing to various locations on a human hand) and discrete markers arranged on the substrate's surface in unique identifying patterns.

The markers and the associated external sensing system may operate in any domain (optical, electromagnetic, magnetostatic, etc.) that allows the accurate, precise, and rapid and continuous acquisition of their three-space position. The markers themselves may operate either actively (e.g. by emitting structured electromagnetic pulses) or passively (e.g. by being optically retroreflective, as in the present embodiment).

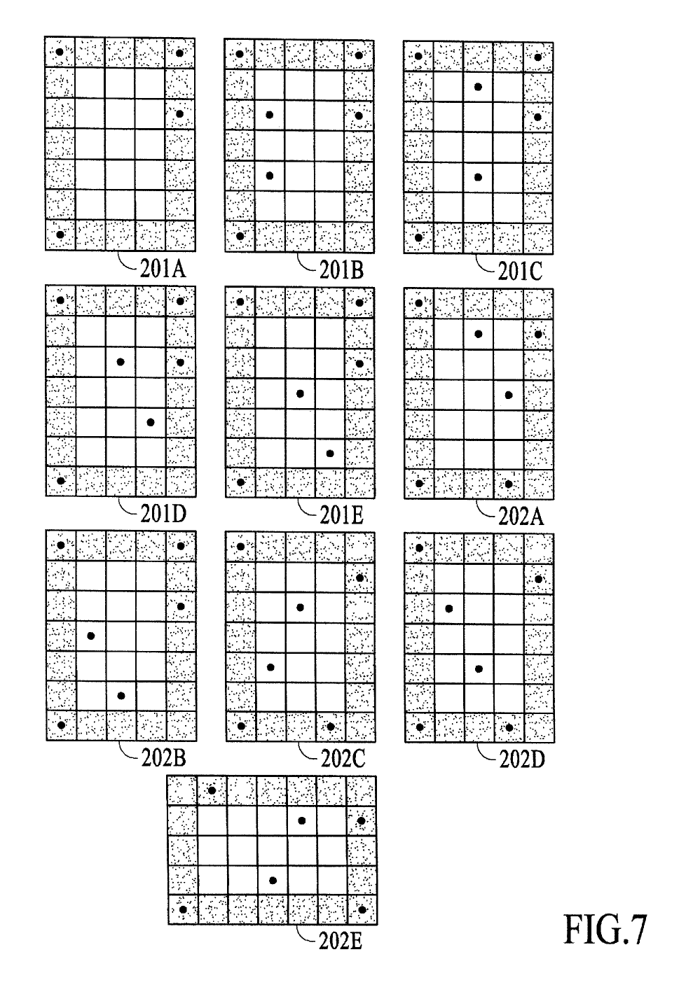

At each frame of acquisition, the detection system receives the aggregate ‘cloud’ of recovered three-space locations comprising all markers from tags presently in the instrumented workspace volume (within the visible range of the cameras or other detectors). The markers on each tag are of sufficient multiplicity and are arranged in unique patterns such that the detection system can perform the following tasks: (1) segmentation, in which each recovered marker position is assigned to one and only one subcollection of points that form a single tag; (2) labelling, in which each segmented subcollection of points is identified as a particular tag; (3) location, in which the three-space position of the identified tag is recovered; and (4) orientation, in which the three-space orientation of the identified tag is recovered. Tasks (1) and (2) are made possible through the specific nature of the marker-patterns, as described below and as illustrated in one embodiment in FIG. 7.

The markers on the tags in one embodiment are affixed at a subset of regular grid locations. This underlying grid may, as in the present embodiment, be of the traditional Cartesian sort; or may instead be some other regular plane tessellation (a triangular/hexagonal tiling arrangement, for example). The scale and spacing of the grid is established with respect to the known spatial resolution of the marker-sensing system, so that adjacent grid locations are not likely to be confused. Selection of marker patterns for all tags should satisfy the following constraint: no tag's pattern shall coincide with that of any other tag's pattern through any combination of rotation, translation, or mirroring. The multiplicity and arrangement of markers may further be chosen so that loss (or occlusion) of some specified number of component markers is tolerated: After any arbitrary transformation, it should still be unlikely to confuse the compromised module with any other.

Referring now to FIG. 7, a number of tags 201A-201E (left hand) and 202A-202E (right hand) are shown. Each tag is rectangular and consists in this embodiment of a 5×7 grid array. The rectangular shape is chosen as an aid in determining orientation of the tag and to reduce the likelihood of mirror duplicates. In the embodiment shown, there are tags for each finger on each hand. In some embodiments, it may be adequate to use one, two, three, or four tags per hand. Each tag has a border of a different grey-scale or color shade. Within this border is a 3×5 grid array. Markers (represented by the black dots of FIG. 7) are disposed at certain points in the grid array to provide information.

Qualifying information may be encoded in the tags' marker patterns through segmentation of each pattern into ‘common’ and ‘unique’ subpatterns. For example, the present embodiment specifies two possible ‘border patterns’, distributions of markers about a rectangular boundary. A ‘family’ of tags is thus established—the tags intended for the left hand might thus all use the same border pattern as shown in tags 201A-201E while those attached to the right hand's fingers could be assigned a different pattern as shown in tags 202A-202E. This subpattern is chosen so that in all orientations of the tags, the left pattern can be distinguished from the right pattern. In the example illustrated, the left hand pattern includes a marker in each corner and on marker in a second from corner grid location. The right hand pattern has markers in only two corners and two markers in non corner grid locations. An inspection of the pattern reveals that as long as any three of the four markers are visible, the left hand pattern can be positively distinguished from the left hand pattern. In one embodiment, the color or shade of the border can also be used as an indicator of handedness.

Each tag must of course still employ a unique interior pattern, the markers distributed within its family's common border. In the embodiment shown, it has been found that two markers in the interior grid array are sufficient to uniquely identify each of the ten fingers with no duplication due to rotation or orientation of the fingers. Even if one of the markers is occluded, the combination of the pattern and the handedness of the tag yields a unique identifier.

In the present embodiment, the grid locations are visually present on the rigid substrate as an aid to the (manual) task of affixing each retroreflective marker at its intended location. These grids and the intended marker locations are literally printed via color inkjet printer onto the substrate, which here is a sheet of (initially) flexible ‘shrink-film’. Each module is cut from the sheet and then oven-baked, during which thermal treatment each module undergoes a precise and repeatable shrinkage. For a brief interval following this procedure, the cooling tag may be shaped slightly—to follow the longitudinal curve of a finger, for example; thereafter, the substrate is suitably rigid, and markers may be affixed at the indicated grid points.

In one embodiment, the markers themselves are three dimensional, such as small reflective spheres affixed to the substrate via adhesive or some other appropriate means. The three-dimensionality of the markers can be an aid in detection and location over two dimensional markers. However either can be used without departing from the spirit and scope of the SOE described herein.

At present, tags are affixed via Velcro or other appropriate means to a glove worn by the operator or are alternately affixed directly to the operator's fingers using a mild double-stick tape. In a third embodiment, it is possible to dispense altogether with the rigid substrate and affix— or ‘paint’—individual markers directly onto the operator's fingers and hands.

### Gesture Vocabulary

The SOE of an embodiment contemplates a gesture vocabulary consisting of hand poses, orientation, hand combinations, and orientation blends. A notation language is also implemented for designing and communicating poses and gestures in the gesture vocabulary of the SOE. The gesture vocabulary is a system for representing instantaneous ‘pose states’ of kinematic linkages in compact textual form. The linkages in question may be biological (a human hand, for example; or an entire human body; or a grasshopper leg; or the articulated spine of a lemur) or may instead be nonbiological (e.g. a robotic arm). In any case, the linkage may be simple (the spine) or branching (the hand). The gesture vocabulary system of the SOE establishes for any specific linkage a constant length string; the aggregate of the specific ASCII characters occupying the string's ‘character locations’ is then a unique description of the instantaneous state, or ‘pose’, of the linkage.

### Hand Poses

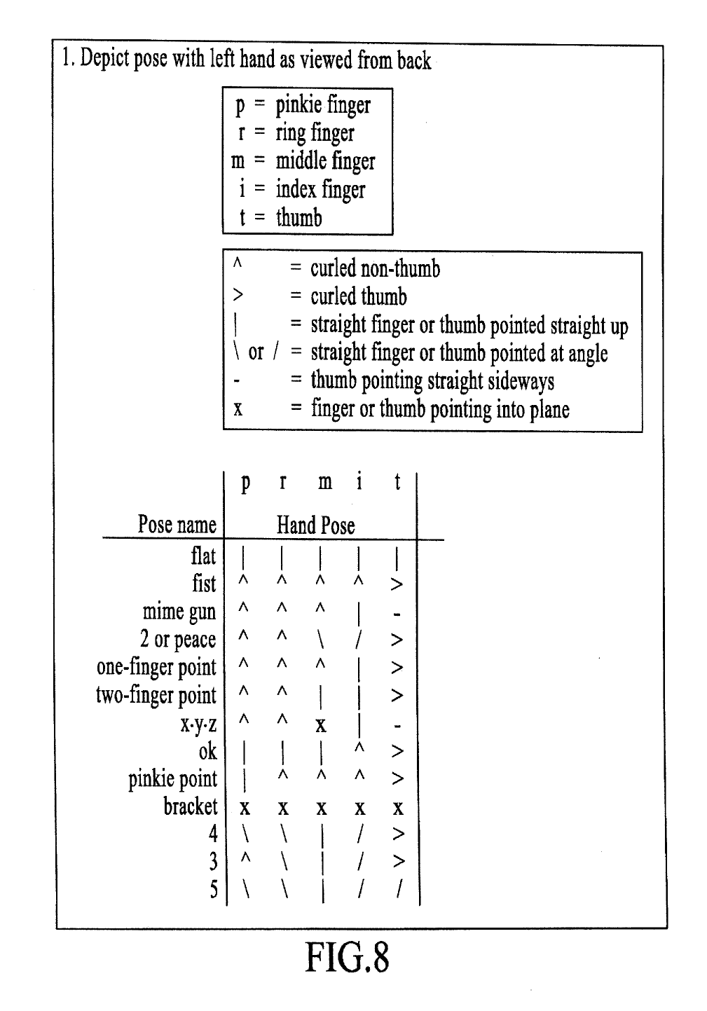

FIG. 8 illustrates hand poses in an embodiment of a gesture vocabulary of the SOE, under an embodiment. The SOE supposes that each of the five fingers on a hand is used. These fingers are codes as p-pinkie, r-ring finger, m-middle finger, i-index finger, and t-thumb. A number of poses for the fingers and thumbs are defined and illustrated in FIG. 8. A gesture vocabulary string establishes a single character position for each expressible degree of freedom in the linkage (in this case, a finger). Further, each such degree of freedom is understood to be discretized (or ‘quantized’), so that its full range of motion can be expressed through assignment of one of a finite number of standard ASCII characters at that string position. These degrees of freedom are expressed with respect to a body-specific origin and coordinate system (the back of the hand, the center of the grasshopper's body; the base of the robotic arm; etc.). A small number of additional gesture vocabulary character positions are therefore used to express the position and orientation of the linkage ‘as a whole’ in the more global coordinate system.

Still referring to FIG. 8, a number of poses are defined and identified using ASCII characters. Some of the poses are divided between thumb and non-thumb. The SOE in this embodiment uses a coding such that the ASCII character itself is suggestive of the pose. However, any character may used to represent a pose, whether suggestive or not. In addition, there is no requirement in the embodiments to use ASCII characters for the notation strings. Any suitable symbol, numeral, or other representation maybe used without departing from the scope and spirit of the embodiments. For example, the notation may use two bits per finger if desired or some other number of bits as desired.

A curled finger is represented by the character “A” while a curled thumb by “>”. A straight finger or thumb pointing up is indicated by “1” and at an angle by “\” or “/”. “-” represents a thumb pointing straight sideways and “x” represents a thumb pointing into the plane.

Using these individual finger and thumb descriptions, a robust number of hand poses can be defined and written using the scheme of the embodiments. Each pose is represented by five characters with the order being p-r-m-i-t as described above. FIG. 8 illustrates a number of poses and a few are described here by way of illustration and example. The hand held flat and parallel to the ground is represented by “11111”. A first is represented by “̂̂̂̂>”. An “OK” sign is represented by “111̂>”.

The character strings provide the opportunity for straightforward ‘human readability’ when using suggestive characters. The set of possible characters that describe each degree of freedom may generally be chosen with an eye to quick recognition and evident analogy. For example, a vertical bar (‘|’) would likely mean that a linkage element is ‘straight’, an ell (‘L’) might mean a ninety-degree bend, and a circumflex (‘A’) could indicate a sharp bend. As noted above, any characters or coding may be used as desired.

Any system employing gesture vocabulary strings such as described herein enjoys the benefit of the high computational efficiency of string comparison—identification of or search for any specified pose literally becomes a ‘string compare’ (e.g. UNIX's ‘strcmp( )’ function) between the desired pose string and the instantaneous actual string. Furthermore, the use of ‘wildcard characters’ provides the programmer or system designer with additional familiar efficiency and efficacy: degrees of freedom whose instantaneous state is irrelevant for a match may be specified as an interrogation point (‘?’); additional wildcard meanings may be assigned.

### Orientation

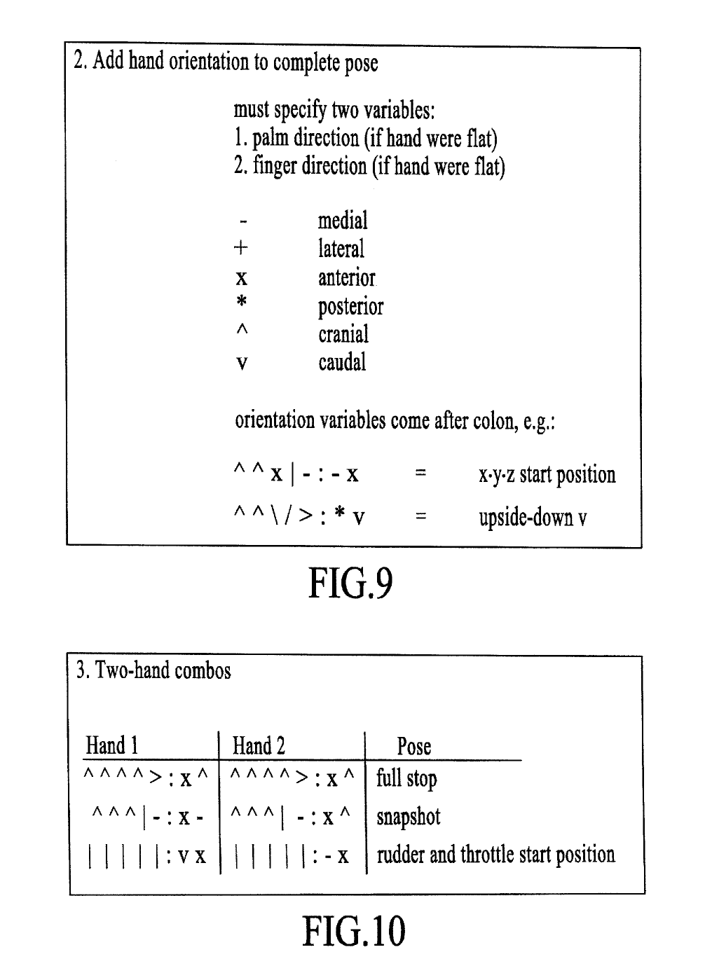

In addition to the pose of the fingers and thumb, the orientation of the hand can represent information. Characters describing global-space orientations can also be chosen transparently: the characters ‘<’, ‘>’, and ‘v’ may be used to indicate, when encountered in an orientation character position, the ideas of left, right, up, and down. FIG. 9 illustrates hand orientation descriptors and examples of coding that combines pose and orientation. In an embodiment, two character positions specify first the direction of the palm and then the direction of the fingers (if they were straight, irrespective of the fingers' actual bends). The possible characters for these two positions express a ‘body-centric’ notion of orientation: ‘−’, ‘+’, ‘x’, ‘*’, ‘̂’, and ‘v’ describe medial, lateral, anterior (forward, away from body), posterior (backward, away from body), cranial (upward), and caudal (downward).

In the notation scheme of an embodiment, the five finger pose indicating characters are followed by a colon and then two orientation characters to define a complete command pose. In one embodiment, a start position is referred to as an “xyz” pose where the thumb is pointing straight up, the index finger is pointing forward and the middle finger is perpendicular to the index finger, pointing to the left when the pose is made with the right hand. This is represented by the string “̂̂x1 -:-x”.

‘XYZ-hand’ is a technique for exploiting the geometry of the human hand to allow full six-degree-of-freedom navigation of visually presented three-dimensional structure. Although the technique depends only on the bulk translation and rotation of the operator's hand—so that its fingers may in principal be held in any pose desired—the present embodiment prefers a static configuration in which the index finger points away from the body; the thumb points toward the ceiling; and the middle finger points left-right. The three fingers thus describe (roughly, but with clearly evident intent) the three mutually orthogonal axes of a three-space coordinate system: thus ‘XYZ-hand’.

XYZ-hand navigation then proceeds with the hand, fingers in a pose as described above, held before the operator's body at a predetermined ‘neutral location’. Access to the three translational and three rotational degrees of freedom of a three-space object (or camera) is effected in the following natural way: left-right movement of the hand (with respect to the body's natural coordinate system) results in movement along the computational context's x-axis; up-down movement of the hand results in movement along the controlled context's y-axis; and forward-back hand movement (toward/away from the operator's body) results in z-axis motion within the context. Similarly, rotation of the operator's hand about the index finger leads to a ‘roll’ change of the computational context's orientation; ‘pitch’ and ‘yaw’ changes are effected analogously, through rotation of the operator's hand about the middle finger and thumb, respectively.

Note that while ‘computational context’ is used here to refer to the entity being controlled by the XYZ-hand method—and seems to suggest either a synthetic three-space object or camera—it should be understood that the technique is equally useful for controlling the various degrees of freedom of real-world objects: the pan/tilt/roll controls of a video or motion picture camera equipped with appropriate rotational actuators, for example. Further, the physical degrees of freedom afforded by the XYZ-hand posture may be somewhat less literally mapped even in a virtual domain: In the present embodiment, the XYZ-hand is also used to provide navigational access to large panoramic display images, so that left-right and up-down motions of the operator's hand lead to the expected left-right or up-down ‘panning’ about the image, but forward-back motion of the operator's hand maps to ‘zooming’ control.

In every case, coupling between the motion of the hand and the induced computational translation/rotation may be either direct (i.e. a positional or rotational offset of the operator's hand maps one-to-one, via some linear or nonlinear function, to a positional or rotational offset of the object or camera in the computational context) or indirect (i.e. positional or rotational offset of the operator's hand maps one-to-one, via some linear or nonlinear function, to a first or higher-degree derivative of position/orientation in the computational context; ongoing integration then effects a non-static change in the computational context's actual zero-order position/orientation). This latter means of control is analogous to use of a an automobile's ‘gas pedal’, in which a constant offset of the pedal leads, more or less, to a constant vehicle speed.

The ‘neutral location’ that serves as the real-world XYZ-hand's local six-degree-of-freedom coordinate origin may be established (1) as an absolute position and orientation in space (relative, say, to the enclosing room); (2) as a fixed position and orientation relative to the operator herself (e.g. eight inches in front of the body, ten inches below the chin, and laterally in line with the shoulder plane), irrespective of the overall position and ‘heading’ of the operator; or (3) interactively, through deliberate secondary action of the operator (using, for example, a gestural command enacted by the operator's ‘other’ hand, said command indicating that the XYZ-hand's present position and orientation should henceforth be used as the translational and rotational origin).

It is further convenient to provide a ‘detent’ region (or ‘dead zone’) about the XYZ-hand's neutral location, such that movements within this volume do not map to movements in the controlled context.

Other poses may included:

[∥∥|:vx] is a flat hand (thumb parallel to fingers) with palm facing down and fingers forward.

[∥∥|:x̂] is a flat hand with palm facing forward and fingers toward ceiling.

[∥∥|:-x] is a flat hand with palm facing toward the center of the body (right if left hand, left if right hand) and fingers forward.

[̂̂̂̂-:-x] is a single-hand thumbs-up (with thumb pointing toward ceiling).

[̂̂̂|-:-x] is a mime gun pointing forward.

### Two Hand Combination

The SOE of an embodiment contemplates single hand commands and poses, as well as two-handed commands and poses. FIG. 10 illustrates examples of two hand combinations and associated notation in an embodiment of the SOE. Reviewing the notation of the first example, “full stop” reveals that it comprises two closed fists. The “snapshot” example has the thumb and index finger of each hand extended, thumbs pointing toward each other, defining a goal post shaped frame. The “rudder and throttle start position” is fingers and thumbs pointing up palms facing the screen.

### Orientation Blends

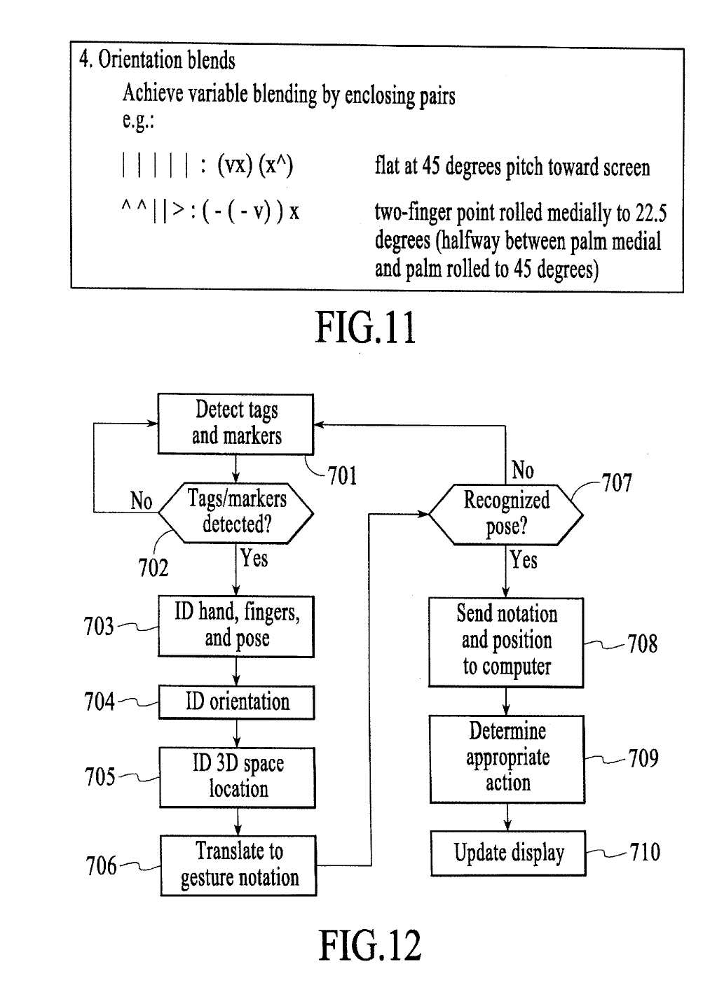

FIG. 11 illustrates an example of an orientation blend in an embodiment of the SOE. In the example shown the blend is represented by enclosing pairs of orientation notations in parentheses after the finger pose string. For example, the first command shows finger positions of all pointing straight. The first pair of orientation commands would result in the palms being flat toward the display and the second pair has the hands rotating to a 45 degree pitch toward the screen. Although pairs of blends are shown in this example, any number of blends is contemplated in the SOE.

### Example Commands

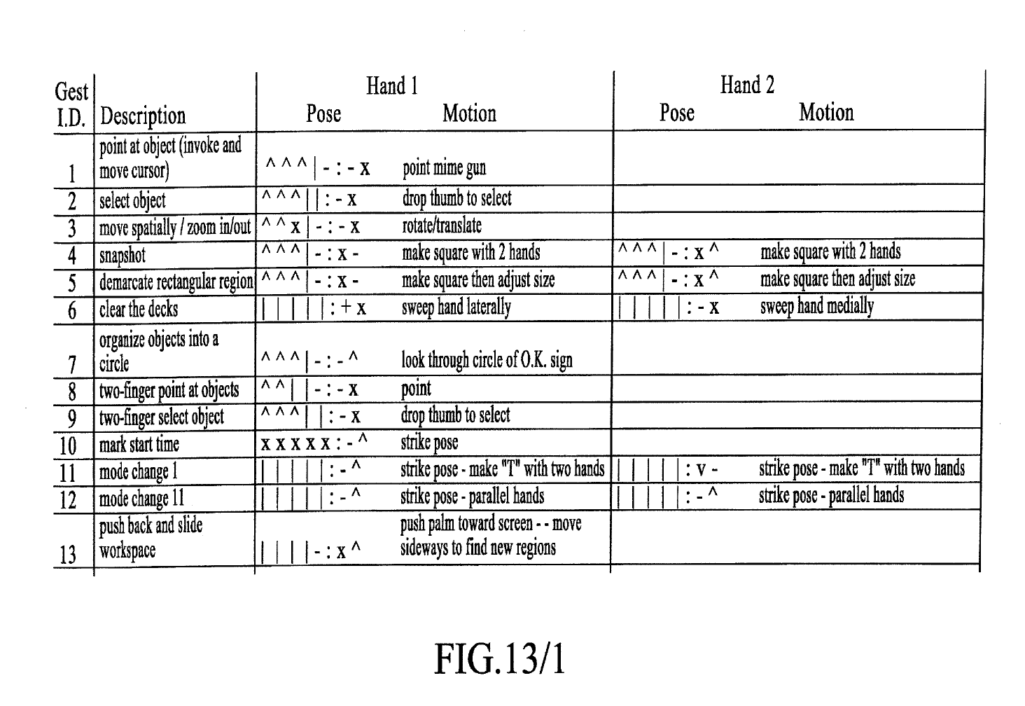

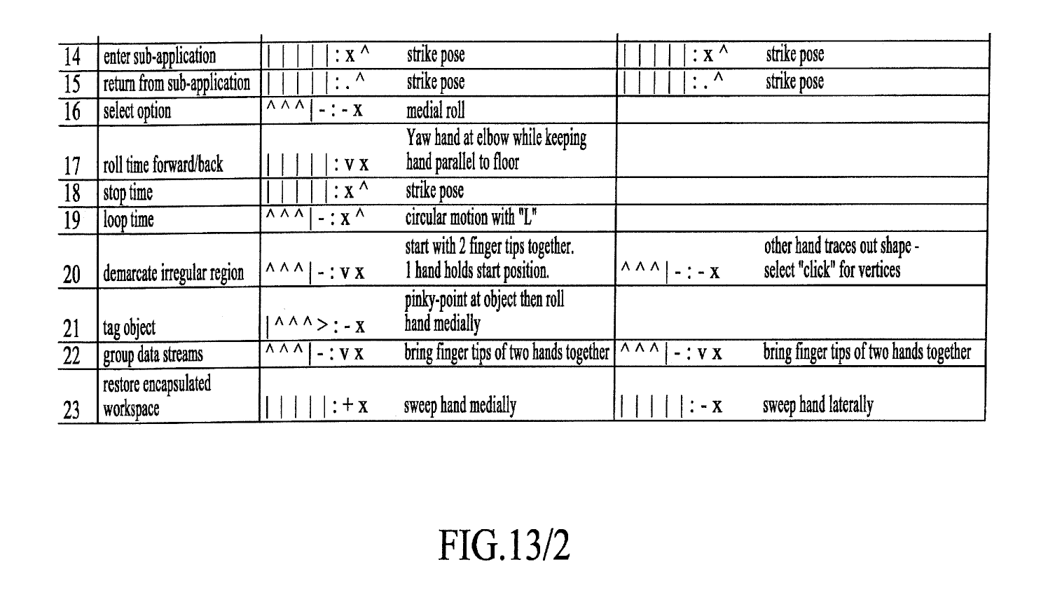

FIGS. 13A and 13B show a number of possible commands that may be used with the SOE. Although some of the discussion here has been about controlling a cursor on a display, the SOE is not limited to that activity. In fact, the SOE has great application in manipulating any and all data and portions of data on a screen, as well as the state of the display. For example, the commands may be used to take the place of video controls during play back of video media. The commands may be used to pause, fast forward, rewind, and the like. In addition, commands may be implemented to zoom in or zoom out of an image, to change the orientation of an image, to pan in any direction, and the like. The SOE may also be used in lieu of menu commands such as open, close, save, and the like. In other words, any commands or activity that can be imagined can be implemented with hand gestures.

### Operation

FIG. 12 is a flow diagram illustrating the operation of the SOE in one embodiment. At 701 the detection system detects the markers and tags. At 702 it is determined if the tags and markers are detected. If not, the system returns to 701. If the tags and markers are detected at 702, the system proceeds to 703. At 703 the system identifies the hand, fingers and pose from the detected tags and markers. At 704 the system identifies the orientation of the pose. At 705 the system identifies the three dimensional spatial location of the hand or hands that are detected. (Please note that any or all of 703, 704, and 705 may be combined).

At 706 the information is translated to the gesture notation described above. At 707 it is determined if the pose is valid. This may be accomplished via a simple string comparison using the generated notation string. If the pose is not valid, the system returns to 701. If the pose is valid, the system sends the notation and position information to the computer at 708. At 709 the computer determines the appropriate action to take in response to the gesture and updates the display accordingly at 710.

In one embodiment of the SOE, 701-705 are accomplished by the on-camera processor. In other embodiments, the processing can be accomplished by the system computer if desired.

### Parsing and Translation

The system is able to “parse” and “translate” a stream of low-level gestures recovered by an underlying system, and turn those parsed and translated gestures into a stream of command or event data that can be used to control a broad range of computer applications and systems. These techniques and algorithms may be embodied in a system consisting of computer code that provides both an engine implementing these techniques and a platform for building computer applications that make use of the engine's capabilities.

One embodiment is focused on enabling rich gestural use of human hands in computer interfaces, but is also able to recognize gestures made by other body parts (including, but not limited to arms, torso, legs and the head), as well as non-hand physical tools of various kinds, both static and articulating, including but not limited to calipers, compasses, flexible curve approximators, and pointing devices of various shapes. The markers and tags may be applied to items and tools that may be carried and used by the operator as desired.

The system described here incorporates a number of innovations that make it possible to build gestural systems that are rich in the range of gestures that can be recognized and acted upon, while at the same time providing for easy integration into applications.

The gestural parsing and translation system in one embodiment comprises:

1) a compact and efficient way to specify (encode for use in computer programs) gestures at several different levels of aggregation:
a. a single hand's “pose” (the configuration and orientation of the parts of the hand relative to one another) a single hand's orientation and position in three-dimensional space.
b. two-handed combinations, for either hand taking into account pose, position or both.
c. multi-person combinations; the system can track more than two hands, and so more than one person can cooperatively (or competitively, in the case of game applications) control the target system.
d. sequential gestures in which poses are combined in a series; we call these “animating” gestures.
e. “grapheme” gestures, in which the operator traces shapes in space.

2) a programmatic technique for registering specific gestures from each category above that are relevant to a given application context.

3) algorithms for parsing the gesture stream so that registered gestures can be identified and events encapsulating those gestures can be delivered to relevant application contexts.

The specification system (1), with constituent elements (1a) to (1f), provides the basis for making use of the gestural parsing and translating capabilities of the system described here.

A single-hand “pose” is represented as a string of

i) relative orientations between the fingers and the back of the hand,

ii) quantized into a small number of discrete states.

Using relative joint orientations allows the system described here to avoid problems associated with differing hand sizes and geometries. No “operator calibration” is required with this system. In addition, specifying poses as a string or collection of relative orientations allows more complex gesture specifications to be easily created by combining pose representations with further filters and specifications.

Using a small number of discrete states for pose specification makes it possible to specify poses compactly as well as to ensure accurate pose recognition using a variety of underlying tracking technologies (for example, passive optical tracking using cameras, active optical tracking using lighted dots and cameras, electromagnetic field tracking, etc).

Gestures in every category (1a) to (1f) may be partially (or minimally) specified, so that non-critical data is ignored. For example, a gesture in which the position of two fingers is definitive, and other finger positions are unimportant, may be represented by a single specification in which the operative positions of the two relevant fingers is given and, within the same string, “wild cards” or generic “ignore these” indicators are listed for the other fingers.

All of the innovations described here for gesture recognition, including but not limited to the multi-layered specification technique, use of relative orientations, quantization of data, and allowance for partial or minimal specification at every level, generalize beyond specification of hand gestures to specification of gestures using other body parts and “manufactured” tools and objects.

The programmatic techniques for “registering gestures” (2), consist of a defined set of Application Programming Interface calls that allow a programmer to define which gestures the engine should make available to other parts of the running system.

These API routines may be used at application set-up time, creating a static interface definition that is used throughout the lifetime of the running application. They may also be used during the course of the run, allowing the interface characteristics to change on the fly. This real-time alteration of the interface makes it possible to,

i) build complex contextual and conditional control states,

ii) to dynamically add hysterisis to the control environment, and

iii) to create applications in which the user is able to alter or extend the interface vocabulary of the running system itself.

Algorithms for parsing the gesture stream (3) compare gestures specified as in (1) and registered as in (2) against incoming low-level gesture data. When a match for a registered gesture is recognized, event data representing the matched gesture is delivered up the stack to running applications.

Efficient real-time matching is desired in the design of this system, and specified gestures are treated as a tree of possibilities that are processed as quickly as possible.

In addition, the primitive comparison operators used internally to recognize specified gestures are also exposed for the applications programmer to use, so that further comparison (flexible state inspection in complex or compound gestures, for example) can happen even from within application contexts.

Recognition “locking” semantics are an innovation of the system described here. These semantics are implied by the registration API (2) (and, to a lesser extent, embedded within the specification vocabulary (1)). Registration API calls include,

i) “entry” state notifiers and “continuation” state notifiers, and

ii) gesture priority specifiers.

If a gesture has been recognized, its “continuation” conditions take precedence over all “entry” conditions for gestures of the same or lower priorities. This distinction between entry and continuation states adds significantly to perceived system usability.

The system described here includes algorithms for robust operation in the face of real-world data error and uncertainty. Data from low-level tracking systems may be incomplete (for a variety of reasons, including occlusion of markers in optical tracking, network drop-out or processing lag, etc).

Missing data is marked by the parsing system, and interpolated into either “last known” or “most likely” states, depending on the amount and context of the missing data.

If data about a particular gesture component (for example, the orientation of a particular joint) is missing, but the “last known” state of that particular component can be analyzed as physically possible, the system uses this last known state in its real-time matching.

Conversely, if the last known state is analyzed as physically impossible, the system falls back to a “best guess range” for the component, and uses this synthetic data in its real-time matching.

The specification and parsing systems described here have been carefully designed to support “handedness agnosticism,” so that for multi-hand gestures either hand is permitted to satisfy pose requirements.

### Navigating Data Space

The SOE of an embodiment enables ‘pushback’, a linear spatial motion of a human operator's hand, or performance of analogously dimensional activity, to control linear verging or trucking motion through a graphical or other data-representational space. The SOE, and the computational and cognitive association established by it, provides a fundamental, structured way to navigate levels of scale, to traverse a principally linear ‘depth dimension’, or—most generally—to access quantized or ‘detented’ parameter spaces. The SOE also provides an effective means by which an operator may volitionally acquire additional context: a rapid technique for understanding vicinities and neighborhoods, whether spatial, conceptual, or computational.

In certain embodiments, the pushback technique may employ traditional input devices (e.g. mouse, trackball, integrated sliders or knobs) or may depend on tagged or tracked objects external to the operator's own person (e.g. instrumented kinematic linkages, magnetostatically tracked ‘input bricks’). In other alternative embodiments, a pushback implementation may suffice as the whole of a control system.

The SOE of an embodiment is a component of and integrated into a larger spatial interaction system that supplants customary mouse-based graphical user interface (‘WIMP’ UI) methods for control of a computer, comprising instead (a) physical sensors that can track one or more types of object (e.g., human hands, objects on human hands, inanimate objects, etc.); (b) an analysis component for analyzing the evolving position, orientation, and pose of the sensed hands into a sequence of gestural events; (c) a descriptive scheme for representing such spatial and gestural events; (d) a framework for distributing such events to and within control programs; (e) methods for synchronizing the human intent (the commands) encoded by the stream of gestural events with graphical, aural, and other display-modal depictions of both the event stream itself and of the application-specific consequences of event interpretation, all of which are described in detail below. In such an embodiment, the pushback system is integrated with additional spatial and gestural input-and-interface techniques.

Generally, the navigation of a data space comprises detecting a gesture of a body from gesture data received via a detector. The gesture data is absolute three-space location data of an instantaneous state of the body at a point in time and physical space. The detecting comprises identifying the gesture using the gesture data. The navigating comprises translating the gesture to a gesture signal, and navigating through the data space in response to the gesture signal. The data space is a data-representational space comprising a dataset represented in the physical space.

When an embodiment's overall round-trip latency (hand motion to sensors to pose analysis to pushback interpretation system to computer graphics rendering to display device back to operator's visual system) is kept low (e.g., an embodiment exhibits latency of approximately fifteen milliseconds) and when other parameters of the system are properly tuned, the perceptual consequence of pushback interaction is a distinct sense of physical causality: the SOE literalizes the physically resonant metaphor of pushing against a spring-loaded structure. The perceived causality is a highly effective feedback; along with other more abstract graphical feedback modalities provided by the pushback system, and with a deliberate suppression of certain degrees of freedom in the interpretation of operator movement, such feedback in turn permits stable, reliable, and repeatable use of both gross and fine human motor activity as a control mechanism.

In evaluating the context of the SOE, many datasets are inherently spatial: they represent phenomena, events, measurements, observations, or structure within a literal physical space. For other datasets that are more abstract or that encode literal yet non-spatial information, it is often desirable to prepare a representation (visual, aural, or involving other display modalities) some fundamental aspect of which is controlled by a single, scalar-valued parameter; associating that parameter with a spatial dimension is then frequently also beneficial. It is manipulation of this single scalar parameter, as is detailed below, which benefits from manipulation by means of the pushback mechanism.

Representations may further privilege a small plurality of discrete values of their parameter—indeed, sometimes only one—at which the dataset is optimally regarded. In such cases it is useful to speak of a ‘detented parameter’ or, if the parameter has been explicitly mapped onto one dimension of a representational space, of ‘detented space’. Use of the term ‘detented’ herein is intended to evoke not only the preferential quantization of the parameter but also the visuo-haptic sensation of ratchets, magnetic alignment mechanisms, jog-shuttle wheels, and the wealth of other worldly devices that are possessed of deliberate mechanical detents.

Self-evident yet crucially important examples of such parameters include but are not limited to (1) the distance of a synthetic camera, in a computer graphics environment, from a renderable representation of a dataset; (2) the density at which data is sampled from the original dataset and converted into renderable form; (3) the temporal index at which samples are retrieved from a time-varying dataset and converted to a renderable representation. These are universal approaches; countless domain-specific parameterizations also exist.

The pushback of the SOE generally aligns the dataset's parameter-control axis with a locally relevant ‘depth dimension’ in physical space, and allows structured real-world motion along the depth dimension to effect a data-space translation along the control axis. The result is a highly efficient means for navigating a parameter space. Following are detailed descriptions of representative embodiments of the pushback as implemented in the SOE.

In a pushback example, an operator stands at a comfortable distance before a large wall display on which appears a single ‘data frame’ comprising text and imagery, which graphical data elements may be static or dynamic. The data frame, for example, can include an image, but is not so limited. The data frame, itself a two-dimensional construct, is nonetheless resident in a three-dimensional computer graphics rendering environment whose underlying coordinate system has been arranged to coincide with real-world coordinates convenient for describing the room and its contents, including the display and the operator.

The operator's hands are tracked by sensors that resolve the position and orientation of her fingers, and possibly of the overall hand masses, to high precision and at a high temporal rate; the system analyzes the resulting spatial data in order to characterize the ‘pose’ of each hand—i.e. the geometric disposition of the fingers relative to each other and to the hand mass. While this example embodiment tracks an object that is a human hand(s), numerous other objects could be tracked as input devices in alternative embodiments. One example is a one-sided pushback scenario in which the body is an operator's hand in the open position, palm facing in a forward direction (along the z-axis) (e.g., toward a display screen in front of the operator). For the purposes of this description, the wall display is taken to occupy the x and y dimensions; z describes the dimension between the operator and the display. The gestural interaction space associated with this pushback embodiment comprises two spaces abutted at a plane of constant z; the detented interval space farther from the display (i.e. closer to the operator) is termed the ‘dead zone’, while the closer half-space is the ‘active zone’. The dead zone extends indefinitely in the backward direction (toward the operator and away from the display) but only a finite distance forward, ending at the dead zone threshold. The active zone extends from the dead zone threshold forward to the display. The data frame(s) rendered on the display are interactively controlled or “pushed back” by movements of the body in the active zone.

The data frame is constructed at a size and aspect ratio precisely matching those of the display, and is positioned and oriented so that its center and normal vector coincide with those physical attributes of the display, although the embodiment is not so limited. The virtual camera used to render the scene is located directly forward from the display and at roughly the distance of the operator. In this context, the rendered frame thus precisely fills the display.

Arranged logically to the left and right of the visible frame are a number of additional coplanar data frames, uniformly spaced and with a modest gap separating each from its immediate neighbors. Because they lie outside the physical/virtual rendering bounds of the computer graphics rendering geometry, these laterally displaced adjacent data frames are not initially visible. As will be seen, the data space—given its geometric structure—is possessed of a single natural detent in the z-direction and a plurality of x-detents.

The operator raises her left hand, held in a loose first pose, to her shoulder. She then extends the fingers so that they point upward and the thumb so that it points to the right; her palm faces the screen (in the gestural description language described in detail below, this pose transition would be expressed as [̂̂̂̂>:x̂ into ∥∥-:x̂ ]). The system, detecting the new pose, triggers pushback interaction and immediately records the absolute three-space hand position at which the pose was first entered: this position is used as the ‘origin’ from which subsequent hand motions will be reported as relative offsets.

Immediately, two concentric, partially transparent glyphs are superimposed on the center of the frame (and thus at the display's center). For example, the glyphs can indicate body pushback gestures in the dead zone up to a point of the dead zone threshold. That the second glyph is smaller than the first glyph is an indication that the operator's hand resides in the dead zone, through which the pushback operation is not ‘yet’ engaged. As the operator moves her hand forward (toward the dead zone threshold and the display), the second glyph incrementally grows. The second glyph is equivalent in size to the first glyph at the point at which the operator's hand is at the dead zone threshold. The glyphs of this example describe the evolution of the glyph's concentric elements as the operator's hand travels forward from its starting position toward the dead zone threshold separating the dead zone from the active zone. The inner “toothy” part of the glyph, for example, grows as the hand nears the threshold, and is arranged so that the radius of the inner glyph and (static) outer glyph precisely match as the hand reaches the threshold position.

The second glyph shrinks in size inside the first glyph as the operator moves her hand away from the dead zone threshold and away from the display, remaining however always concentric with the first glyph and centered on the display. Crucially, only the z-component of the operator's hand motion is mapped into the glyph's scaling; incidental x- and y-components of the hand motion make no contribution.

When the operator's hand traverses the forward threshold of the dead zone, crossing into the active zone, the pushback mechanism is engaged. The relative z-position of the hand (measured from the threshold) is subjected to a scaling function and the resulting value is used to effect a z-axis displacement of the data frame and its lateral neighbors, so that the rendered image of the frame is seen to recede from the display; the neighboring data frames also then become visible, ‘filling in’ from the edges of the display space—the constant angular subtent of the synthetic camera geometrically ‘captures’ more of the plane in which the frames lie as that plane moves away from the camera. The z-displacement is continuously updated, so that the operator, pushing her hand toward the display and pulling it back toward herself, perceives the lateral collection of frames receding and verging in direct response to her movements

As an example of a first relative z-axis displacement of the data frame resulting from corresponding pushback, the rendered image of the data frame is seen to recede from the display and the neighboring data frames become visible, ‘filling in’ from the edges of the display space. The neighboring data frames, which include a number of additional coplanar data frames, are arranged logically to the left and right of the visible frame, uniformly spaced and with a modest gap separating each from its immediate neighbors. As an example of a second relative z-axis displacement of the data frame resulting from corresponding pushback, and considering the first relative z-axis displacement, and assuming further pushing of the operator's hand (pushing further along the z-axis toward the display and away from the operator) from that pushing resulting in the first relative z-axis displacement, the rendered image of the frame is seen to further recede from the display so that additional neighboring data frames become visible, further ‘filling in’ from the edges of the display space.

The paired concentric glyphs, meanwhile, now exhibit a modified feedback: with the operator's hand in the active zone, the second glyph switches from scaling-based reaction to a rotational reaction in which the hand's physical z-axis offset from the threshold is mapped into a positive (in-plane) angular offset. In an example of the glyphs indicating body pushback gestures in the dead zone beyond the point of the dead zone threshold (along the z-axis toward the display and away from the operator), the glyphs depict the evolution of the glyph once the operator's hand has crossed the dead zone threshold—i.e. when the pushback mechanism has been actively engaged. The operator's hand movements toward and away from the display are thus visually indicated by clockwise and anticlockwise rotation of the second glyph (with the first glyph, as before, providing a static reference state), such that the “toothy” element of the glyph rotates as a linear function of the hand's offset from the threshold, turning linear motion into a rotational representation.

Therefore, in this example, an additional first increment of hand movement along the z-axis toward the display is visually indicated by an incremental clockwise rotation of the second glyph (with the first glyph, as before, providing a static reference state), such that the “toothy” element of the glyph rotates a first amount corresponding to a linear function of the hand's offset from the threshold. An additional second increment of hand movement along the z-axis toward the display is visually indicated by an incremental clockwise rotation of the second glyph (with the first glyph, as before, providing a static reference state), such that the “toothy” element of the glyph rotates a second amount corresponding to a linear function of the hand's offset from the threshold. Further, a third increment of hand movement along the z-axis toward the display is visually indicated by an incremental clockwise rotation of the second glyph (with the first glyph, as before, providing a static reference state), such that the “toothy” element of the glyph rotates a third amount corresponding to a linear function of the hand's offset from the threshold.

In this sample application, a secondary dimensional sensitivity is engaged when the operator's hand is in the active zone: lateral (x-axis) motion of the hand is mapped, again through a possible scaling function, to x-displacement of the horizontal frame sequence. If the scaling function is positive, the effect is one of positional ‘following’ of the operator's hand, and she perceives that she is sliding the frames left and right. As an example of a lateral x-axis displacement of the data frame resulting from lateral motion of the body, the data frames slide from left to right such that particular data frames disappear or partially disappear from view via the left edge of the display space while additional data frames fill in from the right edge of the display space.

Finally, when the operator causes her hand to exit the palm-forward pose (by, e.g., closing the hand into a fist), the pushback interaction is terminated and the collection of frames is rapidly returned to its original z-detent (i.e. coplanar with the display). Simultaneously, the frame collection is laterally adjusted to achieve x-coincidence of a single frame with the display; which frame ends thus ‘display-centered’ is whichever was closest to the concentric glyphs' center at the instant of pushback termination: the nearest x-detent. The glyph structure is here seen serving a second function, as a selection reticle, but the embodiment is not so limited. The z- and x-positions of the frame collection are typically allowed to progress to their final display-coincident values over a short time interval in order to provide a visual sense of ‘spring-loaded return’.

The pushback system as deployed in this example provides efficient control modalities for (1) acquiring cognitively valuable ‘neighborhood context’ by variably displacing an aggregate dataset along the direct visual sightline—the depth dimension—thereby bringing more of the dataset into view (in exchange for diminishing the angular subtent of any given part of the dataset); (2) acquiring neighborhood context by variably displacing the laterally-arrayed dataset along its natural horizontal dimension, maintaining the angular subtent of any given section of data but trading the visibility of old data for that of new data, in the familiar sense of ‘scrolling’; (3) selecting discretized elements of the dataset through rapid and dimensionally-constrained navigation.

In another example of the pushback of an embodiment, an operator stands immediately next to a waist-level display device whose active surface lies in a horizontal plane parallel to the floor. The coordinate system is here established in a way consistent with that of the previous example: the display surface lies in the x-z plane, so that the y-axis, representing the normal to the surface, is aligned in opposition to the physical gravity vector.

In an example physical scenario in which the body is held horizontally above a table-like display surface, the body is an operator's hand, but the embodiment is not so limited. The pushback interaction is double-sided, so that there is an upper dead zone threshold and a lower dead zone threshold. Additionally, the linear space accessed by the pushback maneuver is provided with discrete spatial detents (e.g., “1^{st} detent”, “2^{nd} detent”, “3^{rd} detent”, “4^{th} detent”) in the upper active zone, and discrete spatial detents (e.g., “1^{st} detent”, “2^{nd} detent”, “3^{rd} detent”, “4^{th} detent”) in the lower active zone. The interaction space of an embodiment is configured so that a relatively small dead zone comprising an upper dead zone and a lower dead zone is centered at the vertical (y-axis) position at which pushback is engaged, with an active zone above the dead zone and an active zone below the dead zone.

The operator is working with an example dataset that has been analyzed into a stack of discrete parallel planes that are the data frames. The dataset may be arranged that way as a natural consequence of the physical reality it represents (e.g. discrete slices from a tomographic scan, the multiple layers of a three-dimensional integrated circuit, etc.) or because it is logical or informative to separate and discretize the data (e.g., satellite imagery acquired in a number of spectral bands, geographically organized census data with each decade's data in a separate layer, etc.). The visual representation of the data may further be static or include dynamic elements.

During intervals when pushback functionality is not engaged, a single layer is considered ‘current’ and is represented with visual prominence by the display, and is perceived to be physically coincident with the display. Layers above and below the current layer are in this example not visually manifest (although a compact iconography is used to indicate their presence).

The operator extends his closed right hand over the display; when he opens the hand—fingers extended forward, thumb to the left, and palm pointed downward (transition: [̂̂̂̂>:vx into ∥∥-:vx])—the pushback system is engaged. During a brief interval (e.g., 200 milliseconds), some number of layers adjacent to the current layer fade up with differential visibility; each is composited below or above with a blur filter and a transparency whose ‘severities’ are dependent on the layer's ordinal distance from the current layer.

For example, a layer (e.g., data frame) adjacent to the current layer (e.g., data frame) fades up with differential visibility as the pushback system is engaged. In this example, the stack comprises numerous data frames (any number as appropriate to datasets of the data frames) that can be traversed using the pushback system.

Simultaneously, the concentric feedback glyphs familiar from the previous example appear; in this case, the interaction is configured so that a small dead zone is centered at the vertical (y-axis) position at which pushback is engaged, with an active zone both above and below the dead zone. This arrangement provides assistance in ‘regaining’ the original layer. The glyphs are in this case accompanied by an additional, simple graphic that indicates directed proximity to successive layers.

While the operator's hand remains in the dead zone, no displacement of the layer stack occurs. The glyphs exhibit a ‘preparatory’ behavior identical to that in the preceding example, with the inner glyph growing as the hand nears either boundary of the zone (of course, here the behavior is double-sided and symmetric: the inner glyph is at a minimum scale at the hand's starting y-position and grows toward coincidence with the outer glyph whether the hand moves up or down).

As the operator's hand moves upward past the dead zone's upper plane, the inner glyph engages the outer glyph and, as before, further movement of the hand in that direction causes anticlockwise rotational motion of the inner glyph. At the same time, the layer stack begins to ‘translate upward’: those layers above the originally-current layer take on greater transparency and blur; the originally-current layer itself becomes more transparent and more blurred; and the layers below it move toward more visibility and less blur.

In another example of upward translation of the stack, the previously-current layer takes on greater transparency (becomes invisible in this example), while the layer adjacent to the previously-current layer becomes visible as the presently-current layer. Additionally, layer adjacent to the presently-current layer fades up with differential visibility as the stack translates upward. As described above, the stack comprises numerous data frames (any number as appropriate to datasets of the data frames) that can be traversed using the pushback system.

The layer stack is configured with a mapping between real-world distances (i.e. the displacement of the operator's hand from its initial position, as measured in room coordinates) and the ‘logical’ distance between successive layers. The translation of the layer stack is, of course, the result of this mapping, as is the instantaneous appearance of the proximity graphic, which meanwhile indicates (at first) a growing distance between the display plane and the current layer; it also indicates that the display plane is at present below the current layer.

The hand's motion continues and the layer stack eventually passes the position at which the current layer and the next one below exactly straddle (i.e. are equidistant from) the display plane; just past this point the proximity graphic changes to indicate that the display plane is now higher than the current layer: ‘current layer status’ has now been assigned to the next lower layer. In general, the current layer is always the one closest to the physical display plane, and is the one that will be ‘selected’ when the operator disengages the pushback system.

As the operator continues to raise his hand, each consecutive layer is brought toward the display plane, becoming progressively more resolved, gaining momentary coincidence with the display plane, and then returning toward transparency and blur in favor of the next lower layer. When the operator reverses the direction of his hand's motion, lowering it, the process is reversed, and the inner glyph rotates clockwise. As the hand eventually passes through the dead zone the stack halts with the originally-current layer in precise y-alignment with the display plane; and then y-travel of the stack resumes, bringing into successive focus those planes above the originally-current layer. The operator's overall perception is strongly and simply that he is using his hand to push down and pull up a stack of layers.

When at last the operator releases pushback by closing his hand (or otherwise changing its pose) the system ‘springs’ the stack into detented y-axis alignment with the display plane, leaving as the current layer whichever was closest to the display plane as pushback was exited. During the brief interval of this positional realignment, all other layers fade back to complete transparency and the feedback glyphs smoothly vanish.

The discretized elements of the dataset (here, layers) of this example are distributed along the principal pushback (depth) axis; previously, the elements (data frames) were coplanar and arrayed laterally, along a dimension orthogonal to the depth axis. This present arrangement, along with the deployment of transparency techniques, means that data is often superimposed—some layers are viewed through others. The operator in this example nevertheless also enjoys (1) a facility for rapidly gaining neighborhood context (what are the contents of the layers above and below the current layer?); and (2) a facility for efficiently selecting and switching among parallel, stacked elements in the dataset. When the operator intends (1) alone, the provision of a dead zone allows him to return confidently to the originally selected layer. Throughout the manipulation, the suppression of two translational dimensions enables speed and accuracy (it is comparatively difficult for most humans to translate a hand vertically with no lateral drift, but the modality as described simply ignores any such lateral displacement).

It is noted that for certain purposes it may be convenient to configure the pushback input space so that the dead zone is of infinitesimal extent; then, as soon as pushback is engaged, its active mechanisms are also engaged. In the second example presented herein this would mean that the originally-current layer is treated no differently—once the pushback maneuver has begun—from any other. Empirically, the linear extent of the dead zone is a matter of operator preference.

The modalities described in this second example are pertinent across a wide variety of displays, including both two-dimensional (whether projected or emissive) and three-dimensional (whether autostereoscopic or not, aerial-image-producing or not, etc.) devices. In high-quality implementations of the latter—i.e. 3D—case, certain characteristics of the medium can vastly aid the perceptual mechanisms that underlie pushback. For example, a combination of parallax, optical depth of field, and ocular accommodation phenomena can allow multiple layers to be apprehended simultaneously, thus eliminating the need to severely fade and blur (or indeed to exclude altogether) layers distant from the display plane. The modalities apply, further, irrespective of the orientation of the display: it may be principally horizontal, as in the example, or may just as usefully be mounted at eye-height on a wall.

An extension to the scenario of this second example depicts the usefulness of two-handed manipulation. In certain applications, translating either the entire layer stack or an individual layer laterally (i.e. in the x and z directions) is necessary. In an embodiment, the operator's other—that is, non-pushback—hand can effect this transformation, for example through a modality in which bringing the hand into close proximity to the display surface allows one of the dataset's layers to be ‘slid around’, so that its offset x-z position follows that of the hand.

Operators may generally find it convenient and easily tractable to undertake lateral translation and pushback manipulations simultaneously. It is perhaps not wholly fatuous to propose that the assignment of continuous-domain manipulations to one hand and discrete-style work to the other may act to optimize cognitive load.

It is informative to consider yet another example of pushback under the SOE in which there is no natural visual aspect to the dataset. Representative is the problem of monitoring a plurality of audio channels and of intermittently selecting one from among the collection. An application of the pushback system enables such a task in an environment outfitted for aural but not visual output; the modality is remarkably similar to that of the preceding example.

An operator, standing or seated, is listening to a single channel of audio. Conceptually, this audio exists in the vertical plane—called the ‘aural plane’—that geometrically includes her ears; additional channels of audio are resident in additional planes parallel to the aural plane but displaced forward and back, along the z-axis.

Opening her hand, held nine inches in front of her, with palm facing forward, she engages the pushback system. The audio in several proximal planes fades up differentially; the volume of each depends inversely on its ordinal distance from the current channel's plane. In practice, it is perceptually unrealistic to allow more than two or four additional channels to become audible. At the same time, an ‘audio glyph’ fades up to provide proximity feedback. Initially, while the operator's hand is held in the dead zone, the glyph is a barely audible two-note chord (initially in unison).

As the operator moves her hand forward or backward through the dead zone, the volumes of the audio channels remain fixed while that of the glyph increases. When the hand crosses the front or rear threshold of the dead zone, the glyph reaches its ‘active’ volume (which is still subordinate to the current channel's volume).

Once the operator's hand begins moving through the active zone—in the forward direction, say—the expected effect on the audio channels obtains: the current channel plane is pushed farther from the aural plane, and its volume (and the volumes of those channels still farther forward) is progressively reduced. The volume of each ‘dorsal’ channel plane, on the other hand, increases as it nears the aural plane.

The audio glyph, meanwhile, has switched modes. The hand's forward progress is accompanied by the rise in frequency of one of the tones; at the ‘midway point’, when the aural plane bisects one audio channel plane and the next, the tones form an exact fifth (mathematically, it should be a tritone interval, but there is an abundance of reasons that this is to be eschewed). The variable tone's frequency continues rising as the hand continues farther forward, until eventually the operator ‘reaches’ the next audio plane, at which point the tones span precisely an octave.

Audition of the various channels proceeds, the operator translating her hand forward and back to access each in turn. Finally, to select one she merely closes her hand, concluding the pushback session and causing the collection of audio planes to ‘spring’ into alignment. The other (non-selected) channels fade to inaudibility, as does the glyph.

This example has illustrated a variant on pushback application in which the same facilities are again afforded: access to neighborhood context and rapid selection of discretized data element (here, an individual audio stream). The scenario substitutes an aural feedback mechanism, and in particular one that exploits the reliable human capacity for discerning certain frequency intervals, to provide the operator with information about whether she is ‘close enough’ to a target channel to make a selection. This is particularly important in the case of voice channels, in which ‘audible’ signals are only intermittently present; the continuous nature of the audio feedback glyph leaves it present and legible even when the channel itself has gone silent.

It is noted that if the SOE in this present example includes the capacity for spatialized audio, the perception of successive audio layers receding into the forward distance and approaching from the back (or vice versa) may be greatly enhanced. Further, the opportunity to more literally ‘locate’ the selected audio plane at the position of the operator, with succeeding layers in front of the operator and preceding layers behind, is usefully exploitable.

Other instantiations of the audio glyph are possible, and indeed the nature of the various channels' contents, including their spectral distributions, tends to dictate which kind of glyph will be most clearly discernible. By way of example, another audio glyph format maintains constant volume but employs periodic clicking, with the interval between clicks proportional to the proximity between the aural plane and the closest audio channel plane. Finally, under certain circumstances, and depending on the acuity of the operator, it is possible to use audio pushback with no feedback glyph at all.

With reference to the pushback mechanism, as the number and density of spatial detents in the dataset's representation increases toward the very large, the space and its parameterization becomes effectively continuous—that is to say, non-detented. Pushback remains nonetheless effective at such extremes, in part because the dataset's ‘initial state’ prior to each invocation of pushback may be treated as a temporary detent, realized simply as a dead zone.

An application of such non-detented pushback may be found in connection with the idea of an infinitely (or at least substantially) zoomable diagram. Pushback control of zoom functionality associates offset hand position with affine scale value, so that as the operator pushes his hand forward or back the degree of zoom decreases or increases (respectively). The original, pre-pushback zoom state is always readily accessible, however, because the direct mapping of position to zoom parameter insures that returning the control hand to the dead zone also effects return of the zoom value to its initial state.

Each scenario described in the examples above provides a description of the salient aspects of the pushback system and its use under the SOE. It should further be understood that each of the maneuvers described herein can be accurately and comprehensibly undertaken in a second or less, because of the efficiency and precision enabled by allowing a particular kind of perceptual feedback to guide human movement. At other times, operators also find it useful to remain in a single continuous pushback ‘session’ for tens of seconds: exploratory and context-acquisition goals are well served by pushback over longer intervals.

The examples described above employed a linear mapping of physical input (gesture) space to representational space: translating the control hand by A units in real space always results in a translation by B units [prime] in the representational space, irrespective of the real-space position at which the A-translation is undertaken. However, other mappings are possible. In particular, the degree of fine motor control enjoyed by most human operators allows the use of nonlinear mappings, in which for example differential gestural translations far from the active threshold can translate into larger displacements along the parameterized dimension than do gestural translations near the threshold.

### Coincident Virtual/Display and Physical Spaces

The system can provide an environment in which virtual space depicted on one or more display devices (“screens”) is treated as coincident with the physical space inhabited by the operator or operators of the system. An embodiment of such an environment is described here. This current embodiment includes three projector-driven screens at fixed locations, is driven by a single desktop computer, and is controlled using the gestural vocabulary and interface system described herein. Note, however, that any number of screens are supported by the techniques being described; that those screens may be mobile (rather than fixed); that the screens may be driven by many independent computers simultaneously; and that the overall system can be controlled by any input device or technique.

The interface system described in this disclosure should have a means of determining the dimensions, orientations and positions of screens in physical space. Given this information, the system is able to dynamically map the physical space in which these screens are located (and which the operators of the system inhabit) as a projection into the virtual space of computer applications running on the system. As part of this automatic mapping, the system also translates the scale, angles, depth, dimensions and other spatial characteristics of the two spaces in a variety of ways, according to the needs of the applications that are hosted by the system.

This continuous translation between physical and virtual space makes possible the consistent and pervasive use of a number of interface techniques that are difficult to achieve on existing application platforms or that must be implemented piece-meal for each application running on existing platforms. These techniques include (but are not limited to):

1) Use of “literal pointing”—using the hands in a gestural interface environment, or using physical pointing tools or devices—as a pervasive and natural interface technique.

2) Automatic compensation for movement or repositioning of screens.

3) Graphics rendering that changes depending on operator position, for example simulating parallax shifts to enhance depth perception.

4) Inclusion of physical objects in on-screen display—taking into account real-world position, orientation, state, etc. For example, an operator standing in front of a large, opaque screen, could see both applications graphics and a representation of the true position of a scale model that is behind the screen (and is, perhaps, moving or changing orientation).

It is important to note that literal pointing is different from the abstract pointing used in mouse-based windowing interfaces and most other contemporary systems. In those systems, the operator must learn to manage a translation between a virtual pointer and a physical pointing device, and must map between the two cognitively.

By contrast, in the systems described in this disclosure, there is no difference between virtual and physical space (except that virtual space is more amenable to mathematical manipulation), either from an application or user perspective, so there is no cognitive translation required of the operator.

The closest analogy for the literal pointing provided by the embodiment described here is the touch-sensitive screen (as found, for example, on many ATM machines). A touch-sensitive screen provides a one to one mapping between the two-dimensional display space on the screen and the two-dimensional input space of the screen surface. In an analogous fashion, the systems described here provide a flexible mapping (possibly, but not necessarily, one to one) between a virtual space displayed on one or more screens and the physical space inhabited by the operator. Despite the usefulness of the analogy, it is worth understanding that the extension of this “mapping approach” to three dimensions, an arbritrarialy large architectural environment, and multiple screens is non-trivial.

In addition to the components described herein, the system may also implement algorithms implementing a continuous, systems-level mapping (perhaps modified by rotation, translation, scaling or other geometrical transformations) between the physical space of the environment and the display space on each screen.

A rendering stack which takes the computational objects and the mapping and outputs a graphical representation of the virtual space.

An input events processing stack which takes event data from a control system (in the current embodiment both gestural and pointing data from the system and mouse input) and maps spatial data from input events to coordinates in virtual space. Translated events are then delivered to running applications.

A “glue layer” allowing the system to host applications running across several computers on a local area network.

Embodiments of a spatial-continuum input system are described herein as comprising network-based data representation, transit, and interchange that includes a system called “plasma” that comprises subsystems “slawx”, “proteins”, and “pools”, as described in detail below. The pools and proteins are components of methods and systems described herein for encapsulating data that is to be shared between or across processes. These mechanisms also include slawx (plural of “slaw”) in addition to the proteins and pools. Generally, slawx provide the lowest-level of data definition for inter-process exchange, proteins provide mid-level structure and hooks for querying and filtering, and pools provide for high-level organization and access semantics. Slawx include a mechanism for efficient, platform-independent data representation and access. Proteins provide a data encapsulation and transport scheme using slawx as the payload. Pools provide structured and flexible aggregation, ordering, filtering, and distribution of proteins within a process, among local processes, across a network between remote or distributed processes, and via longer term (e.g. on-disk, etc.) storage.

The configuration and implementation of the embodiments described herein include several constructs that together enable numerous capabilities. For example, the embodiments described herein provide efficient exchange of data between large numbers of processes as described above. The embodiments described herein also provide flexible data “typing” and structure, so that widely varying kinds and uses of data are supported. Furthermore, embodiments described herein include flexible mechanisms for data exchange (e.g., local memory, disk, network, etc.), all driven by substantially similar application programming interfaces (APIs). Moreover, embodiments described enable data exchange between processes written in different programming languages. Additionally, embodiments described herein enable automatic maintenance of data caching and aggregate state.

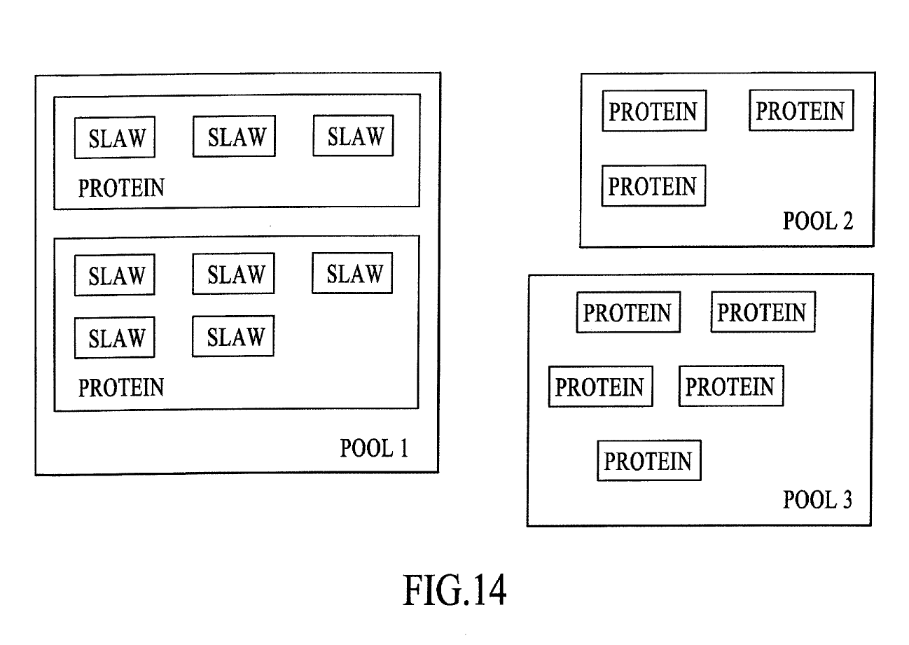

FIG. 14 is a block diagram of a processing environment including data representations using slawx, proteins, and pools, under an embodiment. The principal constructs of the embodiments presented herein include slawx (plural of “slaw”), proteins, and pools. Slawx as described herein includes a mechanism for efficient, platform-independent data representation and access. Proteins, as described in detail herein, provide a data encapsulation and transport scheme, and the payload of a protein of an embodiment includes slawx. Pools, as described herein, provide structured yet flexible aggregation, ordering, filtering, and distribution of proteins. The pools provide access to data, by virtue of proteins, within a process, among local processes, across a network between remote or distributed processes, and via ‘longer term’ (e.g. on-disk) storage.

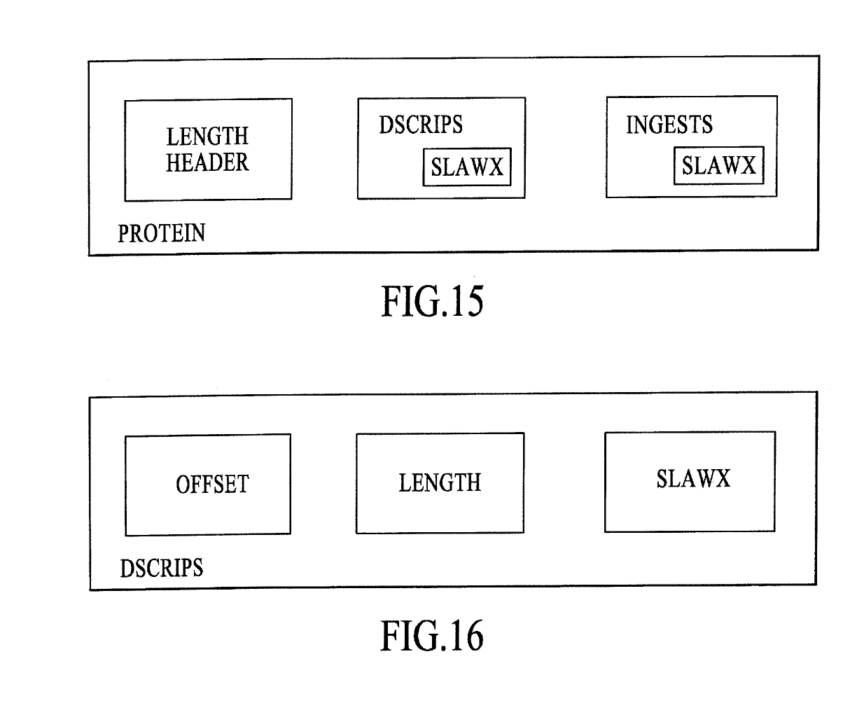

FIG. 15 is a block diagram of a protein, under an embodiment. The protein includes a length header, a descrip, and an ingest. Each of the descrip and ingest includes slaw or slawx, as described in detail below.

FIG. 16 is a block diagram of a descrip, under an embodiment. The descrip includes an offset, a length, and slawx, as described in detail below.

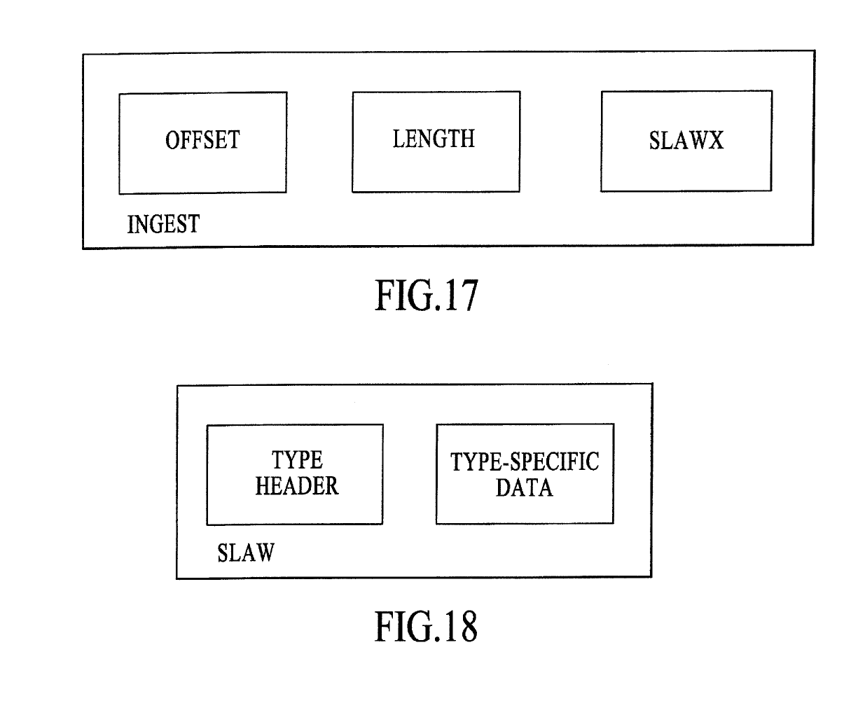

FIG. 17 is a block diagram of an ingest, under an embodiment. The ingest includes an offset, a length, and slawx, as described in detail below.

FIG. 18 is a block diagram of a slaw, under an embodiment. The slaw includes a type header and type-specific data, as described in detail below.

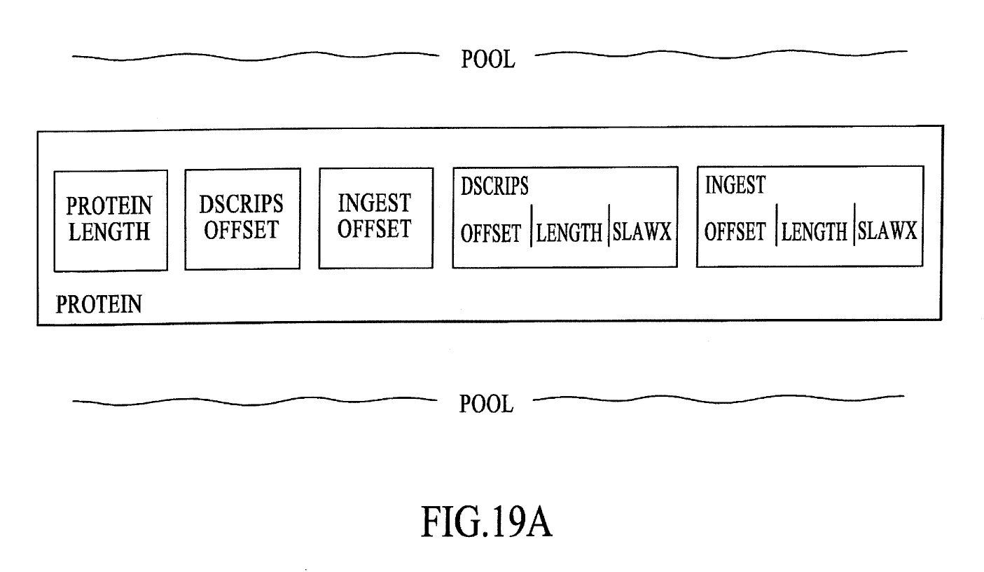

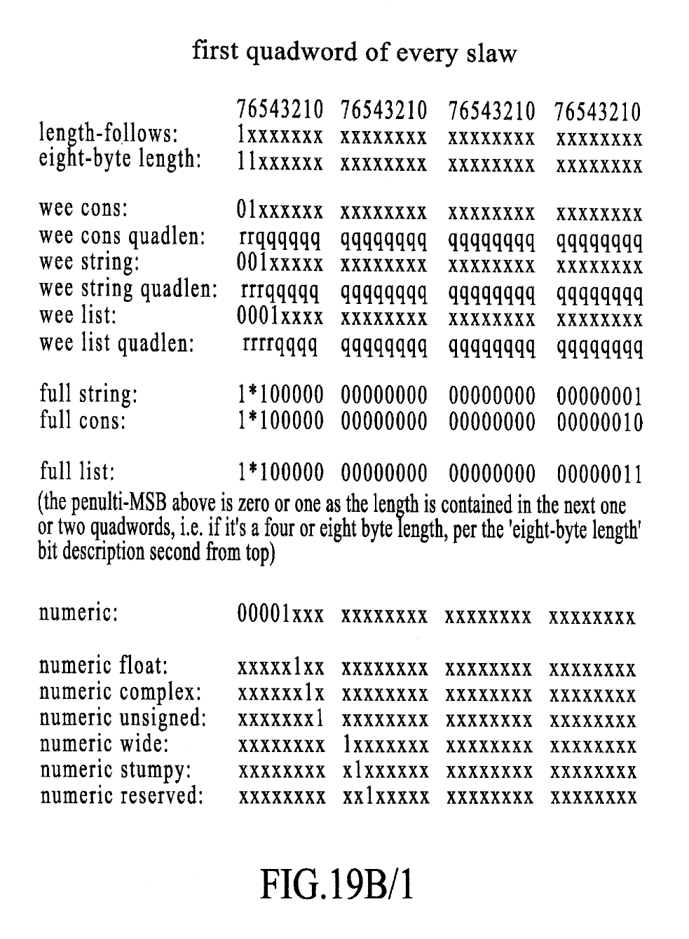

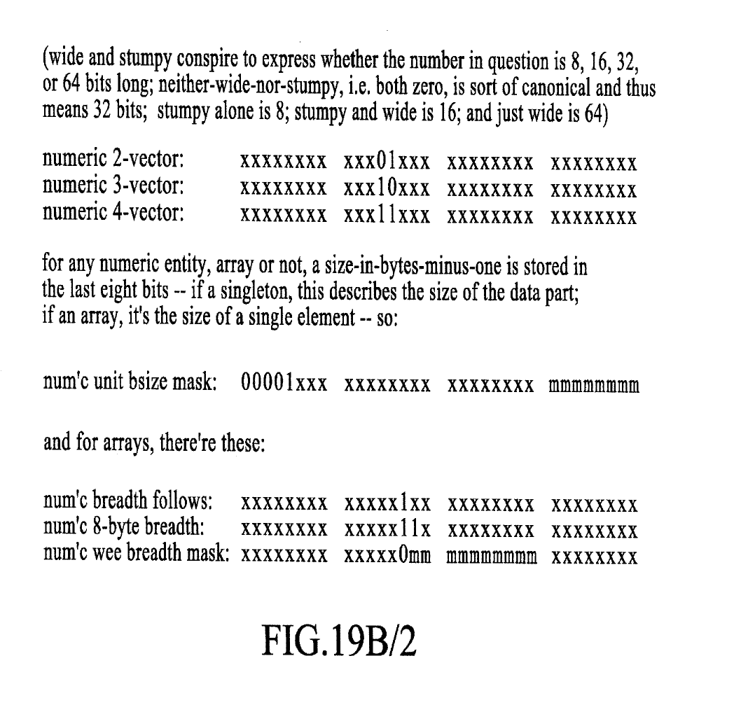

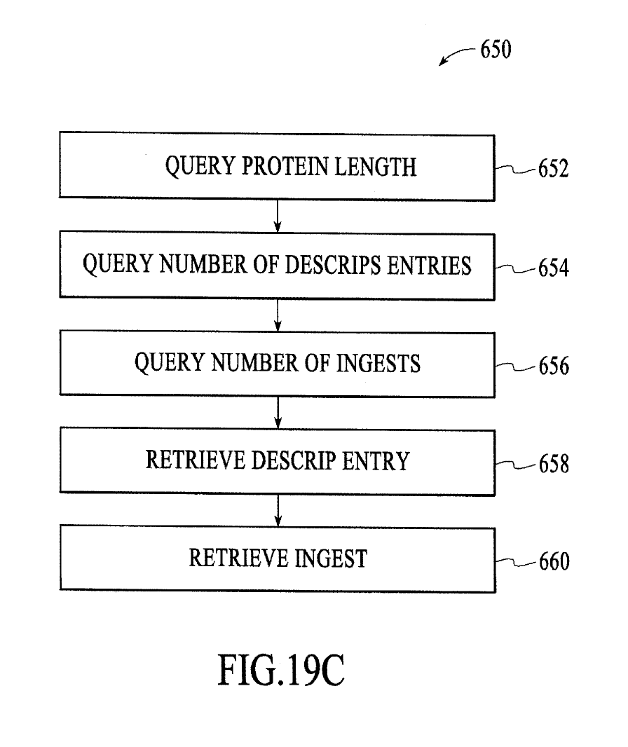

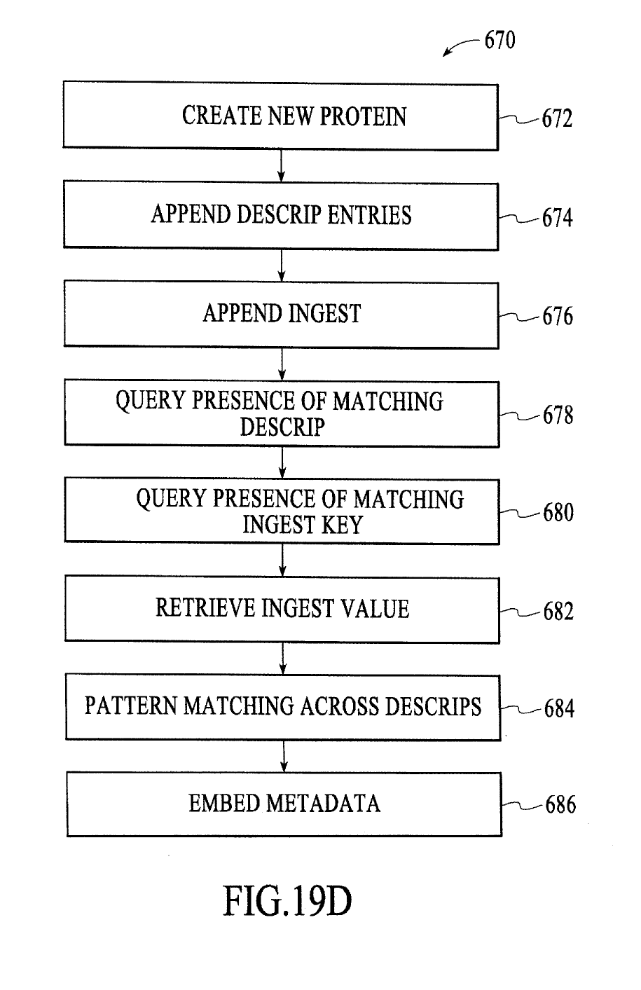

FIG. 19A is a block diagram of a protein in a pool, under an embodiment. The protein includes a length header (“protein length”), a descrips offset, an ingests offset, a descrip, and an ingest. The descrips includes an offset, a length, and a slaw. The ingest includes an offset, a length, and a slaw.

The protein as described herein is a mechanism for encapsulating data that needs to be shared between processes, or moved across a bus or network or other processing structure. As an example, proteins provide an improved mechanism for transport and manipulation of data including data corresponding to or associated with user interface events; in particular, the user interface events of an embodiment include those of the gestural interface described above. As a further example, proteins provide an improved mechanism for transport and manipulation of data including, but not limited to, graphics data or events, and state information, to name a few. A protein is a structured record format and an associated set of methods for manipulating records. Manipulation of records as used herein includes putting data into a structure, taking data out of a structure, and querying the format and existence of data. Proteins are configured to be used via code written in a variety of computer languages. Proteins are also configured to be the basic building block for pools, as described herein. Furthermore, proteins are configured to be natively able to move between processors and across networks while maintaining intact the data they include.

In contrast to conventional data transport mechanisms, proteins are untyped. While being untyped, the proteins provide a powerful and flexible pattern-matching facility, on top of which “type-like” functionality is implemented. Proteins configured as described herein are also inherently multi-point (although point-to-point forms are easily implemented as a subset of multi-point transmission). Additionally, proteins define a “universal” record format that does not differ (or differs only in the types of optional optimizations that are performed) between in-memory, on-disk, and on-the-wire (network) formats, for example.

Referring to FIGS. 15 and 19A, a protein of an embodiment is a linear sequence of bytes. Within these bytes are encapsulated a descrips list and a set of key-value pairs called ingests. The descrips list includes an arbitrarily elaborate but efficiently filterable per-protein event description. The ingests include a set of key-value pairs that comprise the actual contents of the protein.

Proteins' concern with key-value pairs, as well as some core ideas about network-friendly and multi-point data interchange, is shared with earlier systems that privilege the concept of “tuples” (e.g., Linda, Jini). Proteins differ from tuple-oriented systems in several major ways, including the use of the descrips list to provide a standard, optimizable pattern matching substrate. Proteins also differ from tuple-oriented systems in the rigorous specification of a record format appropriate for a variety of storage and language constructs, along with several particular implementations of “interfaces” to that record format.

Turning to a description of proteins, the first four or eight bytes of a protein specify the protein's length, which must be a multiple of 16 bytes in an embodiment. This 16-byte granularity ensures that byte-alignment and bus-alignment efficiencies are achievable on contemporary hardware. A protein that is not naturally “quad-word aligned” is padded with arbitrary bytes so that its length is a multiple of 16 bytes.

The length portion of a protein has the following format: 32 bits specifying length, in big-endian format, with the four lowest-order bits serving as flags to indicate macro-level protein structure characteristics; followed by 32 further bits if the protein's length is greater than 2̂32 bytes.

The 16-byte-alignment proviso of an embodiment means that the lowest order bits of the first four bytes are available as flags. And so the first three low-order bit flags indicate whether the protein's length can be expressed in the first four bytes or requires eight, whether the protein uses big-endian or little-endian byte ordering, and whether the protein employs standard or non-standard structure, respectively, but the protein is not so limited. The fourth flag bit is reserved for future use.

If the eight-byte length flag bit is set, the length of the protein is calculated by reading the next four bytes and using them as the high-order bytes of a big-endian, eight-byte integer (with the four bytes already read supplying the low-order portion). If the little-endian flag is set, all binary numerical data in the protein is to be interpreted as little-endian (otherwise, big-endian). If the non-standard flag bit is set, the remainder of the protein does not conform to the standard structure to be described below.

Non-standard protein structures will not be discussed further herein, except to say that there are various methods for describing and synchronizing on non-standard protein formats available to a systems programmer using proteins and pools, and that these methods can be useful when space or compute cycles are constrained. For example, the shortest protein of an embodiment is sixteen bytes. A standard-format protein cannot fit any actual payload data into those sixteen bytes (the lion's share of which is already relegated to describing the location of the protein's component parts). But a non-standard format protein could conceivably use 12 of its 16 bytes for data. Two applications exchanging proteins could mutually decide that any 16-byte-long proteins that they emit always include 12 bytes representing, for example, 12 8-bit sensor values from a real-time analog-to-digital converter.

Immediately following the length header, in the standard structure of a protein, two more variable-length integer numbers appear. These numbers specify offsets to, respectively, the first element in the descrips list and the first key-value pair (ingest). These offsets are also referred to herein as the descrips offset and the ingests offset, respectively. The byte order of each quad of these numbers is specified by the protein endianness flag bit. For each, the most significant bit of the first four bytes determines whether the number is four or eight bytes wide. If the most significant bit (msb) is set, the first four bytes are the most significant bytes of a double-word (eight byte) number. This is referred to herein as “offset form”. Use of separate offsets pointing to descrips and pairs allows descrips and pairs to be handled by different code paths, making possible particular optimizations relating to, for example, descrips pattern-matching and protein assembly. The presence of these two offsets at the beginning of a protein also allows for several useful optimizations.

Most proteins will not be so large as to require eight-byte lengths or pointers, so in general the length (with flags) and two offset numbers will occupy only the first three bytes of a protein. On many hardware or system architectures, a fetch or read of a certain number of bytes beyond the first is “free” (e.g., 16 bytes take exactly the same number of clock cycles to pull across the Cell processor's main bus as a single byte).

In many instances it is useful to allow implementation-specific or context-specific caching or metadata inside a protein. The use of offsets allows for a “hole” of arbitrary size to be created near the beginning of the protein, into which such metadata may be slotted. An implementation that can make use of eight bytes of metadata gets those bytes for free on many system architectures with every fetch of the length header for a protein.

The descrips offset specifies the number of bytes between the beginning of the protein and the first descrip entry. Each descrip entry comprises an offset (in offset form, of course) to the next descrip entry, followed by a variable-width length field (again in offset format), followed by a slaw. If there are no further descrips, the offset is, by rule, four bytes of zeros. Otherwise, the offset specifies the number of bytes between the beginning of this descrip entry and a subsequent descrip entry. The length field specifies the length of the slaw, in bytes.

In most proteins, each descrip is a string, formatted in the slaw string fashion: a four-byte length/type header with the most significant bit set and only the lower 30 bits used to specify length, followed by the header's indicated number of data bytes. As usual, the length header takes its endianness from the protein. Bytes are assumed to encode UTF-8 characters (and thus—nota bene—the number of characters is not necessarily the same as the number of bytes).

The ingests offset specifies the number of bytes between the beginning of the protein and the first ingest entry. Each ingest entry comprises an offset (in offset form) to the next ingest entry, followed again by a length field and a slaw. The ingests offset is functionally identical to the descrips offset, except that it points to the next ingest entry rather than to the next descrip entry.

In most proteins, every ingest is of the slaw cons type comprising a two-value list, generally used as a key/value pair. The slaw cons record comprises a four-byte length/type header with the second most significant bit set and only the lower 30 bits used to specify length; a four-byte offset to the start of the value (second) element; the four-byte length of the key element; the slaw record for the key element; the four-byte length of the value element; and finally the slaw record for the value element.

Generally, the cons key is a slaw string. The duplication of data across the several protein and slaw cons length and offsets field provides yet more opportunity for refinement and optimization.

The construct used under an embodiment to embed typed data inside proteins, as described above, is a tagged byte-sequence specification and abstraction called a “slaw” (the plural is “slawx”). A slaw is a linear sequence of bytes representing a piece of (possibly aggregate) typed data, and is associated with programming-language-specific APIs that allow slawx to be created, modified and moved around between memory spaces, storage media, and machines. The slaw type scheme is intended to be extensible and as lightweight as possible, and to be a common substrate that can be used from any programming language.

The desire to build an efficient, large-scale inter-process communication mechanism is the driver of the slaw configuration. Conventional programming languages provide sophisticated data structures and type facilities that work well in process-specific memory layouts, but these data representations invariably break down when data needs to be moved between processes or stored on disk. The slaw architecture is, first, a substantially efficient, multi-platform friendly, low-level data model for inter-process communication.

But even more importantly, slawx are configured to influence, together with proteins, and enable the development of future computing hardware (microprocessors, memory controllers, disk controllers). A few specific additions to, say, the instruction sets of commonly available microprocessors make it possible for slawx to become as efficient even for single-process, in-memory data layout as the schema used in most programming languages.

Each slaw comprises a variable-length type header followed by a type-specific data layout. In an example embodiment, which supports full slaw functionality in C, C++ and Ruby for example, types are indicated by a universal integer defined in system header files accessible from each language. More sophisticated and flexible type resolution functionality is also enabled: for example, indirect typing via universal object IDs and network lookup.

The slaw configuration of an embodiment allows slaw records to be used as objects in language-friendly fashion from both Ruby and C++, for example. A suite of utilities external to the C++ compiler sanity-check slaw byte layout, create header files and macros specific to individual slaw types, and auto-generate bindings for Ruby. As a result, well-configured slaw types are quite efficient even when used from within a single process. Any slaw anywhere in a process's accessible memory can be addressed without a copy or “deserialization” step.

Slaw functionality of an embodiment includes API facilities to perform one or more of the following: create a new slaw of a specific type; create or build a language-specific reference to a slaw from bytes on disk or in memory; embed data within a slaw in type-specific fashion; query the size of a slaw; retrieve data from within a slaw; clone a slaw; and translate the endianness and other format attributes of all data within a slaw. Every species of slaw implements the above behaviors.

FIGS. 19B/1 and 19B2 show a slaw header format, under an embodiment. A detailed description of the slaw follows.

The internal structure of each slaw optimizes each of type resolution, access to encapsulated data, and size information for that slaw instance. In an embodiment, the full set of slaw types is by design minimally complete, and includes: the slaw string; the slaw cons (i.e. dyad); the slaw list; and the slaw numerical object, which itself represents a broad set of individual numerical types understood as permutations of a half-dozen or so basic attributes. The other basic property of any slaw is its size. In an embodiment, slawx have byte-lengths quantized to multiples of four; these four-byte words are referred to herein as ‘quads’. In general, such quad-based sizing aligns slawx well with the configurations of modern computer hardware architectures.

The first four bytes of every slaw in an embodiment comprise a header structure that encodes type-description and other metainformation, and that ascribes specific type meanings to particular bit patterns. For example, the first (most significant) bit of a slaw header is used to specify whether the size (length in quad-words) of that slaw follows the initial four-byte type header. When this bit is set, it is understood that the size of the slaw is explicitly recorded in the next four bytes of the slaw (e.g., bytes five through eight); if the size of the slaw is such that it cannot be represented in four bytes (i.e. if the size is or is larger than two to the thirty-second power) then the next-most-significant bit of the slaw's initial four bytes is also set, which means that the slaw has an eight-byte (rather than four byte) length. In that case, an inspecting process will find the slaw's length stored in ordinal bytes five through twelve. On the other hand, the small number of slaw types means that in many cases a fully specified typal bit-pattern “leaves unused” many bits in the four byte slaw header; and in such cases these bits may be employed to encode the slaw's length, saving the bytes (five through eight) that would otherwise be required.

For example, an embodiment leaves the most significant bit of the slaw header (the “length follows” flag) unset and sets the next bit to indicate that the slaw is a “wee cons”, and in this case the length of the slaw (in quads) is encoded in the remaining thirty bits. Similarly, a “wee string” is marked by the pattern 001 in the header, which leaves twenty-nine bits for representation of the slaw-string's length; and a leading 0001 in the header describes a “wee list”, which by virtue of the twenty-eight available length-representing bits can be a slaw list of up to two-to-the-twenty-eight quads in size. A “full string” (or cons or list) has a different bit signature in the header, with the most significant header bit necessarily set because the slaw length is encoded separately in bytes five through eight (or twelve, in extreme cases). Note that the Plasma implementation “decides” at the instant of slaw construction whether to employ the “wee” or the “full” version of these constructs (the decision is based on whether the resulting size will “fit” in the available wee bits or not), but the full-vs.-wee detail is hidden from the user of the Plasma implementation, who knows and cares only that she is using a slaw string, or a slaw cons, or a slaw list.

Numeric slawx are, in an embodiment, indicated by the leading header pattern 00001. Subsequent header bits are used to represent a set of orthogonal properties that may be combined in arbitrary permutation. An embodiment employs, but is not limited to, five such character bits to indicate whether or not the number is: (1) floating point; (2) complex; (3) unsigned; (4) “wide”; (5) “stumpy” ((4) “wide” and (5) “stumpy” are permuted to indicate eight, sixteen, thirty-two, and sixty-four bit number representations). Two additional bits (e.g., (7) and (8)) indicate that the encapsulated numeric data is a two-, three-, or four-element vector (with both bits being zero suggesting that the numeric is a “one-element vector” (i.e. a scalar)). In this embodiment the eight bits of the fourth header byte are used to encode the size (in bytes, not quads) of the encapsulated numeric data. This size encoding is offset by one, so that it can represent any size between and including one and two hundred fifty-six bytes. Finally, two character bits (e.g., (9) and (10)) are used to indicate that the numeric data encodes an array of individual numeric entities, each of which is of the type described by character bits (1) through (8). In the case of an array, the individual numeric entities are not each tagged with additional headers, but are packed as continuous data following the single header and, possibly, explicit slaw size information.

This embodiment affords simple and efficient slaw duplication (which can be implemented as a byte-for-byte copy) and extremely straightforward and efficient slaw comparison (two slawx are the same in this embodiment if and only if there is a one-to-one match of each of their component bytes considered in sequence). This latter property is important, for example, to an efficient implementation of the protein architecture, one of whose critical and pervasive features is the ability to search through or ‘match on’ a protein's descrips list.

Further, the embodiments herein allow aggregate slaw forms (e.g., the slaw cons and the slaw list) to be constructed simply and efficiently. For example, an embodiment builds a slaw cons from two component slawx, which may be of any type, including themselves aggregates, by: (a) querying each component slaw's size; (b) allocating memory of size equal to the sum of the sizes of the two component slawx and the one, two, or three quads needed for the header-plus-size structure; (c) recording the slaw header (plus size information) in the first four, eight, or twelve bytes; and then (d) copying the component slawx's bytes in turn into the immediately succeeding memory. Significantly, such a construction routine need know nothing about the types of the two component slawx; only their sizes (and accessibility as a sequence of bytes) matters. The same process pertains to the construction of slaw lists, which are ordered encapsulations of arbitrarily many sub-slawx of (possibly) heterogeneous type.

A further consequence of the slaw system's fundamental format as sequential bytes in memory obtains in connection with “traversal” activities—a recurring use pattern uses, for example, sequential access to the individual slawx stored in a slaw list. The individual slawx that represent the descrips and ingests within a protein structure must similarly be traversed. Such maneuvers are accomplished in a stunningly straightforward and efficient manner: to “get to” the next slaw in a slaw list, one adds the length of the current slaw to its location in memory, and the resulting memory location is identically the header of the next slaw. Such simplicity is possible because the slaw and protein design eschews “indirection”; there are no pointers; rather, the data simply exists, in its totality, in situ.

To the point of slaw comparison, a complete implementation of the Plasma system must acknowledge the existence of differing and incompatible data representation schemes across and among different operating systems, CPUs, and hardware architectures. Major such differences include byte-ordering policies (e.g., little-vs. big-endianness) and floating-point representations; other differences exist. The Plasma specification requires that the data encapsulated by slawx be guaranteed interprable (i.e., must appear in the native format of the architecture or platform from which the slaw is being inspected. This requirement means in turn that the Plasma system is itself responsible for data format conversion. However, the specification stipulates only that the conversion take place before a slaw becomes “at all visible” to an executing process that might inspect it. It is therefore up to the individual implementation at which point it chooses to perform such format c conversion; two appropriate approaches are that slaw data payloads are conformed to the local architecture's data format (1) as an individual slaw is “pulled out” of a protein in which it had been packed, or (2) for all slaw in a protein simultaneously, as that protein is extracted from the pool in which it was resident. Note that the conversion stipulation considers the possibility of hardware-assisted implementations. For example, networking chipsets built with explicit Plasma capability may choose to perform format conversion intelligently and at the “instant of transmission”, based on the known characteristics of the receiving system. Alternately, the process of transmission may convert data payloads into a canonical format, with the receiving process symmetrically converting from canonical to “local” format. Another embodiment performs format conversion “at the metal”, meaning that data is always stored in canonical format, even in local memory, and that the memory controller hardware itself performs the conversion as data is retrieved from memory and placed in the registers of the proximal CPU.

A minimal (and read-only) protein implementation of an embodiment includes operation or behavior in one or more applications or programming languages making use of proteins. FIG. 19C is a flow diagram 650 for using proteins, under an embodiment. Operation begins by querying 652 the length in bytes of a protein. The number of descrips entries is queried 654. The number of ingests is queried 656. A descrip entry is retrieved 658 by index number. An ingest is retrieved 660 by index number.

The embodiments described herein also define basic methods allowing proteins to be constructed and filled with data, helper-methods that make common tasks easier for programmers, and hooks for creating optimizations. FIG. 19D is a flow diagram 670 for constructing or generating proteins, under an embodiment. Operation begins with creation 672 of a new protein. A series of descrips entries are appended 674. An ingest is also appended 676. The presence of a matching descrip is queried 678, and the presence of a matching ingest key is queried 680. Given an ingest key, an ingest value is retrieved 682. Pattern matching is performed 684 across descrips. Non-structured metadata is embedded 686 near the beginning of the protein.

As described above, slawx provide the lowest-level of data definition for inter-process exchange, proteins provide mid-level structure and hooks for querying and filtering, and pools provide for high-level organization and access semantics. The pool is a repository for proteins, providing linear sequencing and state caching. The pool also provides multi-process access by multiple programs or applications of numerous different types. Moreover, the pool provides a set of common, optimizable filtering and pattern-matching behaviors.

The pools of an embodiment, which can accommodate tens of thousands of proteins, function to maintain state, so that individual processes can offload much of the tedious bookkeeping common to multi-process program code. A pool maintains or keeps a large buffer of past proteins available—the Platonic pool is explicitly infinite—so that participating processes can scan both backwards and forwards in a pool at will. The size of the buffer is implementation dependent, of course, but in common usage it is often possible to keep proteins in a pool for hours or days.

The most common style of pool usage as described herein hews to a biological metaphor, in contrast to the mechanistic, point-to-point approach taken by existing inter-process communication frameworks. The name protein alludes to biological inspiration: data proteins in pools are available for flexible querying and pattern matching by a large number of computational processes, as chemical proteins in a living organism are available for pattern matching and filtering by large numbers of cellular agents.

Two additional abstractions lean on the biological metaphor, including use of “handlers”, and the Golgi framework. A process that participates in a pool generally creates a number of handlers. Handlers are relatively small bundles of code that associate match conditions with handle behaviors. By tying one or more handlers to a pool, a process sets up flexible call-back triggers that encapsulate state and react to new proteins.

A process that participates in several pools generally inherits from an abstract Golgi class. The Golgi framework provides a number of useful routines for managing multiple pools and handlers. The Golgi class also encapsulates parent-child relationships, providing a mechanism for local protein exchange that does not use a pool.

A pools API provided under an embodiment is configured to allow pools to be implemented in a variety of ways, in order to account both for system-specific goals and for the available capabilities of given hardware and network architectures. The two fundamental system provisions upon which pools depend are a storage facility and a means of inter-process communication. The extant systems described herein use a flexible combination of shared memory, virtual memory, and disk for the storage facility, and IPC queues and TCP/IP sockets for inter-process communication.

Pool functionality of an embodiment includes, but is not limited to, the following: participating in a pool; placing a protein in a pool; retrieving the next unseen protein from a pool; rewinding or fast-forwarding through the contents (e.g., proteins) within a pool. Additionally, pool functionality can include, but is not limited to, the following: setting up a streaming pool call-back for a process; selectively retrieving proteins that match particular patterns of descrips or ingests keys; scanning backward and forwards for proteins that match particular patterns of descrips or ingests keys.

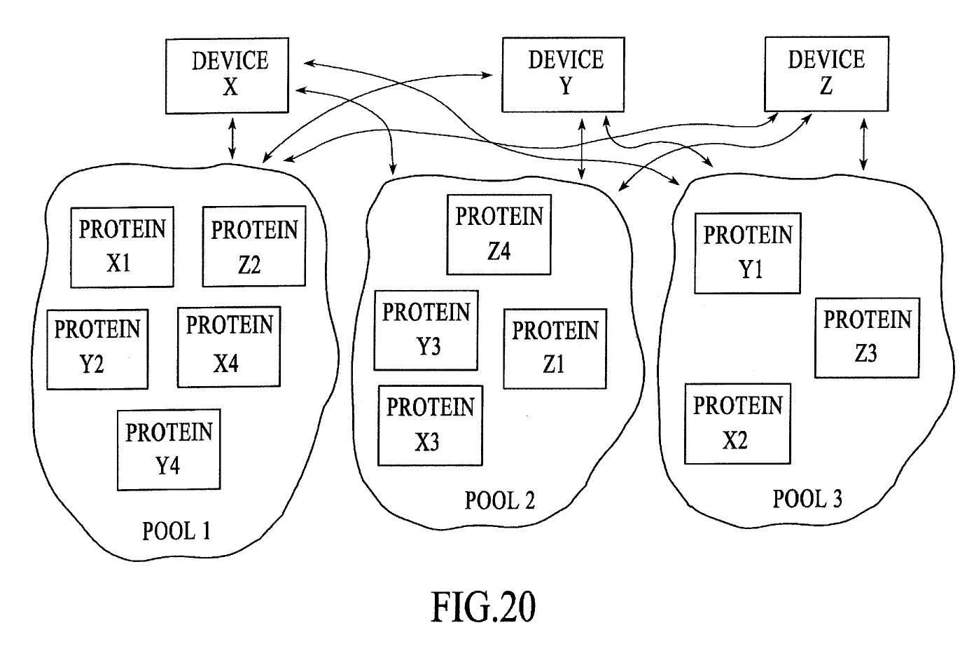

The proteins described above are provided to pools as a way of sharing the protein data contents with other applications. FIG. 20 is a block diagram of a processing environment including data exchange using slawx, proteins, and pools, under an embodiment. This example environment includes three devices (e.g., Device X, Device Y, and Device Z, collectively referred to herein as the “devices”) sharing data through the use of slawx, proteins and pools as described above. Each of the devices is coupled to the three pools (e.g., Pool 1, Pool 2, Pool 3). Pool 1 includes numerous proteins (e.g., Protein X1, Protein Z2, Protein Y2, Protein X4, Protein Y4) contributed or transferred to the pool from the respective devices (e.g., protein Z2 is transferred or contributed to pool 1 by device Z, etc.). Pool 2 includes numerous proteins (e.g., Protein Z4, Protein Y3, Protein Z1, Protein X3) contributed or transferred to the pool from the respective devices (e.g., protein Y3 is transferred or contributed to pool 2 by device Y, etc.). Pool 3 includes numerous proteins (e.g., Protein Y1, Protein Z3, Protein X2) contributed or transferred to the pool from the respective devices (e.g., protein X2 is transferred or contributed to pool 3 by device X, etc.). While the example described above includes three devices coupled or connected among three pools, any number of devices can be coupled or connected in any manner or combination among any number of pools, and any pool can include any number of proteins contributed from any number or combination of devices. The proteins and pools of this example are as described above with reference to FIGS. 18-23.

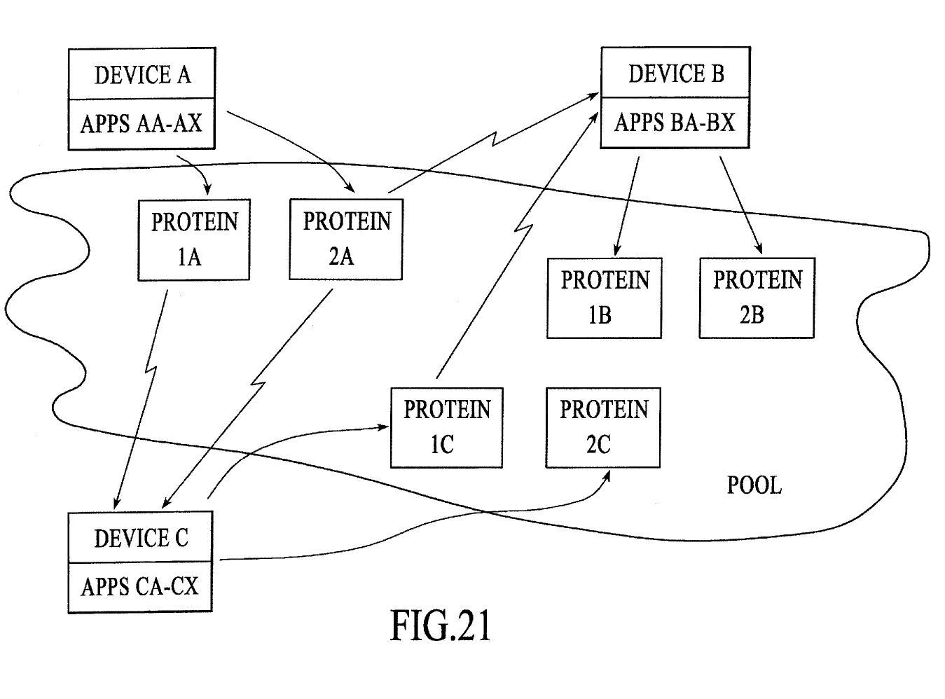

FIG. 21 is a block diagram of a processing environment including multiple devices and numerous programs running on one or more of the devices in which the Plasma constructs (e.g., pools, proteins, and slaw) are used to allow the numerous running programs to share and collectively respond to the events generated by the devices, under an embodiment. This system is but one example of a multi-user, multi-device, multi-computer interactive control scenario or configuration. More particularly, in this example, an interactive system, comprising multiple devices (e.g., device A, B, etc.) and a number of programs (e.g., apps AA-AX, apps BA-BX, etc.) running on the devices uses the Plasma constructs (e.g., pools, proteins, and slaw) to allow the running programs to share and collectively respond to the events generated by these input devices.

In this example, each device (e.g., device A, B, etc.) translates discrete raw data generated by or output from the programs (e.g., apps AA-AX, apps BA-BX, etc.) running on that respective device into Plasma proteins and deposits those proteins into a Plasma pool. For example, program AX generates data or output and provides the output to device A which, in turn, translates the raw data into proteins (e.g., protein 1A, protein 2A, etc.) and deposits those proteins into the pool. As another example, program BC generates data and provides the data to device B which, in turn, translates the data into proteins (e.g., protein 1B, protein 2B, etc.) and deposits those proteins into the pool.

Each protein contains a descrip list that specifies the data or output registered by the application as well as identifying information for the program itself. Where possible, the protein descrips may also ascribe a general semantic meaning for the output event or action. The protein's data payload (e.g., ingests) carries the full set of useful state information for the program event.

The proteins, as described above, are available in the pool for use by any program or device coupled or connected to the pool, regardless of type of the program or device. Consequently, any number of programs running on any number of computers may extract event proteins from the input pool. These devices need only be able to participate in the pool via either the local memory bus or a network connection in order to extract proteins from the pool. An immediate consequence of this is the beneficial possibility of decoupling processes that are responsible for generating processing events from those that use or interpret the events. Another consequence is the multiplexing of sources and consumers of events so that devices may be controlled by one person or may be used simultaneously by several people (e.g., a Plasma-based input framework supports many concurrent users), while the resulting event streams are in turn visible to multiple event consumers.

As an example, device C can extract one or more proteins (e.g., protein 1A, protein 2A, etc.) from the pool. Following protein extraction, device C can use the data of the protein, retrieved or read from the slaw of the descrips and ingests of the protein, in processing events to which the protein data corresponds. As another example, device B can extract one or more proteins (e.g., protein 1C, protein 2A, etc.) from the pool. Following protein extraction, device B can use the data of the protein in processing events to which the protein data corresponds.

Devices and/or programs coupled or connected to a pool may skim backwards and forwards in the pool looking for particular sequences of proteins. It is often useful, for example, to set up a program to wait for the appearance of a protein matching a certain pattern, then skim backwards to determine whether this protein has appeared in conjunction with certain others. This facility for making use of the stored event history in the input pool often makes writing state management code unnecessary, or at least significantly reduces reliance on such undesirable coding patterns.

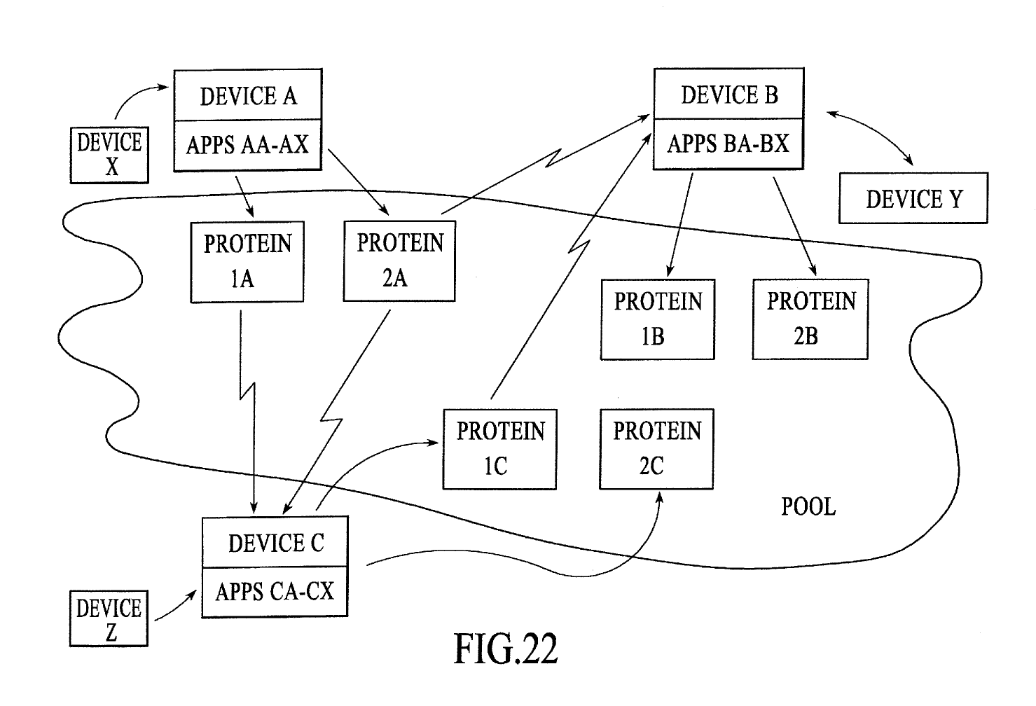

FIG. 22 is a block diagram of a processing environment including multiple devices and numerous programs running on one or more of the devices in which the Plasma constructs (e.g., pools, proteins, and slaw) are used to allow the numerous running programs to share and collectively respond to the events generated by the devices, under an alternative embodiment. This system is but one example of a multi-user, multi-device, multi-computer interactive control scenario or configuration. More particularly, in this example, an interactive system, comprising multiple devices (e.g., devices X and Y coupled to devices A and B, respectively) and a number of programs (e.g., apps AA-AX, apps BA-BX, etc.) running on one or more computers (e.g., device A, device B, etc.) uses the Plasma constructs (e.g., pools, proteins, and slaw) to allow the running programs to share and collectively respond to the events generated by these input devices.

In this example, each device (e.g., devices X and Y coupled to devices A and B, respectively) is managed and/or coupled to run under or in association with one or more programs hosted on the respective device (e.g., device A, device B, etc.) which translates the discrete raw data generated by the device (e.g., device X, device A, device Y, device B, etc.) hardware into Plasma proteins and deposits those proteins into a Plasma pool. For example, device X running in association with application AB hosted on device A generates raw data, translates the discrete raw data into proteins (e.g., protein 1A, protein 2A, etc.) and deposits those proteins into the pool. As another example, device X running in association with application AT hosted on device A generates raw data, translates the discrete raw data into proteins (e.g., protein 1A, protein 2A, etc.) and deposits those proteins into the pool. As yet another example, device Z running in association with application CD hosted on device C generates raw data, translates the discrete raw data into proteins (e.g., protein 1C, protein 2C, etc.) and deposits those proteins into the pool.

Each protein contains a descrip list that specifies the action registered by the input device as well as identifying information for the device itself. Where possible, the protein descrips may also ascribe a general semantic meaning for the device action. The protein's data payload (e.g., ingests) carries the full set of useful state information for the device event.

The proteins, as described above, are available in the pool for use by any program or device coupled or connected to the pool, regardless of type of the program or device. Consequently, any number of programs running on any number of computers may extract event proteins from the input pool. These devices need only be able to participate in the pool via either the local memory bus or a network connection in order to extract proteins from the pool. An immediate consequence of this is the beneficial possibility of decoupling processes that are responsible for generating processing events from those that use or interpret the events. Another consequence is the multiplexing of sources and consumers of events so that input devices may be controlled by one person or may be used simultaneously by several people (e.g., a Plasma-based input framework supports many concurrent users), while the resulting event streams are in turn visible to multiple event consumers.

Devices and/or programs coupled or connected to a pool may skim backwards and forwards in the pool looking for particular sequences of proteins. It is often useful, for example, to set up a program to wait for the appearance of a protein matching a certain pattern, then skim backwards to determine whether this protein has appeared in conjunction with certain others. This facility for making use of the stored event history in the input pool often makes writing state management code unnecessary, or at least significantly reduces reliance on such undesirable coding patterns.

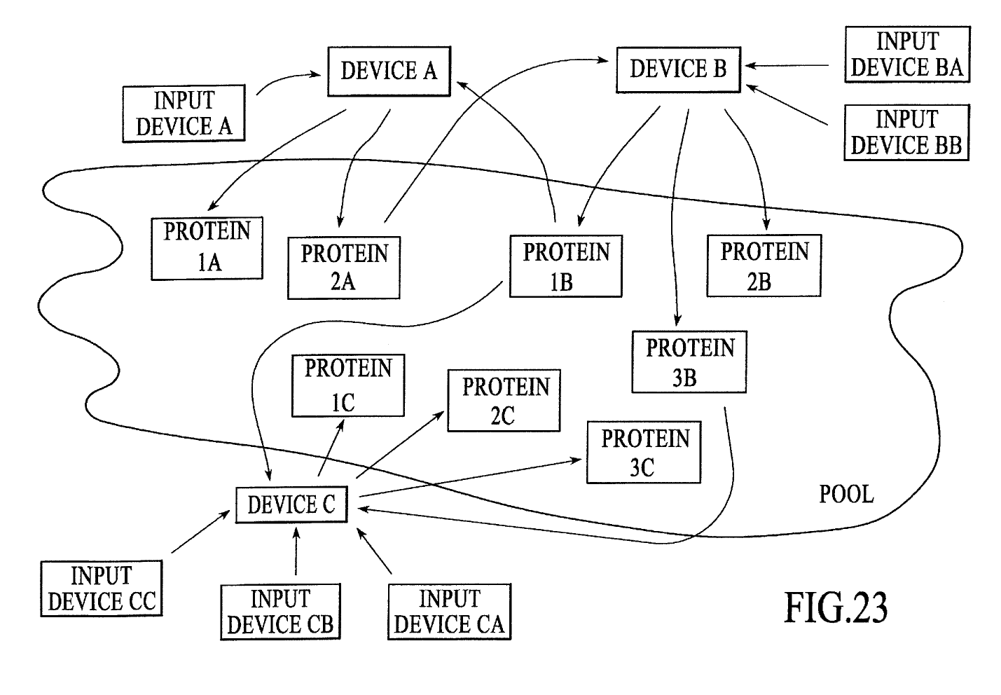

FIG. 23 is a block diagram of a processing environment including multiple input devices coupled among numerous programs running on one or more of the devices in which the Plasma constructs (e.g., pools, proteins, and slaw) are used to allow the numerous running programs to share and collectively respond to the events generated by the input devices, under another alternative embodiment. This system is but one example of a multi-user, multi-device, multi-computer interactive control scenario or configuration. More particularly, in this example, an interactive system, comprising multiple input devices (e.g., input devices A, B, BA, and BB, etc.) and a number of programs (not shown) running on one or more computers (e.g., device A, device B, etc.) uses the Plasma constructs (e.g., pools, proteins, and slaw) to allow the running programs to share and collectively respond to the events generated by these input devices.

In this example, each input device (e.g., input devices A, B, BA, and BB, etc.) is managed by a software driver program hosted on the respective device (e.g., device A, device B, etc.) which translates the discrete raw data generated by the input device hardware into Plasma proteins and deposits those proteins into a Plasma pool. For example, input device A generates raw data and provides the raw data to device A which, in turn, translates the discrete raw data into proteins (e.g., protein 1A, protein 2A, etc.) and deposits those proteins into the pool. As another example, input device BB generates raw data and provides the raw data to device B which, in turn, translates the discrete raw data into proteins (e.g., protein 1B, protein 3B, etc.) and deposits those proteins into the pool.

Each protein contains a descrip list that specifies the action registered by the input device as well as identifying information for the device itself. Where possible, the protein descrips may also ascribe a general semantic meaning for the device action. The protein's data payload (e.g., ingests) carries the full set of useful state information for the device event.

To illustrate, here are example proteins for two typical events in such a system. Proteins are represented here as text however, in an actual implementation, the constituent parts of these proteins are typed data bundles (e.g., slaw). The protein describing a g-speak “one finger click” pose (described in the Related Applications) is as follows:

[ Descrips: { point, engage, one, one-finger-engage, hand,

pilot-id-02, hand-id-23 }

Ingests: { pilot-id => 02,

| hand-id => 23, | |
|---|---|
| pos | => [ 0.0, 0.0, 0.0 ] |
| angle-axis => [ 0.0, 0.0, 0.0, 0.707 ] | |
| gripe | => ..\hat{ }\|\|:vx |
| time | => 184437103.29}] |

As a further example, the protein describing a mouse click is as follows:

[ Descrips: { point, click, one, mouse-click, button-one,

mouse-id-02 }

Ingests: { mouse-id => 23,

| | |
|---|---|
| pos | => [ 0.0, 0.0, 0.0 ] |
| time | => 184437124.80}] |

Either or both of the sample proteins foregoing might cause a participating program of a host device to run a particular portion of its code. These programs may be interested in the general semantic labels: the most general of all, “point”, or the more specific pair, “engage, one”. Or they may be looking for events that would plausibly be generated only by a precise device: “one-finger-engage”, or even a single aggregate object, “hand-id-23”.

The proteins, as described above, are available in the pool for use by any program or device coupled or connected to the pool, regardless of type of the program or device. Consequently, any number of programs running on any number of computers may extract event proteins from the input pool. These devices need only be able to participate in the pool via either the local memory bus or a network connection in order to extract proteins from the pool. An immediate consequence of this is the beneficial possibility of decoupling processes that are responsible for generating ‘input events’ from those that use or interpret the events. Another consequence is the multiplexing of sources and consumers of events so that input devices may be controlled by one person or may be used simultaneously by several people (e.g., a Plasma-based input framework supports many concurrent users), while the resulting event streams are in turn visible to multiple event consumers.

As an example or protein use, device C can extract one or more proteins (e.g., protein 1B, etc.) from the pool. Following protein extraction, device C can use the data of the protein, retrieved or read from the slaw of the descrips and ingests of the protein, in processing input events of input devices CA and CC to which the protein data corresponds. As another example, device A can extract one or more proteins (e.g., protein 1B, etc.) from the pool. Following protein extraction, device A can use the data of the protein in processing input events of input device A to which the protein data corresponds.

Devices and/or programs coupled or connected to a pool may skim backwards and forwards in the pool looking for particular sequences of proteins. It is often useful, for example, to set up a program to wait for the appearance of a protein matching a certain pattern, then skim backwards to determine whether this protein has appeared in conjunction with certain others. This facility for making use of the stored event history in the input pool often makes writing state management code unnecessary, or at least significantly reduces reliance on such undesirable coding patterns.

Examples of input devices that are used in the embodiments of the system described herein include gestural input sensors, keyboards, mice, infrared remote controls such as those used in consumer electronics, and task-oriented tangible media objects, to name a few.

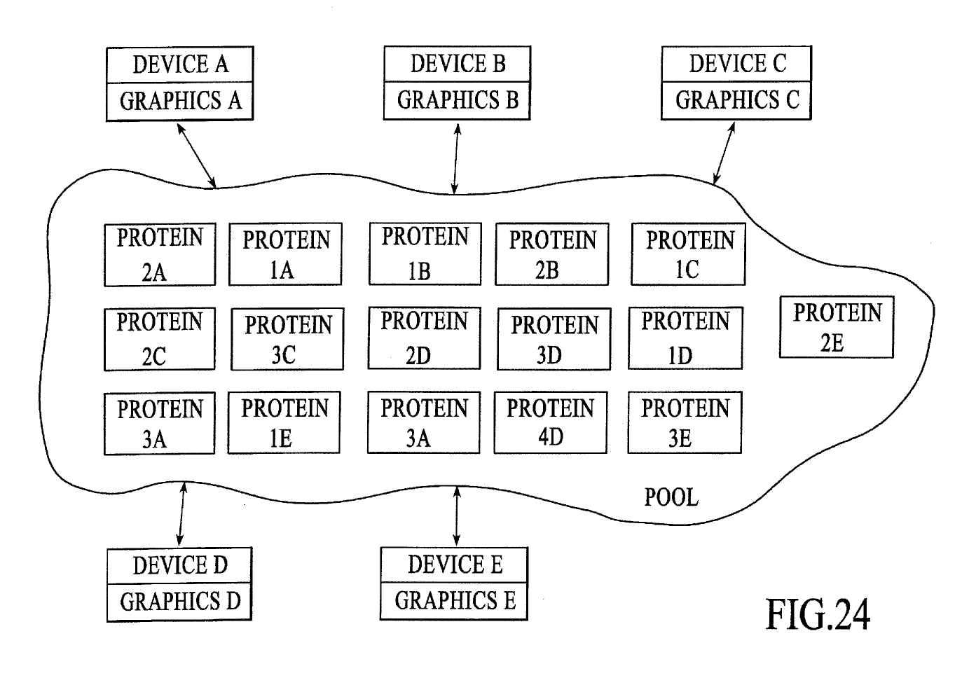

FIG. 24 is a block diagram of a processing environment including multiple devices coupled among numerous programs running on one or more of the devices in which the Plasma constructs (e.g., pools, proteins, and slaw) are used to allow the numerous running programs to share and collectively respond to the graphics events generated by the devices, under yet another alternative embodiment. This system is but one example of a system comprising multiple running programs (e.g. graphics A-E) and one or more display devices (not shown), in which the graphical output of some or all of the programs is made available to other programs in a coordinated manner using the Plasma constructs (e.g., pools, proteins, and slaw) to allow the running programs to share and collectively respond to the graphics events generated by the devices.

It is often useful for a computer program to display graphics generated by another program. Several common examples include video conferencing applications, network-based slideshow and demo programs, and window managers. Under this configuration, the pool is used as a Plasma library to implement a generalized framework which encapsulates video, network application sharing, and window management, and allows programmers to add in a number of features not commonly available in current versions of such programs.

Programs (e.g., graphics A-E) running in the Plasma compositing environment participate in a coordination pool through couplings and/or connections to the pool. Each program may deposit proteins in that pool to indicate the availability of graphical sources of various kinds. Programs that are available to display graphics also deposit proteins to indicate their displays' capabilities, security and user profiles, and physical and network locations.

Graphics data also may be transmitted through pools, or display programs may be pointed to network resources of other kinds (RTSP streams, for example). The phrase “graphics data” as used herein refers to a variety of different representations that lie along a broad continuum; examples of graphics data include but are not limited to literal examples (e.g., an ‘image’, or block of pixels), procedural examples (e.g., a sequence of ‘drawing’ directives, such as those that flow down a typical openGL pipeline), and descriptive examples (e.g., instructions that combine other graphical constructs by way of geometric transformation, clipping, and compositing operations).

On a local machine graphics data may be delivered through platform-specific display driver optimizations. Even when graphics are not transmitted via pools, often a periodic screen-capture will be stored in the coordination pool so that clients without direct access to the more esoteric sources may still display fall-back graphics.

One advantage of the system described here is that unlike most message passing frameworks and network protocols, pools maintain a significant buffer of data. So programs can rewind backwards into a pool looking at access and usage patterns (in the case of the coordination pool) or extracting previous graphics frames (in the case of graphics pools).

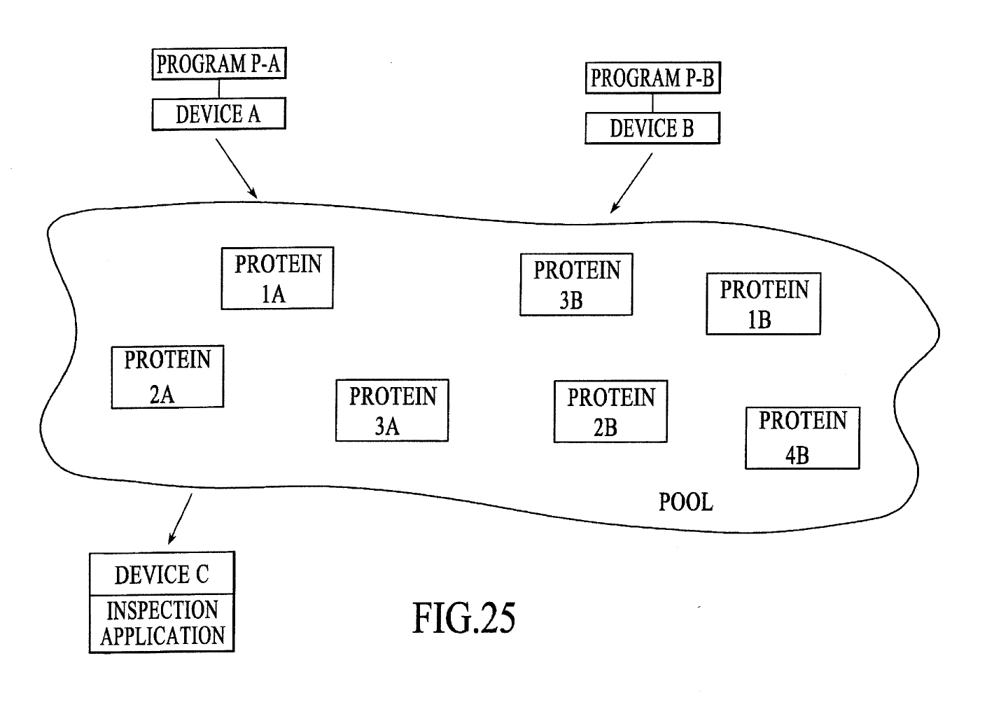

FIG. 25 is a block diagram of a processing environment including multiple devices coupled among numerous programs running on one or more of the devices in which the Plasma constructs (e.g., pools, proteins, and slaw) are used to allow stateful inspection, visualization, and debugging of the running programs, under still another alternative embodiment. This system is but one example of a system comprising multiple running programs (e.g. program P-A, program P-B, etc.) on multiple devices (e.g., device A, device B, etc.) in which some programs access the internal state of other programs using or via pools.

Most interactive computer systems comprise many programs running alongside one another, either on a single machine or on multiple machines and interacting across a network. Multi-program systems can be difficult to configure, analyze and debug because run-time data is hidden inside each process and difficult to access. The generalized framework and Plasma constructs of an embodiment described herein allow running programs to make much of their data available via pools so that other programs may inspect their state. This framework enables debugging tools that are more flexible than conventional debuggers, sophisticated system maintenance tools, and visualization harnesses configured to allow human operators to analyze in detail the sequence of states that a program or programs has passed through.

Referring to FIG. 25, a program (e.g., program P-A, program P-B, etc.) running in this framework generates or creates a process pool upon program start up. This pool is registered in the system almanac, and security and access controls are applied. More particularly, each device (e.g., device A, B, etc.) translates discrete raw data generated by or output from the programs (e.g., program P-A, program P-B, etc.) running on that respective device into Plasma proteins and deposits those proteins into a Plasma pool. For example, program P-A generates data or output and provides the output to device A which, in turn, translates the raw data into proteins (e.g., protein 1A, protein 2A, protein 3A, etc.) and deposits those proteins into the pool. As another example, program P-B generates data and provides the data to device B which, in turn, translates the data into proteins (e.g., proteins 1B-4B, etc.) and deposits those proteins into the pool.

For the duration of the program's lifetime, other programs with sufficient access permissions may attach to the pool and read the proteins that the program deposits; this represents the basic inspection modality, and is a conceptually “one-way” or “read-only” proposition: entities interested in a program P-A inspect the flow of status information deposited by P-A in its process pool. For example, an inspection program or application running under device C can extract one or more proteins (e.g., protein 1A, protein 2A, etc.) from the pool. Following protein extraction, device C can use the data of the protein, retrieved or read from the slaw of the descrips and ingests of the protein, to access, interpret and inspect the internal state of program P-A.

But, recalling that the Plasma system is not only an efficient stateful transmission scheme but also an omnidirectional messaging environment, several additional modes support program-to-program state inspection. An authorized inspection program may itself deposit proteins into program P's process pool to influence or control the characteristics of state information produced and placed in that process pool (which, after all, program P not only writes into but reads from).

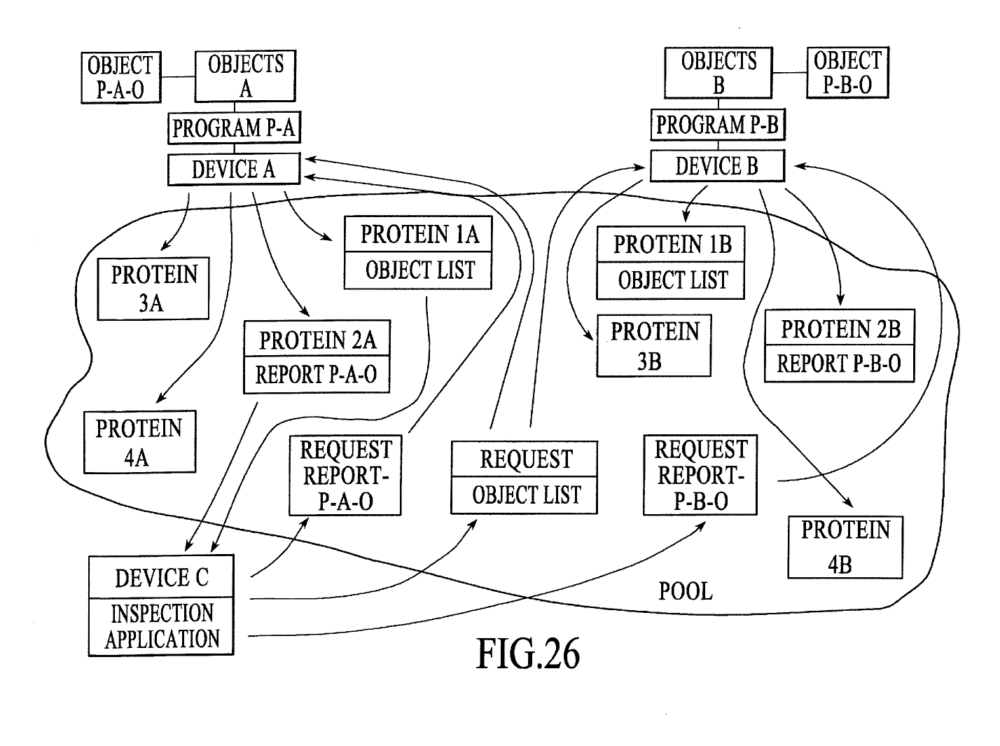

FIG. 26 is a block diagram of a processing environment including multiple devices coupled among numerous programs running on one or more of the devices in which the Plasma constructs (e.g., pools, proteins, and slaw) are used to allow influence or control the characteristics of state information produced and placed in that process pool, under an additional alternative embodiment. In this system example, the inspection program of device C can for example request that programs (e.g., program P-A, program P-B, etc.) dump more state than normal into the pool, either for a single instant or for a particular duration. Or, prefiguring the next ‘level’ of debug communication, an interested program can request that programs (e.g., program P-A, program P-B, etc.) emit a protein listing the objects extant in its runtime environment that are individually capable of and available for interaction via the debug pool. Thus informed, the interested program can ‘address’ individuals among the objects in the programs runtime, placing proteins in the process pool that a particular object alone will take up and respond to. The interested program might, for example, request that an object emit a report protein describing the instantaneous values of all its component variables. Even more significantly, the interested program can, via other proteins, direct an object to change its behavior or its variables' values.

More specifically, in this example, inspection application of device C places into the pool a request (in the form of a protein) for an object list (e.g., “Request-Object List”) that is then extracted by each device (e.g., device A, device B, etc.) coupled to the pool. In response to the request, each device (e.g., device A, device B, etc.) places into the pool a protein (e.g., protein 1A, protein 1B, etc.) listing the objects extant in its runtime environment that are individually capable of and available for interaction via the debug pool.

Thus informed via the listing from the devices, and in response to the listing of the objects, the inspection application of device C addresses individuals among the objects in the programs runtime, placing proteins in the process pool that a particular object alone will take up and respond to. The inspection application of device C can, for example, place a request protein (e.g., protein “Request Report P-A-O”, “Request Report P-B-O”) in the pool that an object (e.g., object P-A-O, object P-B-O, respectively) emit a report protein (e.g., protein 2A, protein 2B, etc.) describing the instantaneous values of all its component variables. Each object (e.g., object P-A-O, object P-B-O) extracts its request (e.g., protein “Request Report P-A-O”, “Request Report P-B-O”, respectively) and, in response, places a protein into the pool that includes the requested report (e.g., protein 2A, protein 2B, respectively). Device C then extracts the various report proteins (e.g., protein 2A, protein 2B, etc.) and takes subsequent processing action as appropriate to the contents of the reports.

In this way, use of Plasma as an interchange medium tends ultimately to erode the distinction between debugging, process control, and program-to-program communication and coordination.

To that last, the generalized Plasma framework allows visualization and analysis programs to be designed in a loosely-coupled fashion. A visualization tool that displays memory access patterns, for example, might be used in conjunction with any program that outputs its basic memory reads and writes to a pool. The programs undergoing analysis need not know of the existence or design of the visualization tool, and vice versa.

The use of pools in the manners described above does not unduly affect system performance. For example, embodiments have allowed for depositing of several hundred thousand proteins per second in a pool, so that enabling even relatively verbose data output does not noticeably inhibit the responsiveness or interactive character of most programs.

Embodiments described herein include one or more additional specifications and protocols enabling the tracking system of an embodiment, details of which are described in detail below.

### Ultrasonic System Operation and Calibration

### 1. Background

### 1.1 System Architecture

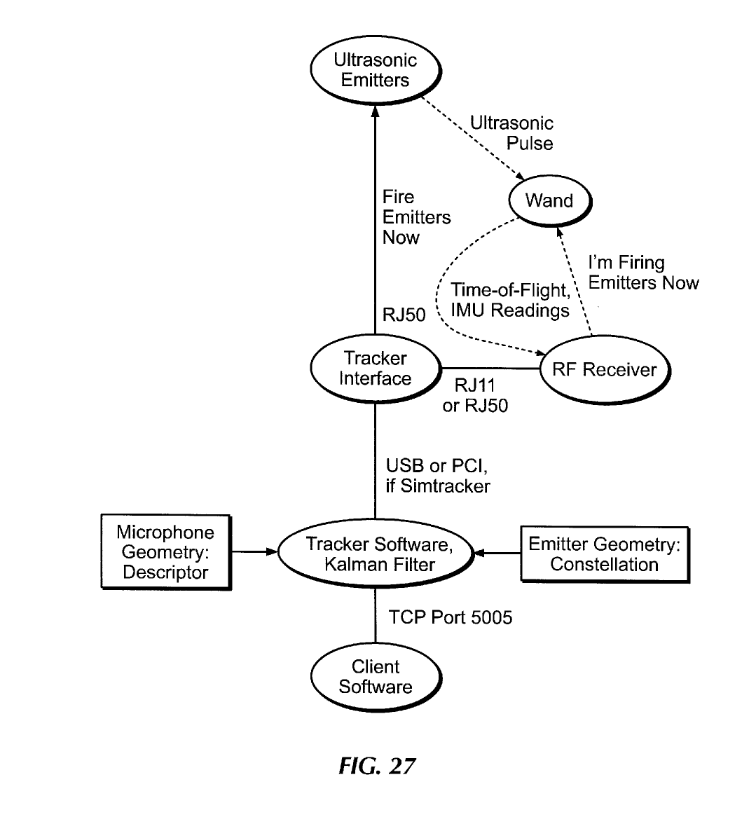

The top-level architecture of an Intersense tracking system is shown in FIG. 27. There are ultrasonic emitters mounted around the tracking space. When the tracking system takes a measurement, it simultaneously fires an ultrasonic emitter, and sends a radio signal to a wand that contains ultrasonic microphones. Some time later, the wand receives the ultrasonic pulse, measures the time-of-flight, and sends it back to the main tracking system. The wand also measures and sends out it IMU readings. The tracking system assumes perfect knowledge of the 3D geometry of the microphone positions (called the descriptor) and of the emitter positions (called the constellation). The tracking system contains a Kalman filter, that is able to fuse these geometries, the IMU readings and the times-of-flight into the pose of the wand in the tracking space.

FIG. 27 shows the tracking system components, and their data flow. Solid lines are wires, dashed lines are radio lines, and dotted lines are ultrasonic pulses. The flow of data when tracking. A central Kalman filter fuses raw measurements coming from the wand (IMU readings, ultrasonic ranges) with some previously-known data (descriptor, constellation) to produce the best estimate of the wand pose.

### 1.1.1 Hardware Variations

As seen in FIG. 27, the wands have a radio link to the tracking system via an “RF receiver” component. When tracking each receiver uses a single RF channel. The current configuration uses 1 wand per RF receiver and RF channel (so a 2-wand system utilizes 2 receivers on 2 different channels). In the near future, pairs of wands will be able to share an RF channel, that we'll have 2 wands per 1 RF receiver and RF channel.

The Intersense emitters always connect viva a proprietary RJ50 connector. The RF receiver can use this same RJ50 connector, but may also use a different RJ11 connector. For our systems we have a standardized on RJ50 for everything, and we only have a few RJ11-based receivers around. The “Tracker interface” component in FIG. 27 is a board that interfaces the RJ50 and/or RJ11 connectors to a computer via either PCI or USB. Currently, this interface exists in 2 flavors: A PCI card sold by Intersense, which contains both RJ50 and RJ11 ports and is sold standalone, or as part of a SimTracker (see below); or a USB card built by Oblong, which contains 3 RJ50 ports. Intersense sells the PCI interface card by itself, or together with the tracker software in a single rack-mounted computer, called the SimTracker.

### 1.1.2 Software Variations

If we don't use the SimTracker, we must run the software ourselves. This is a binary biob executable we get, from Intemsense called intrackx. This program can be configured to communicate with either the PCI or USB-based interfaces. Configuration of the intrackx is a part of the pipeline installations, so it is not covered here.

The tracker software communicates with all the external devices, and listens on TCP port 5005, to give clients access to the tracking data. There are several ways to make use of this connection. The most direct is to simply open a TCP connection and start sending data. This can be done with, for instance, the netcat tool (Section 3.1.1). A brief listing of some Intersense commands that can be sent with this tool appears in Appendix A. This direct-connection method is useful for running some simple tests. To actually receive and interpret tracking data, Intersense provides an API that encapsulates this TCP layer. This API is generally referred to as libisense. So (or libisense.dll on Win32). The wandreader (Section 3) and insense—of the . . . p1 tools in Section 3 use it.

### 1.2 Motivation for an Automated Calibration

As previously described, the 3D geometry of the microphones (descriptor) and of the emitters (constellation) must be known in advance. The microphone geometry is set during manufacturing of the tracking objects, and can thus be controlled and determined very precisely.

It is possible to determine the emitter geometry (constellation) the same way, by very precisely and carefully measuring the tracking space. However, since the emitter geometry is different for every tracking space, and since mm-order accuracy is required, this represents a dramatic increase in the amount of effort needed to set up an ultrasonic tracking system.

To streamline this ultrasonic installation process, we developed a calibration routine for these systems. This is a procedure that allows the emitters to be installed haphazardly, and then for the tracking. The algorithmic and implementation details of this routine are described in Appendix B, while details regarding the usage of the calibration tool appear in Section 2.

### 2. Obtaining a Calibration

### 2.1 Preliminaries

### 2.1.1 Software Installation

Before we can start to calibrate, we must make sure that all the necessary software is installed. The calibration tool itself lives in the ultrasonic-calibration-oblong package. There are various other tools that are useful, but not obviously required to run a calibration. These can all be installed together with ultrasonic-calibration-oblong, by installing the ultrasonic-calibration-oblong-meta-package. This package simply contains dependencies to pull in everything that is good to have. If you do not know how to manage packages, please read any of a number of APT guides available on the internet. Briefly, to install a package (the meta package from above, for instance), do, as root.
$ apt-get install ultrasonic-calibration-oblong-meta

To see if a package is installed, do
$ dpkg-query -s ultrasonic-calibration-oblong

If the package is installed, this will report some information about it. Otherwise this will say that the package isn't installed.

### 2.1.2 Software Setup

Other than the calibration tools, the tracker software needs to be running (Section 1.1.2), and the calibration machine must be able to communicate with it. I won't go into configuration details here, as these pare a part of the pipeline setup. If we are using a SimTracker, there's nothing to do here, otherwise we must make sure the intrackx process is running. To check for this, do something like:
$ pgrep -x intrackx

This will return the PID of the process if it's running or nothing if it isn't. The pgrep tool lives in the procps package, which I believe is pre-installed on all Ubuntu machines. If this isn't the case, install it as described above.

To check whether we can communicate with the tracker software, first check to make sure we can talk to its machine. If it's running on 10.10.4.152:
$ ping -c3 -W1 10.10.4.152

This sends out 3 packets and waits for replies for 1 second each at the longest. The tool should report 3 replies if the machine is up, and no replies if it isn't.

Now that we know the machine is up, we can make sure we can communicate with the software. As mentioned in Section 1.1.2., the tracker software listens on TCP port 5005 for a client connection. To check that this connection is up, we can simply try to send it a command (Appendix A) with the netcat tool (Section 3.1.1):

$ echo MP 1 timeout 1 nc 10.10.4.152 5005

If there were connection issues, we'll see something like:
(UNKNOWN) [10.10.4.152] 5005 (?): Connection refused

This means that port 5005 was not open. We have the wrong machine, or the tracker software is not running. If the port was open, netcat would connect to it. If everything worked correctly, we'll see the output of the MP command:
31P 00 00 00 00 00 00 00 00 00 00 00 00 122

The output may be a bit different from this but if it looks even remotely similar, then everything is running correctly and we can proceed. A common failure case exists, where the connection is not refused, but the server doesn't respond to any command either. This is due in a bug in Intersense's software. The software is set up to allow only a single TCP connection at a time, so if anything is currently connected on a port 5005, another connection cannot be established. Intersense should signal this condition by refusing the connection, as shown above. Instead they accept the connection but don't communicate on that link until the currently-active link is closed. To the user it′ll look like the above command succeeded, but no data will be returned. Unfortunately, there is no general way to know what machine is currently using the connection, so we must make educated guess. The most likely culprit here is a wandreader process that drives the pipeline (Section 3). To check whether this process is running or not, issue:
$ pgrep -f ‘perp-pogo.*wandreader’

As before, this will return the PID if the process exists and nothing if it does not. If this process exists, then it is likely taking the TCP connection we want to use. To be able to calibrate, this process must be shut down:
$ sudo wandreader stop

The wandreader drives the wands pool, and thus necessary for all of Oblong's applications to function. Thus when calibration is complete, it must be restarted with:
$ sudo wandreader start

### 2.1.3 Wand Provisioning

Now that we are successfully communicating with the tracker software, we must tell it to talk to the specific wands on specific channels. In the specific case of calibration, we need to connect the calibration objects as the first “wand”. We refer to this configuration as provisioning. The tools available are described in detail in Section 3.2. Briefly, to provision 2 wands, do something like
$ reprovision.pl 10.10.4.152 1001234 3 1005678 13

This provisions wand 1001234 on channel 3 and wand 1005678 on channel 13. When provisioning wands, it is important that the wands being configured are on at that time. Furthermore, the reprovisioning process involves a restart of the tracking software (performed automatically) so it takes at least 30 seconds to complete. While reprovisioning, the RF light on the wands should blink a few times and then go on solid. If this did not happen, something has failed. Possible issues are hardware faults or radio interferences issues. Once the provisioning is complete and the RF light is solid on, we can proceed.

### 2.2 Running the Calibration Tool

To generate a constellation with our calibration routine, a special calibration object must be used. This is an object with 4 ultrasonic microphone placed in well-known positions in such a way that all 4 microphones can hear an emitter at a given time. The object is moved around the tracking volume to gather some number of calibration views. For each view, the object is held stationary (on a fixed tripod, say), while each emitter fires in turn. For each emitter, all the microphone ranges are measured and recorded. Finally, the accelerometer in the tracking object is queried to read off the gravity vector. These range measurements and gravity vectors are the raw input to the calibration routine.

As more views are gathered, the calibration routine becomes more and more confident in its estimate of the positions of the emitters. The various confidence metrics are reported to the calibration operator, who can decide when the calibration is sufficiently accurate. If it isn't yet, the metrics can be used to determine the best location of the calibration view, so that the confidence can be quickly increased. Normally 10-20 views are required to achieve sufficient accuracy.

The main tool use to run the ultrasonic calibration is inferConstellation.pl from the ultrasonic-calibration-oblong package. There are various commandline options available. These are all described in the manpage for the tool, and I will not go into detail about them here. I strongly encourage you to read the manpage in full (Appendix C.1). The basic usage is:
$ inferConstellation.pl 10.10.4.152 36
   to calibrate a 36-emitter system accessible through that IP. The calibration routine will father views one at a time. Press Enter after each view to gather another view, or type a few characters and then press Enter to accept the current constellation, ending the calibration. If at least 2 views are available, the routine will compute the best-estimate constellation after each view is gathered. After each computation is complete, various metrics for the quality of the constellation are reported to the user; the user can then use these to judge whether to gather more views and where the best locations for further views are.

The inferConstellation.pl tool sends a lot of status information to STDERR as it runs. The only data it sends to STDOUT is the resulting constellation, when all the data gathering and all the computation is finished. Thus it is possible to save the final constellation to a file with something like
$ inferConstellation.pl 10.10.4.152 36 1 tee result.constellation

In addition, the constellation tool automatically saves all its raw data to a log file. The name of this is timestamped, so that logs are never overwritten. Furthermore, the most recent log is pointed to by a softlink name ultrasonicCalib.latest. So one way to use the calibration tool is to: Run it as stated previously; analyze and/or manipulate the resulting constellation with tools described in Section 3.4; and if we′re happy with the results, send them to the Intersense box using a tool such as netcat, described in Section 3.1.1.

In order to achieve millimeter-level accuracy in the final calibration it's important that the input data has sub-millimeter accuracy. For this reason it is important to keep the calibration object as stills as possible while it's gathering data. Further, to keep our temperature distribution model as correct as possible, it is highly desirable to turn off the A/C or heating system while running the calibration (Appendix B.1). Usable calibrations will result event if these guidelines aren't strictly observed, but more controlled gathering of data will result in a more accurate constellation, which in turn will result in better tracking performance.

### 2.3 Interpreting User Feedback: Console Output

With every run of the calibration solver, lots of user feedback is printed on STDOUT. Here I explain each section of the output. This output shows the result of every step of the computation as described in Appendix B. Note that all distances are in meters and all times are in seconds. The sample output comes from the 15^{th} view gathered from a ceiling-mounted 36-emitter system. While data is gathered, output such as the following is shown:
Connecting to intersense via a network at 10.10.4.152
Selecting station 1 [symbol]
Selecting emitter 5030
Mic 1 received 34 raw ranges
Mic 2 received 34 raw ranges
Mic 3 received 34 raw ranges
Mic 4 received 34 raw ranges [symbol]
reading gravity
Selecting station 1
Done getting date for this view

This reports which emitter we′re talking to and how many microphones hear the pulses from this emitter. If too few pulses are heard, we give up on this emitter and move on. All 4 microphones must hear the pulses in order to use that specific emitter. After every emitter has been sampled, we read the gravity vector from the accelerometer. When this is complete, the data has been gathered, and, if we have more than 2 views, we can try to solve the main calibration problem, Equation (1).

When solving the problem, the first output that appears to looks like the following sample:
Solving system
Ignoring emitter 5001: too few mics heard signal
Ignoring emitter 5002: too few mics heard signal
Ignoring emitter 5003: too few mics heard signal [symbol]
Locally optimizing 7 emitters
Optimizing with 4 visible mics
Mic 1 has 34 points with range rms 0.000426492880601614
Mic 4 has 31 points with range rms 0.000460809466893218
Mic 3 has 34 points with range rms 0.000380032691370641
Mic 2 has 31 points with range rms 0.000454029011080132
Running local optimization
Emitter 5030 localized with rms error: 1.85785490978436e-05
Optimizing with 4 visible mics
Mic 1 has 34 points with range rms 0.000426492880601614
Mic 4 has 31 points with range rms 0.000460809466893218
Mic 3 has 34 points with range rms 0.000380032691370641
Mic 2 has 31 points with range rms 0.000454029011080132
Running local optimization
Emitter 5028 localized with rms error: 7.13846587886659e-05 [symbol]
Locally optimized emitter 5033 at [1.0208077, −1.7172728, −0.66723522]
Locally optimized emitter 5030 at [1.0285931, 0.056527221, −1.2403442]
Locally optimized emitter 5028 at [1.5835793, −1.5205806, −0.67125077]
Locally optimized emitter 5019 at [1.6091575, 0.2605714, −1.2636183]
Locally optimized emitter 5032 at [0.74306034, −0.92732041, −0.93242568]
Locally optimized emitter 5029 at [1.3052561, −0.73097638, −0.9395087]
Locally optimized emitter 5020 at [1.8888127, −0.52481239, −0.96713061]

Before we do any computation with this view, we throw away data from emitters that had insufficient or conflicting data. We see that emitters 5001-5003 don't have readings from all the microphones, so we don't touch those emitters here.

The first step of the computation is to estimate the position of every emitter to the local coordinate system of the calibration object in this view. Here we have good data from 7 emitters in this view. We look at the variance of the ranges measured between each microphone-emitter pair to make sure the data is self-consistent. In this particular snippet of data the worst range measurement has 0.47 mm of RMS deviation, which is deemed low enough. For each emitter we thus have 4 ranges to known relative 3D positions (those of the calibration object). We can then run a triangulation to estimate the position of the emitter in the local coordinate system of the calibration object. This is purely geometric, ignoring any speed-of-sound effects. Here we see that we computed the position of emitter 5030 with an RMS error of 0.0186 mm. This error is also deemed low enough to accept. When we have localized all the emitters in this way, we print out the relative positions of all the emitters, as we have just computed them.

When we have the local positions of the emitters in the coordinate system for each view, we move on to the next step. We take all the local emitter positions for all available views, and join them together. In a global coordinate system we try to compute poses of all emitters and all the calibration object views. This is also done purely geometrically, without taking into account any speed of sound factors. I compute this one of two ways: if the geometry estimate from a previous step has all the emitters that this view has, I can simply match these 2 estimates together. This is a very easy problem, computationally, so I do this whenever I can. When this path is taken, the output looks like:
Multi-View Join
Used previous solution for the joint aligner. RMS: 0.027652927234537

Here the two point clouds fit with an RMS error of 27.7 mm. This is fairly high, but since the results are simply a seed to fairly robust solver, it's good enough.

If the previous solution doesn't exist or there isn't enough overlap between the two sets of emitters, I have to fit all the N available views together. This computation is much slower. It is iterative, reporting the RMS fit error with every iteration. In this case the output looks like:
Multi-view join
Couldn't use previous solution because there isn't one
RMS error: 1.8366949257969
RMS error: 0.922357400823466
RMS error: 0.255632967116382
RMS error: 0.0183757969054668
RMS error: 0.00421697153275043
RMS error: 0.00421678408255343

Here we see that we stabilize at 4.2 mm of RMS error (this is a different instant from the above 27.7 mm, so the results shouldn't be the same).

At this point we have an estimate of all the geometry in the system. We can now use this estimate to seed a full solver that attempts to minimize the main error function, defined in Equation (1). First off, we solve this equation while allowing the speed of sound to vary, but locking down the height dependence. We get output like:
Running full global optimizer with no speed-of-sound-on-height dependence
RMS error so far: 20.502471 mm
CHOLMOD warning: not positive definite
RMS error so far: 0.703611 mm
RMS error so far: 0.608656 mm
RMS error so far: 0.608656 mm
Success! took 2 iterations
RMS error so far: 0.608656 mm

Here we ran the full optimizer to find a global solution with an RMS error of 0.608656 mm. This is fairly typical of the accuracies at this point. Note that at this stage you will always see the warning CHOLMOD warning: not positive definite. This simply means that there were optimization variables that do not affect the error function; since we have locked down ν₁ so this warning makes perfect sense.

At this point we have a decent estimate of all of our geometry and the speed of sound. In particular, we have an estimate of the orientations of the calibration object at every view. Since for each view we have sampled the accelerometer, we can now use these measured gravity vectors to solve for the mechanical mounting error of the accelerometer, and to estimate the direction of gravity in the global coordinate system (Appendix B.2):
Orientation optimizer callback cost: −223.931081926017
Orientation optimizer callback cost: −89.0331081780974
Orientation optimizer callback cost: −224.825607221066
Orientation optimizer callback cost: −224.849863864203
Orientation optimizer callback cost: −224.850065566545
Orientation optimizer callback cost: −224.850466618581
Orientation optimizer callback cost: −224.850482636334
Orientation optimizer callback cost: −224.850696549625
Orientation optimizer callback cost: −224.850719699272
Orientation optimizer callback cost: −224.85071969937

Here I'm solving Equation (6), reporting the optimal value as I go. Note that the cost function here is not normalized so the best possible result for this cost is —N² where N is the number of views so far. It is typical to get values that are very close to this best-possible value. For instance in this example we have 15 views, so the best possible cost is −225, while we found a rotation that yields −224.8507. I just solved the global orientation problem so I can now vary speed-of-sound with height, since I now know where “up” is.

At this point we have an estimate of all our geometry (including the non-yaw component of orientation) and the speed of sound. I am ready to run the final, full computation:
Running full global optimizer
RMS error so far: 21.290070 mm
RMS error so far: 0.570208 mm
RMS error so far: 0.438752 mm
RMS error so far: 0.438714 mm
RMS error so far: 0.438714 mm
Success! took 4 iterations
RMS error so far: 0.438714 mm

I solved the full problem to an RMS accuracy of 0.438714 mm, which is better than the 0.608656 mm I got before. This makes sense since I now know one more variables ν₁ I can manipulate while trying to minimize the error. Note that even though the extra gain of 0.169942 mm may look insignificant, non-negligible shifts in geometry may have been necessary to achieve it. Especially with ceiling-mounted emitters (such as we have here), experience has shown that significant gains in calibration accuracy come from this extra computation step. Ceiling-mounted emitters generally correlate with a larger gain in RMS error and larger |ν₁|, indicating a strong dependence of speed-of-sound on height.

I have now solved the full problem. Since the rotations likely moved since the last time I solved for the orientation, I do it again here:
Orientation optimizer callback cost: −223.966265601729
Orientation optimizer callback cost: −89.9843933831491
Orientation optimizer callback cost: −224.955451393559
Orientation optimizer callback cost: −224.981749851503
Orientation optimizer callback cost: −224.981751024652
Orientation optimizer callback cost: −224.981751607597
Orientation optimizer callback cost: −224.981752570402
Orientation optimizer callback cost: −224.98175267406
Orientation optimizer callback cost: −224.981752690556
Orientation optimizer callback cost: −224.981752691267
Orientation optimizer callback cost: −224.981752691267
Best mean gravity inconsistency of 0.515984497583381 degrees
Speed-of-sound-on-height dependence caused a gravity shift of 0.212941116609611 degrees
Rotation to align+x to +x: yaw of −0.0552996660714145 degrees
Mic-accelerometer offset: 4.02100231413929 degrees

The measured gravity vectors have a mean deviation of 0.516 degrees from the optimal joint vector. This is typical. I expect the gravity vector to move only a little bit from the previous gravity optimization. Here adding ν₁ to the optimization shifted the gravity vector 0.213 degree. If a much larger shift was necessary, something was probably wrong, and more data is likely needed. In practice it's very rare to see large shifts here. All the rotating can yaw us also, so I re-align the x-axis to match the first view's x-axis, as before. This also tends to be very small (0.055 degree here). The reported Mic-accelerometer offset is the manufacturing tolerance I described previously. This is usually a few degrees, and is characteristic of a particular calibration object. If I were to calibrate another system with this same calibration object, I would expect a similar value for this offset. If these values don't match up, this would be another indication that something is wrong and more data is needed. Orientating the next view differently will increase our confidence in this value, giving us a more precise estimate.

The rest of the output gives us more feedback about the solution:
At z=0: vsound=341.277801 m/s, corresponding to 16.7002147837397 degrees C.
For 1m of +z, change in vsound is −4.348308 m/s, corresponding to −7.49111517788456 degree C. confidence of vsound0, vsound1: 1.39040395285925e-06 2.96219705811892e-06
Emitter 5001: sloppiest direction[0.94811116, −0.20720112, −0.24114919] with certainty 0.032670567
Emitter 5002: sloppiest direction[0.95336314, −0.20627719, 0.022033712] with certainty 0.037042819
Emitter 5003: sloppiest direction [−0.057574316, 0.89040416, −0.45151481] with certainty 0.054239190
Emitter 5004: sloppiest direction[0.069111499, −0.83930972, 0.5392428] with certainty 0.058657003
Emitter 5005: sloppiest direction[0.85481533, 0.44097382, −0.2735559] with certainty 0.037280945
. . .

Here we're told about the final ν₀ and ν₁ values. The resulting ν₀ and ν₁ correspond to 16.7 (Celsius) and a gain of 7.49 (Celsius) with every vertical meter (+z points down, so the reported value should be negative). This is a typical for ceiling-mounted emitters. The values do sound like they exaggerate the actual temperature difference, but this is likely due to the actual temperature distribution not being linear, as our v1 term requires. When looking at the emitters that are not mounted at the ceiling, the layer of warm air near on top would not affect us, and we would expect a lot less height dependence. In that scenario, ν₁ would be much smaller and ν₁ should reflect reality much more.

The computation of the confidences and certainties mentioned in the output is described in Appendix B.4. TODO: mention desired values here.

Once the calibration is complete the user has approved the confidences, the final constellation is reported:
MCC
MCF1, −2.117970908, −1.608561094, −2.350324598, 0.2988445881, 0.5582724034, 0.7739663013, 5001
MCF2, −1.204965247, −1.567148562, −2.354462877, −0.04952943547, 0.6441428613, 0.763299947, 5002 [symbol]
MCF35, −1.354024019, 1.475988467, −2.352683481, 0.01259953187, −0.4673469102, 0.8839842290, 5035
MCF36, −2.267082176, 1.431039153, −2.355287817, 0.3382521168, −0.2692446455,
0.9017165997, 5036
MCe
MConfigLockMode0
Press enter to exit

### 2.4 Interpreting User Feedback: Graphs

In addition the console-based user feedback described above, some information is displayed graphically. Thus the user can act based on easily-interpretable graphical output instead of poring through hundreds of lines of text.

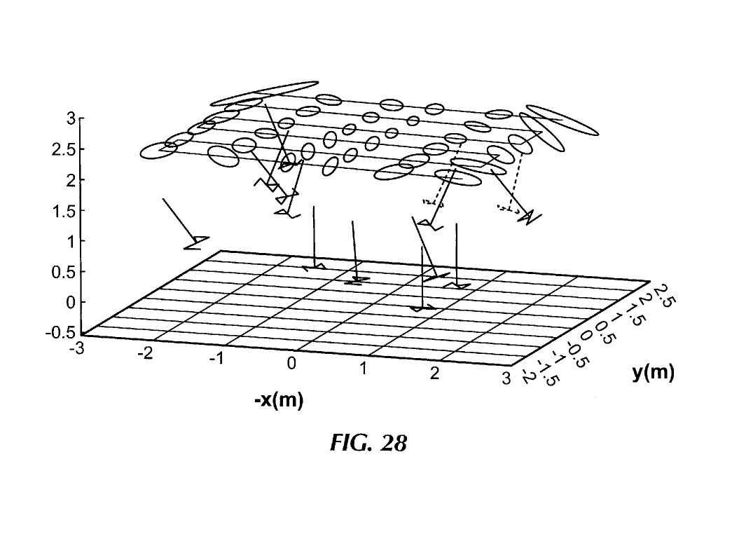

Three plots are generated. These are updated with every run of the solver to report on the current state of the solution, and on its evolution through time. Sample plots are shown that were gathered after 15 views looking at a ceiling-mounted 36-emitter system. (same calibration run analyzed in the previous section). These appear in FIGS. 28 to 30.

The most telling plot is a 3D plot showing the current best-estimate geometry and uncertainties. This plot only shows a snapshot in time, and the sample shown in FIG. 28 comes from analyzing all available 15 views.

FIG. 28 is a sample plot shown to the user at the end of a calibration run. The red ellipsoids represent the positions and uncertainties of the emitters. The colored lines represent the poses of the calibration object where the views were gathered (lines connect the 4 microphones, the middle of the object and a point in front). We can see the best uncertainties near the middle of the array and the worst ones at the edges.

Here we see the full geometry of the solution. The uncertainty ellipsoids clearly show that the estimates of the emitter positions in the middle of the space are more precise than those at the edge of the space. This is largely due to the emitters in the middle being heard by more views as we move around the room, so there is more data describing those emitters. Particularly poor are the 2 emitters in the far corners; both of these were challenging to get data for, and it shows.

### 2.4.1 Interpreting Uncertainty Ellipsoids

It is important to be able to interpret the meaning of the uncertainty ellipsoids so that future views can be positioned intelligently. There are two main contributors to the uncertainties displayed in the ellipsoids: geometric uncertainties; and speed of sound uncertainties

First, let's examine just the geometric uncertainties, assuming that the speed of sound values are known exactly.

When a calibration object gathers data, it measures the ranges to the emitters in front of it: the component of the emitter position along the measurement axis is measured directly, and the component perpendicular to this axis is inferred. This translates directly into the confidence ellipsoid produced by this view, which is pancake-shaped with the flat side facing the calibration object. The ellipsoids shown in FIG. 28 effectively come from merging of all the pancakes coming from each view. Just the geometric uncertainties of a calibrated system would consist of a set of squashed pancake-like ellipsoids, each flat face oriented towards the positions of the views that sampled each corresponding emitter. Thus the most effective way to improve the accuracy of a particular emitter is to measure “into” the longest direction of its uncertainly ellipsoid. I.e to obtain a view by setting the calibration object to point at the emitter is a direction that aligns as much as is possible to the major axis of the ellipsoid in question.

The above logic is slightly complicated by the effect of speed-of-sound parameter (ν₀ and ν₁) uncertainty on the ellipsoids. If we are highly uncertain in the speed of sound, there's a lot of uncertainty in the range measurements themselves. This would make the inferred sideways components more certain than the direct ones, the opposite situation from that observed from geometric uncertainties. So if we calibrated a full system and somehow had only speed-of-sound uncertainties, all the ellipsoids would be long and thin, pointing towards the positions of the views that sampled each emitter; again, the opposite situation from the geometric uncertainty case.

In reality we always have both components of uncertainty. Experience shows that speed-of-sound uncertainty dominated at first, but as more views are gathered, the geometric uncertainty begins to dominate. This can be clearly seen by looking at the uncertainty ellipsoids for the emitters in the middle of the constellation. At first, their major axes tend to point at the center of the calibration space, flattening out as more views are gathered. The specific case shown in FIG. 28 has many views already gathered, so the ellipsoids have already flattened out.

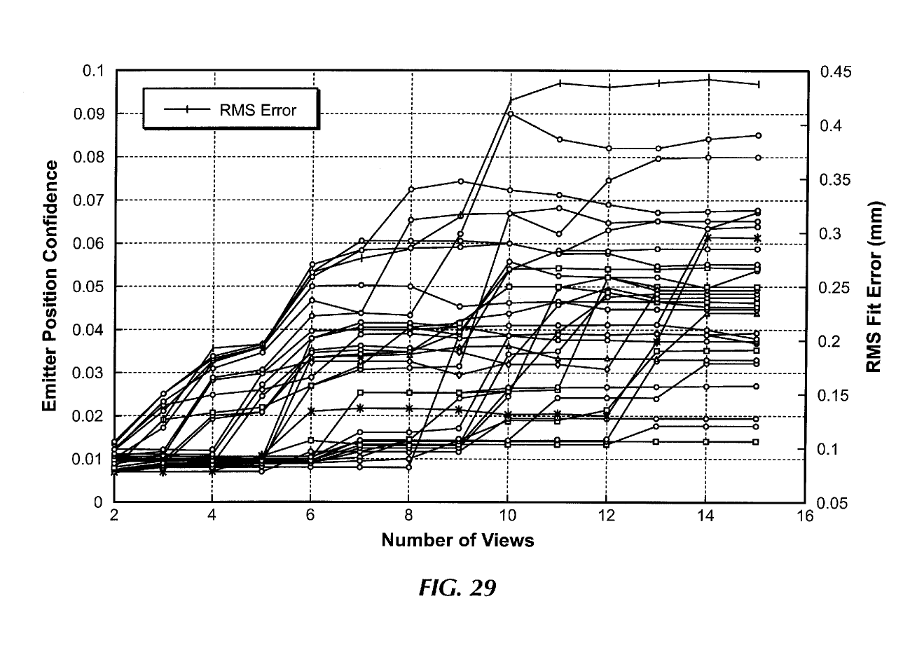

FIG. 29 is a sample plot shown to the user at the end of a calibration run. The thick red line is plotted on the right y-axis and represents the RMS error of the optimal geometry computed after each number of views were gathered. The thin lines are plotted on the left y-axis, and represent the worst-direction confidence of the position of each emitter. This corresponds inversely to the length of the major-axis of each ellipsoid in FIG. 28. We can see that with more views confidences generally improve and the RMS error increases, then stabilizes.

Another plot that reports the uncertainties is shown in FIG. 29. Unlike FIG. 28, this plot does not show a snapshot in time, but rather a progression of the solution as more views are gathered. This plot shows the worst-case confidences of the position of each emitter. This is exactly inversely proportional to the major-axis-length of each uncertainty ellipsoid. There's a separate curve for each emitter. These values are plotted against the left y-axis, and we clearly see that with more views the confidences increase. One convenient element of this plot is that we can clearly see which emitter is worst by looking at the right edge of this plot.

Another independent value being plotted here is the RMS error of our fit. Recall from Equation (1) that the main problem we are solving minimizes a time-of-flight error. This error is converted to a distance error and appears on the right y-axis of FIG. 28. The general trend here is for this error to increase with more views, but to flatten out as some point. It is OK for this error to get worse with more views simply because given insufficient data we are free to underestimate the “real” error; we simple don't have enough information to know better. The flattening out is important, though. At some point, we should have a decent idea of where everything is, and more data should support this estimate. This consensus is indicated in a flat RMS error curve.

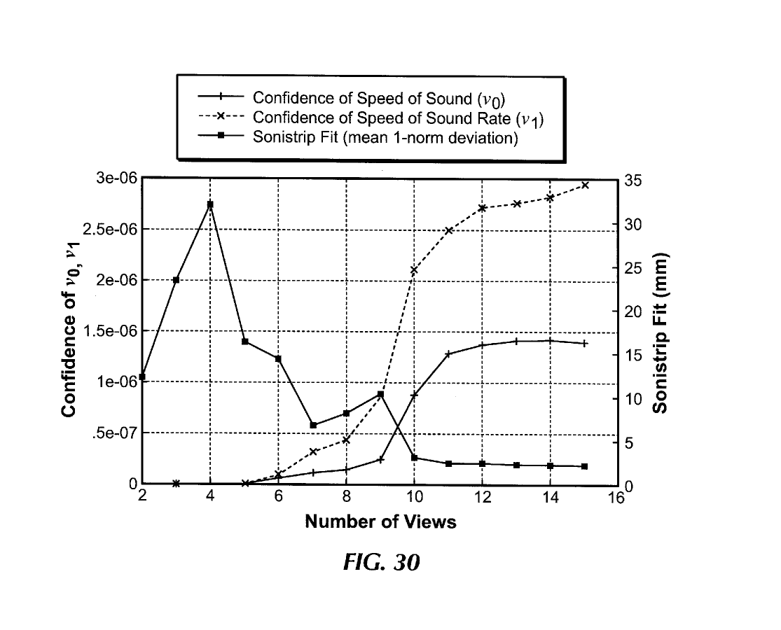

FIG. 30 is a sample plot shown to the user at the end of a calibration run. The thick blue line is plotted on the right y-axis and represents the mean 1-norm error in the sonistrip fit of the optimal geometry computed after each number of views were gathered. The thin lines are plotted on the left y-axis, and represent the confidences of the 2 speed of sound parameters. We can see that with more views confidences go up and errors go down.

Yet another plot that displays various runtime performance characteristics is shown in FIG. 30. As with FIG. 29 this shows the evolution of the solution as more views are gathered. One set of displayed values is our confidence in the two speed-of-sound parameters (ν₀ and ν₁). These should increase with more data, and FIG. 29 confirms this.

If we know that all the emitters are mounted inside sonistrips (as we do for the system that produced our sample plots), we then know the correct intra-strip emitter spacing and can use this information to validate our results. This fit quality is displayed in FIG. 30 with the thick, blue curved plotted on the right y-axis. This is an absolute measure of the precision of our constellation, so we want this to be as low as possible. As expected, we see high errors in the beginning of the calibration cycle and then, with more views, the errors drop to their final value. Here we end up with an error of about 2 mm. This is decent. It is possible to get in the 1 mm range if the measurements are gathered carefully and there's no significant airflow in the room. Not that this value is not used in the computation. It is only reported to the user to provide more information about the quality of the calibration thus far.

### 3. Tools

We have various tools available to communicate with Intersense hardware and to manipulate data pertaining to it. When our system is fully up and running, there's a wandreader process that is connected to the Intersense hardware. This process reads off the tracking results, and outputs them as proteins. It is impossible for multiple processes to talk to the hardware at the same time, so this splits the tools into those that talk to the hardware directly, and those that talk to it through the wandreader. To start/stop the wandreader, as root issue wandreader start or wandreader stop (these are scripts installed with the Oblong pipeline stack).

### 3.1 General Useful Tools

All of our tools assume some familiarity with UNIX, its data piping, and tools generally available on UNIX-like systems. This is a quick overview of tools that are very useful to interact with Intersense hardware and data. If you are not familiar with these tools, you are strongly encouraged to read their manpages.

### 3.1.1 Netcat

nc is the “netcat” tool. It is used to directly communicate with a network socket. Since one generally communicated to Intersense hardware with a TCP connection or port 5005, netcat can be used to do this. As mentioned previously this is only possible if the wandreader is not running. Example: to open a connection to Intersense hardware running on IP 10.10.4.152, issue.
$ nc 10.10.4.152 5005

Then you can give commands to the hardware simply by typing them in (some Intersense commands are described in Appendix A). Since constellations in canonical format (see Section 3.4.1) consist purely of Intersense commands, these can be sent to the hardware directly, as in
$ nc -q0 10.10.4.152 5005<constellation

Most canonical constellation end with the ̂K (ASCII 0x0B) character, which tells the hardware to persist its settings. Thus if above command succeeds, the hardware will displays Settings saved on its LCD, or console.

3.1.2 feedgnuplot

feedgnuplot is not a standard UNIX tool, but it's extremely useful in visualizing data, and we describe it here. Feedgnuplot is a frontend to gnuplot that plots ASCII data coming in on STDIN. As a trivial example, here's how to use it to plot number 1, 2, 3, 4, 5:
$ seq 51 feedgnuplot -points

Examples of using this tool to plot tracking statistics and constellation data are given in Section 3.3, Section 3.4.1 and Section 3.4.2.

3.2 Low-level tools

We have a suite of tools written to accomplish various low-level testing/debugging tasks. These tools are all available in the libolong-internsense-perl package. The API these tools are based on currently has no support for reading data from the system while it's tracking, so none of these tools have access to this tracking data. As such, all of these tools communicate to the hardware directly, without the wandreader. All of these tools take in the address of the Intersense hardware to communicate with. This intersense address can be a network address or a file. If it looks like an IP, it is used on port 5005. It there is a: in the address, it is used as a network address and a port (machine.local:5005 will connect to machine.local on port 5005 for instance). Otherwise, the address is treated as a simple file. This is useful if we want to connect over a serial connection instead of a network. All of these tools have manpages and you're encouraged to read them. The tools are:
readRawRanges.pl reads the raw range data from Inersense. Useful to check the audibility of particular microphones and emitters.
readRawIMU.pl reads the raw IMU data from Intersense. Useful to get the measured gravity vector.
validateWands.pl is an automated script to test several wands for audibility issues. This is the main wand quality control script, so it will get more features. selectEmitter.pl simply turns on given emitter, turning off all the others. This is useful when running various tests.
sendIntersenseFile.pl uploads a file to the Intersense hardware. This is most useful for reprovisioning. For this purpose though, the below reprovision.pl utility is more appropriate.
recvIntersenseFile.pl downloads a file from the Intersense hardware. One can download the insense.log file to debug Intersense connection issues of the isradio.ini file to see what the current provisioning state is.
Reprovision.pl is used to connect new wands to the hardware. This script takes a list of wands and channels, and tells the Intersense hardware to talk to them instead of the wands it was talking to previously. Internally this constructs an isradio.ini file, uploads it and resets the Intersense hardware.

In addition to the reprovisioning tools just mentioned, there are several tools with similar functionality available as part of Oblong's pipeline stack. The Intersense-related tools that are distributed as part of the pipeline and talk to the Intersense hardware directly use a different convention when addressing the hardware. These tools take in the hardware target as -I address: port where the address must be a numeric IP, and port is almost always 5005. These tools are:
Isense-getRadio downloads the isradio.ini file to determine the current provisioning state of the hardware. This is similar to recvIntersenseFile.pl
Isense-setRadio connects given wands to the Intersense hardware. This tools is functionally identical to reprovision.pl
Isense-reset restarts the Intersense hardware. Similar to isense-setRadio, but doesn't upload the isradio.ini file

If the wandreader is running, it's listening on the wandreader pool for commands. We can then use the wand-ctl tool to send it a protein to initiate a reprovision. The specific sub-commands are wand-ctl change_rf and wand-ctl change_serial. For example to change the channel for the first wand to 3, issue
$ wand-ctl change_rf 1 3

To connect wand 1003322 as wand 2, issue
$ wand-ctl change_serial 2 1003322

Note that the other reprovisioning tools can change 4 pieces of data (2 channels, 2 IDs) with one command, while wand_ctl requires 4 separate commands. For this reason it is usually much faster to use the other tools.

3.2.1 isradio.ini

The isradio.ini file was just mentioned as the carrier of provisioning data. This file is fairly straightforward. An example:
Device=1001234:3:1
Device=1005678:13:2
DeviceOption=6

This says that the first wand is 1001234 on channel 3, and the second is 1005678 on channel 13/The DeviceOption field consists of several bits. If bit 1 is on (DeviceOption & 0x2), the the software will do an RF search every time it is started. With this bit on, every reboot of the software will effectively reprovision the wands. If bit 6 is on (DeviceOption & 0x40), then the isense.log will have more verbose debugging information. Normally DeviceOption=6 when we are reprovisioning and DeviceOption=4 otherwise.

### 3.3 Tools for Getting Tracking Data

The isense-readData tool exists to read off tracking data directly from the Intersense hardware. This tool comes with the pipeline and thus uses the -I syntax to address Intersense. In a way, this tool is a standalone version of wandreader that sends its results to STDOUT instead of pools. This tool connects to the hardware and then in a loop, reads off the tracking data, sending the results to STDOUT in a plain ASCII table. The first line of the output is a header that labels all of the fields that follow. By default, all available data is written out. If only a subset is desired, it can be selected by passing options to isense-readData. The available options to select desired output are
serial show serial number
tracking show the tracking status
comm show the communication integrity
measqual show the measurement quality
orientation show the orientation
position show the position
velocities show the velocity vectors
accels show the acceleration vectors
buttons show the button status
battery show the battery charge
firmversion show the firmware version
newdata show the newdata status
only xxxx Report data only from wand xxxx

Except for—only, these are all simply on/off switches. If none of the switches are given, all the data is output if any of the switches are given, only that data is output. To only get data for a particular wand, use the—only option. For example, to get just the tracking quality information for wand 1008844 issue
$ isense-readData -only 1008844 -tracking

Note that isense-filterlog.pl (described below) can also be used to select specific pieces of data from a stream instead of specifying the filter here.

If the wandreader is running, it is responsible for reading the tracking data, and writing it out to the wands pool. Like any other, this pool can be read with the peek command. This is a general g-speak tool used for reading pools. Conceptually, peeking the wands pool is similar to running isense-readData, except peek spits out a YAML-formatted protein, while isense-readData spits out an ASCII table. To unify these 2 tools, the pipeline comes with an isense-readData. Once we have the columns of ASCII data, we can use various UNIX tool that can manipulate such data. For instance, feedgnuplot can be used to make plots, as described in Section 3.1.2. To connect the Intersense hardware, log the data to a file, and make a realtime plot of tracking quality and communication integrity, one can issue
Isense-readData -I 10.10.4.151:5005 -only 1008437 -tracking -comm
Tee log
feedGnuplot -lines -stream 0.3 -domain -xlen 10 -le 0 tq -le 1 ci -ymin 0
--ymax 101 -curvestyleall ‘lw 3’

Equivalently, we can do the same from a running wandreader by issuing
Peek top://bs2.local/wands
Isense-denature.pl
Isense-filterlog.pl -only 1008437 trackingstatus commintegrity
Tee log
feedGnuplot -lines -stream 0.3 -domain -xlen 10 -le 0 tq -le 1 ci -ymin
0
--ymax 101 -curvestyleall ‘lw 3’

The feedgnuplot tool has a detailed manpage and you are encouraged to read it.

### 3.4 Tools for Handling Constellation

As mentioned previously in Section 2, the calibration routine writes its resulting constellating to STDOUT. If it is acceptable, this constellation can then be sent to the Intersense hardware. It is quite common to want to run some analyses on a constellation or to manipulate it before sending it onwards. For this reason we have the libolong-constellation-perl package that contains many tools to work with constellation data. These tools all have manpages that you are encouraged to read.

### 3.4.1 Constellation Formats

There are 3 formats for constellation files that we can work with. The first is the “canonical” format. This is what is produced by the calibration utility, and is also the format used when sending a constellation to the Intersense hardware. All of our constellation utilities whose job isn't to convert formats operate on canonical constellations. As example:
MCC
MCF1, 0.9736720142, 0.339671797, −1.815272453, −0.5784490362, −0.1446375038, 0.8027930648, 5001
MCF2, 0.09853272703, 0.3645144806, −1.80069332, −0.2291082806, −0.189620243, 0.9547531402, 5002
MCF3, −0.7757968608, 0.3955457870, −1.80374787, 0.2334416957, −0.2048329362, 0.9505516518, 5003
MCF4 −0.7946926069, −0.1906732708, −1.79953006, 0.2471579329, 0.1059693834, 0.9631632498, 5004
MCF5, 0.07908186036, −0.2194437346, −1.795251315, −0.2223296396, 0.12221621, 0.9672810949, 5005
MCF6, 0.9555267752, −0.2563854403, −1.80668872, −0.5769811675, 0.1180070317, 0.8081875232, 5006
MCe
MconfigLockMode0

The meat of the data has online per emitter. The first and last fields represent the order of the emitter in the chain. Removing a line from the constellation will skip the respective emitter. The 6 numerical fields represent the 3D XYZ emitter position (in meters) followed by the 3D normal vector of the emitter. Intersense assumes that gravity is directed in the +z direction. The last byte of a constellation in this format is a non-printable character ̂K (ASCII 0xx0B). This indicates to the Intersense hardware that it should save its settings. Thus a canonical constellation sent to the hardware will persist.

If we want to query the Intersense hardware for its current stored constellation, we can send it the MCF command. The hardware then responds with the constellation, stored in the MCF format. Example:
31F 1 0.9736720142 0.3339671797 −1.815272453 −0.5784490362 −0.1446375038 0.8027930648 5001
31F 2 0.09853272703 0.3645144806 −1.80069332 −0.2291082806, −0.189620243 0.9547531402 5002
31F 3 −0.7757968608 0.395545787 −1.80374787 0.2334416957 −0.2048329362 0.9505516518 5003
31F 4 −0.7946926069 −0.1906732708 −1.799953006 0.2471579329 0.1059693834 0.9631632498 5004
31F 5 0.07908186036 −0.2194437346 −1.795251315 −0.2223296396 0.122216261 0.9672810949 5005
31F 6 0.9555267752 −0.2563854403 −1.806688872 −0.5769811675 0.1180070317 0.8081875232 5006
31 F 0 0.0000 0.0000 0.0000 0.00 0.00 0.00 0

To convert a canonical constellation to an MCF constellation, the constellation -ToMCF.pl tool can be used. To go the other way, use the constellation -FromMCF.pl. Both of these tools read their STDIN and write their STDOUT. No options are accepted.

Another useful data format we support is a plain ASCII table of the emitter positions. This is useful to provide input for any UNIX tool that can accept such data. An example of a constellation in this format:
0.9736720142, 0.33967197, −1.815272453
0.09853272703, 0.3645144806, −1.80069332
−0.7757968608, 0.395545787, −1.80374787
−0.7946926069, −0.1906732708, −1.799953006
0.07908186036, −0.2194437345, −1.795251315
0.9555267752, −0.2563854403, −1.806688872

As with the MCF format, we have tools to convert to and from this format: constellation-ToPos.pl and constellation-FromPos.pl. Note that this constellation format does not have the normal vector data. When converting from a canonical representation we simply throw away the normal. When converting to canonical representation, we hard-code the normal vectors to +z. This is generally correct for downward-facing emitters but will be wrong for any other geometry. It is thus often not appropriate the send constellation converted in this way to the hardware for tracking.

Here's an example of reading a constellation from the hardware and plotting it:
$ echo MCF
Nc 10.10.4.152 5005
Constellation-FromMCF.pl
Constellation-ToPos.pl
Feedgnuplot -lines -points -3d -domain

### 3.4.2 Constellation Evaluation

Once we have a constellation, it is often described to run some analyses on it. Our pre-made analysis tools are described here. If a desired analysis doesn't already exist, one can use constellation-ToPos.pl to convert the constellation to a pure XYZ form, which can then be analyzed with any of a number of external mathematics tools (PDL, numpy, octave, etc). The tools we have are:
Constellation-compare.pl takes in 2 constellations, and reports how well they match. If --plot3d is passed in, one constellation is fitted to the other, and a 3D plot is made showing both constellations together. Without-plot3d the same fit is performed, but instead of the full geometry being shown in 3D, the distances between each corresponding pair of emitters are output.
Constellation-getStripFit.pl take in a constellation and reports how much each interstitial distance varies from what it would be in a sonistrip. Note that a sonistrip has 3 emitters, so we report 2 errors for each strip. Thus an 18 emitter constellation consisting of 6 strips would produce 12 of these deviations. Both 4 ft and 6 ft strips are supported: the better of the two fits is returned

An example of reading a constellation and plotting its strip fit:
$ echo MCF
Nc 10.10.4.152 5005
Constellation-getStripFit.pl
Feedgnuplot -lines -points

### 3.4.3 Constellation Manipulation

We have a set of tools used to modify a given constellations. This is often useful if we obtained a constellation from a calibration routine, but need to move or rotate it to better fir the coordinate system of the screens. The tools are
Constellation-Shift.pl translates a constellation. Input on STDIN, output on STDOUT. The desired translation vector must be passed in as 3 separate arguments on the commandline
Constellation-AlignPairTox.pl rotated the constellation around the z-axis to align the given pair of emitters with the +x vector as closely as possible. The rotation is constrained to the z-axis because a calibrated constellation is already aligned correctly with gravity, which acts in the +z direction. Input on STDIN, output on STDOUT. The pair of emitters to match to +x must be given as two separate arguments on the commandline.
Constellation-AlignTo.pl translates and rotates (around z-axis) one constellation to match another as closely as possible. This is useful if we calibrated a system, set up its screens and then ran the calibration again because we were unhappy with the previous calibration for whatever reason. We should have a scenario where the new constellation is more accurate but the old constellation is positioned more correctly (because the screens are already set up). In this case we can run constellation-AlignTo.pl -ref constellation.old constellation.new. A constellation would be written to STDOUT that rotates and translated the new constellation to fit the old one.
Constellation-MakeNormalsStraightDown.pl takes a constellation and sets all the emitter normal to (0.0.1). This is only useful if we want to use the ISDEMO tool to give us the sonistrip fit. Unlike our sonistrip fit (constellation-getStripFit.pl), Intersense's strip fit uses the normal and returns bogus values if these normal are not what it expects.

### APPENDICES

A. Direct Intersense Commands

The Intersense hardware uses a specific set of commands for all of it I/O. If we connect directly to the hardware, we can send these commands ourselves. One way to connect is with the netcat tool, as described in Section 3.1.1. A very small subset of useful commands is given here:
C tells the Intersense hardware to leave continuous mode. This is a mode of operation in which the hardware sends out, unsolicited binary data without being polled for it. This is the usual mode of operation when tracking, but it is not desirable when sending the hardware our commands. If you see a spew of data as soon as you connect to the hardware send this command to quell it.
MCF is the main command used to send and receive constellation data. To request the current constellation, send MCF by itself, without any arguments MP without arguments requests tracking status information. The returned string generally looks like 31PTe0L20 00 00 . . . . . Here 31P indicated that this is a reply to MP. This is followed by sets of 3 characters for each tracking object. So te0 refers to the firs wand, L20 to the second and so on. The first character is the tracking state (T for Tracking, L for Lost, X if no radio connection and empty if we have nothing provisioned in this slot). The second character is a hexadecimal number of received ultrasonic pulses in the last period; this corresponds to the RC readout on the Simtracker front panel. The third character is similar to the second, but it refers to the number of rejected measurements: RJ on the front panel. So in the above example, there are 2 wands, the first is tracking with 14 measurements and no rejections; the second is lost with 2 measurements and no rejections.
MWConfig reboots the Inersense hardware
MSystemTestl requests a Level-1 self test. This will return a long string with lots of status and version information.

B. Algorithm Overview

As stated previously the raw data input to the calibration routine is the range measurements obtained for each view. The calibration routine is tasked with computing a geometry that best explains the observed ranges. More precisely the calibration routine solves the non-linear least square problem

$${min}_{\vec{p}} {‖ \vec{x} ( \vec{p} ) ‖}^{2} ≡ {min}_{\vec{p}} {‖ \vec{T} ( \vec{p} ) - \frac{{\vec{p}}_{measured}}{{v}_{ref}} ‖}^{2} \qquad ( 1 )$$

Where \vec{p} is the vector we are optimizing, \vec{T} is the vector of times-of-flight we should we observing for a geometry described by \vec{p}, \vec{r}_{measured} is is a vector of ranges we did observe, and ν_{ref} is the reference speed of sound that Intersense uses to convert the times-of-flight they measure to the ranges they report

$$( 344.40 \frac{m}{s} ) .$$

I.e. we want to minimize the error between the expected and observed times-of-flight; if we minimized this, we have found the best geometry given the data that is available. We optimize the time-of-flight error instead of the range error because time-of-flight is what we actually measure. Note that while we measure the gravity vector for each view, the onboard accelerometer is not precise enough to be used in the optimization and we ignore those readings here. They are used to orient the whole constellation after it has been computed.

As stated previously, \vec{p} contains all the data that describes the state of the world that produces some particular range readings. Clearly, this vector must include the position of all the emitters (3 DOF each). It must also include the poses of each of the views (6 DOF each; position and orientation). These 2 sets of values fully describe the geometry of the system.

Note that since our data describes the relative distance between elements represented by \vec{p}, it is possible to move and rotate all the geometry together, and not affect the implied range reading. Thus it is desirable to anchor the geometry to make each geometry represented by \vec{p} unique. I do this by defining the global coordinate system by the first view. This means that the pose of the first view does not appear in \vec{p}, and all the other elements move in respect to this first view. This has some ramifications on the resulting constellation: the origin of the resulting constellation is located at the origin of the first view; and the x-axis of the constellation that results from solving Equation (1) aligns with the x-axis of the first view

This means that the first view should be taken from a location desired to be the origin. The +x vector of the first view should also align with the desired +x direction. If this isn't done, the resulting constellation will have to be moved and/or rotated. Tools that do this are described in Section 3.4.

B.1 Speed of Sound Considerations

It is tempting to say that these geometric parameters are all that \vec{p} needs to contain. Sadly life isn't so simple. The tracking system measures the time it takes for the ultrasonic pulse to travel from the emitter to the microphone. This time is then converted to a distance by multiplying it with the speed of sound. The speed of sound is strongly dependent on temperature so we can not assume any particular value for the speed of sound. We thus estimate the speed of sound together with all the geometry data: speed of sound, referred to as ν₀, is an element of \vec{p}. This is takes care of global variations in the speed of sound, but not local ones. I.e it assumes the temperature is constant throughout the space. This is a reasonable assumption for spaces with very high ceilings where the emitters are not mounted at the ceiling. In spaces with ceiling-mounted emitters, you generally see significantly wanner air gathered on top, which breaks the constant-temperature assumption. To deal with this I assume that temperature (and the speed of sound) varies linearly with height. This is represented by a value ν₁ that is yet another element of \vec{p}. Even more sophisticated temperature distribution models can be used, but the danger of overfitting rises dramatically with each extra element, so I stop here. Clearly any airflow breaks the inherent assumption, so it is highly desirable to turn off the A/S or heating system while running the calibration. Things will still work if this isn't done, but the resulting calibration will not be precise.

To summarize, the optimization vector \vec{p} contains:
The positions of all the emitters
The poses of all the views other than the first

The speed of sound at z=0:

$${v}_{0} \frac{m}{s}$$

The rate of speed of sound increase with height:

$${v}_{1} \frac{\frac{m}{s}}{m}$$

B.2 Orientation Computation

As stated previously in Appendix B, the accelemeter provided with an Intersense tracker is not accurate enough to use in the main optimization problem (1). Even so, the measured gravity vectors are still useful to correctly orient the constellation obtained from solving Equation (1).

A complicating factor in this is that the gravity-measuring device (accelerometer) is not attached very precisely to the range-measuring devices (mircophones). We do know how we built the calibration object, but only within several degrees of accuracy or so. Thus I want to more precisely estimate this manufacturing error.

Let's say a rotation matrix R_{offset} maps a gravity measurement in the accelerometer coordinate system (\vec{g}ᵢ) to one in the microphone coordinate system for view i. Since we have already solve Equation (1), we have rotation matrices Rᵢ, that map the microphone coordinate system of view i to the global coordinate system. So the gravity vector for view i is

\vec{g}ᵢ≡RᵢR_{offset}\vec{g}_{measured,i} (2)

All of these views measure the same gravity (let's call it \vec{g}_{global} in the global coordinate system), so let's find R_{offset} that aligns all the measured gravity vectors with \vec{g}_{global} as much as possible:

$${max}_{{R}_{offset}} {\sum }_{i} {\vec{g}}_{global}^{T} {\vec{g}}_{i} = {max}_{{R}_{offset}} {\vec{g}}_{global}^{T} {\sum }_{i} {R}_{i} {R}_{offset} {\vec{g}}_{measured , i} ≡ {max}_{{R}_{offset}} {\vec{g}}_{global}^{T} \vec{v} \qquad ( 3 )$$

Since \vec{g}_{global} is a unit vector, this is clearly maximized when \vec{g}_{global}∥\vec{v}* where \vec{v}* is the optimal \vec{v}. Naturally

$$\begin{matrix}{\vec{g}}_{global} = \frac{{\vec{v}}^{*}}{‖ {\vec{v}}^{*} ‖} \\ Furthermore & ( 4 ) \\ {\vec{g}}_{global}^{T} {\vec{v}}^{*} = ‖ {\vec{v}}^{*} ‖ = ‖ {\sum }_{i} {R}_{i} {R}_{offset}^{*} {\vec{g}}_{measured , i} ‖ & ( 5 )\end{matrix}$$

Thus we can compute the optimal R_{offset} by solving the nonlinear optimization problem

$${min}_{{R}_{offset}} - {‖ {\sum }_{i} {R}_{i} {R}_{offset} {\vec{g}}_{measured , i} ‖}^{2} \qquad ( 6 )$$

This yields R_{offset}, which yields \vec{g}_{global}, which is aligned with the +z axis to orient the constellation.

B.3 Algorithm Implementation Details

As stated previously, the big-picture goal is to solve Equation (1). To do this I use a sparse implementation of Powell's dog-leg method. This dog-led method is similar in spirit to the more well-known Levenberg-Marquardt method, but has some practical advantages. Due to the structure of the problem, our Jacobian matrix

$$\frac{\partial \vec{x}}{\partial \vec{p}}$$

mostly, consists of 0 entries. The spare method we′re using takes advantage of this structure to give us a significant performance boost. The specific method is LGPL-licenses and available at http://github.com/Oblong/libdogleg.

As with all iterative methods, a good seed is essential for reliable and quick convergence of the solver. We thus need to produce an estimate of the solution before we even attempt to tackle Equation (1). We do this in several steps. When a single emitter hears all the microphones from a single position of the calibration object, it uses L-BFGS to estimate the emitter position in the coordinate system of the calibration object. This is a simple triangulation problem, which converges quickly and reliably. Here we assume some specific speed of sound, and see the L-BFGS solver with a position a few meters in front of the calibration object. When the above is completed, then for each view we have an estimate of all the emitter positions in the local coordinate system of that view. Since all these views describe the same physical emitters, we can move around these local coordinate system to match up the emitter positions as much as possible. With only 2 views, this can be solved in closed form with the Procrustes method. With N views, however, this requires, yet another iterative stage. I use Pottmann's variation on ICP, but other methods are possible. When this is done, we have an estimate of all the view poses and all the emitter positions.

This gives us the seed we seek. With this seed we solve Equation (1), allowing the speed of sound (νₒ) to vary, but locking down the speed of sound gradient (ν₁). We do this because at this point we're not yet sure of which way is up, so we can't apply ν₁ in a meaningful way.

When this preliminary solve of Equation (1) is complete, we use the gravity vector we measured from each view to rotate the solution, as described in Appendix B.2. This is also implemented with L-BFGS.

When we have done this, we have a good estimate of which way “up” is, and we can thus solve the full problem with all variables. Since this changes the orientation vectors from the previous estimate, we estimate the orientation again, and re-orient the new constellation with the new gravity vector. Now we have the final estimate of our constellation.

B.4 Uncertainty Analysis

So far I have described how the set of raw readings is used to generate a geometry that best describes it. Determining this optimal geometry is just half the battle, though: we must also get an estimate if our confidence level in each part of the solution. A calibration can be deemed finished only when we have achieved a high enough level of confidence in each part of our solution. The confidence estimates all come from solving Equation (1). Like any other nonlinear least squares problem, here we try to fit our model to match a set of measurements, so in general we're trying to solve

$${min}_{\vec{p}} E ( \vec{p} ) \qquad ( 7 )$$

where the error function E is defined as

E(\vec{p})≡∥\vec{x}(\vec{p})|² (8)

where \vec{x} comes from Equation (1). Let's say we have solved this equation to determine that it's optimized by \vec{p}*. If we are very confident in this solution, then moving \vec{p} slightly off this optimum will cause the cost E to increase very quickly. On the other hand, if we are not confident, then we can move \vec{p} a lot without causing E to rise very much. I.e there would be a large region that's almost-optimal. We thus want to analyze the local cost surface E(\vec{p}*+\vec{Δ}).
We define

$$J ≡ \frac{\partial \vec{x}}{\partial \vec{p}} .$$

### Then

E(\vec{p}*+\vec{Δ})≡∥\vec{x}(\vec{p}*+\vec{Δ})∥²≈∥\vec{x}*+J*\vec{Δ}∥²=∥\vec{x}*∥²+∥J*\vec{Δ}∥²+2Δ^{T}J*^{T}\vec{x}* (9)

Specifically,

E(\vec{p}*+\vec{Δ})−E(\vec{p}*)≈∥J*\vec{Δ}∥²+2Δ^{T}J*^{T}\vec{x}* (10)

Since Equation (8) describes an optimum, we know that

$$\frac{\partial E}{\partial \vec{p}} ( {\vec{p}}^{*} ) = 2 {\vec{x}}^{* T} {J}^{*} = 0.$$

Thus the above simplifies to

E(\vec{p}* +\vec{Δ})−E(\vec{p}*)≈∥J*\vec{Δ}∥²=\vec{Δ}^{T}J*^{T}J*\vec{Δ} (11)

Thus the local cost surface around \vec{p}* can be described by a paraboloid defined by H*≡2J*^{T}J* where H* is Hessian matrix of E at the optimum \vec{p}*. The Hessian matrix can be used to infer our confidence in the optimal solution \vec{p}*. In the N-dimensional space near equal-cost contours are ellipsoids described by H*. The axis directions of these ellipsoids are the eigenvectors of H* (orthogonal since H* is symmetric), and the scales on those axes are the corresponding eigenvalues. The eigenvalues clearly represent our confidence, as described above.

Note that the just-described method allows us to compute the confidence of solution in the full N-dimensional space. This is great in general, but it's not completely sufficient for our application. We want to be able to determine the 3-dimensional confidence for each emitter position separately instead of generating a single N-dimensional confidence for the whole problem at once. Let's say we want to determine our confidence in the position of a particular emitter, described by a subset of the full state vector \vec{p}₀. Let's call all the other variables \vec{p}₁. We want to see how the error function E responds to perturbations in \vec{p}₀. A simple way to do this is to simply look at the eigenvalues/eigenvectors of the submatrix of H* that corresponds to \vec{p}₀. This work, but we can do better. We ideally want to compute the sensitivity of E to perturbations in \vec{p}₀ while reoptimizing the other variables. It is possible to see a large increase in E when tweaking \vec{p}₀ by itself (indicating a high confidence), but for this increase to vanish if we move another variable to compensate. In this case we really aren't confident in our estimate of \vec{p}₀*. We thus solve a slightly different problem. We find the global optimum \vec{p}*, move \vec{p}₀ a bit, and find the optimum \vec{p}₁* while holding the tweaked \vec{p}₀ constant. I.e. we're looking at a deviation

$${\vec{Δ}}^{†} ≡ ( \begin{matrix}\vec{Δ} \\ {\vec{Δ}}_{1}^{†}\end{matrix} )$$

where \vec{Δ}₁^{†} depends on \vec{Δ}₀ and we want to compute

$${E}^{†} ( {\vec{Δ}}_{0} ) - E ( {\vec{p}}^{*} ) ≡ {min}_{{\vec{Δ}}_{1}} E ( {\vec{p}}^{*} + ( \begin{matrix}{\vec{Δ}}_{0} \\ {\vec{Δ}}_{1}\end{matrix} ) ) - E ( {\vec{p}}^{*} ) ≡ {‖ {J}^{*} {\vec{Δ}}^{†} ‖}^{2} \qquad ( 12 )$$

As before, the eigenvalues and eigenvectors of the Hessian describing E^{†} determine the confidence we seek. Let's split our known Jacobian matrix to represent the two sets of variables in our partition: J*≡(J₀*J₁*). We have

$$\frac{\partial {‖ {J}^{*} \vec{Δ} ‖}^{2}}{\partial {\vec{Δ}}_{1}} = 2 {( {J}^{*} \vec{Δ} )}^{T} {J}_{1}^{*} = 0 \qquad ( 13 )$$

So

(\hat{Δ}₀^{T}J₀*^{T}+\vec{Δ}₁^{†T}J₁*^{T})J₁*=0 (14)

and

\vec{Δ}₁^{†}=−(J₁*^{T}J₁*)⁻¹J₁*^{T}J₀*\vec{Δ}₀ (15)

As stated in Equation (12), I want to look at

∥J*\vec{Δ}^{†}∥²=\vec{Δ}₀^{T}J₀*^{T}J₀*\vec{Δ}₀+2\vec{Δ}₀^{T}J₀*^{T}J₁*\vec{Δ}₁^{†}+\vec{Δ}₁^{†T}J₁*^{T}J₁*\vec{Δ}₁^{†} (16)

This combines with the previous equation to yield

∥J*\vec{Δ}^{†}∥²=\vec{Δ}₀^{T}[J₀*^{T}(I−J₁*(J₁*^{T}J₁*)⁻¹J₁*^{T})J₀]\vec{Δ}₀ (17)

Thus the Hessian that describes the local absolute confidence of some specific subset of variables \vec{p}₀ is

H^{†}=2J₀*^{T}(I−J₁*(J₁*^{T}J₁*)⁻¹J₁*^{T})J₀* (18)

When we solve Equation (1), we get out \vec{p}* and J*. We can use that to compute H^{†}, find its eigenvalue decomposition and thus infer the confidence in the variables in question. It is an issue that these uncertainty values have limited physical meaning, but “good-enough” levels for these values can be determined empirically.

### C Manpages

C.1 inferconstellation.pl

Ultrasonic calibration for Intersense hardware

### Synopsis

Calibration of 6 emitters connection to Intersense hardware at 10.10.4.152:
inferConstellation.pl 10.10.4.152 6

Calibration reading a previously-gathered data file, instead of talking to the hardware directly:
inferConstellation.pl -cache ultrasonicCalib.latest

Same, but gathering more data to add to data file
inferConstellation.pl -cache ultrasonicCalib.latest -continue 10.10.4.152 6

### Description

This is a routine for calibrating ultrasonic systems based on Intersense hardware. A calibration is obtained by repeatedly placing a calibration object somewhere in the volume covered by the emitters and gathering all the range readings. After every view is gathered, the full calibration problem is solved. The user receives feedback to indicate how good the latest calibration is. This can be used to determine if more data needs to be gathered, and the best location to gather it from.

The calibration routine optimizes the location of all the emitters (3 DOF each), the poses of all the calibration object positions (6 DOF each), the speed of sound and the speed-of-sound variation with height. The full optimization is solved using the first view to define the reference coordinate system. I.e the emitters and the view positions all move in respect to the first view position,

The speed-of-sound parameters are present because the speed of sound is strongly dependent on temperature and temperature is strongly dependent on height. This produces a very noticeable shift in the data, especially when the sonistrips are mounted near the ceiling.

Communicating with Intersense hardware

The only 2 non-option arguments to the tool are the address of the Intersense hardware and the number of emitters we′re talking to. For instance
inferConstellation.pl 10.10.4.152 6
   calibrates 6 emitters connected to the Intersense hardware on IP 10.10.4.152. The Intersense address can be a network address or a file. If it looks like a IP, it is used on port 5005. If there is a ‘:’ in the address, it is used as a network address and a port (machine.local:5005 will connect to machine.local on port 5005 for instance). Otherwise, the address is treated as a simple file. This is useful if we want to connect over a serial connection instead of a network.

### Saving and Refusing Raw Data

Every calibration run saves its raw data into a file on disk, so that the data can be re-analyzed later. This file is timestamped and is name such as ultrasonicCalib_{—}2011_-07_{—}26_{—}18_{—}59_{—}58.cache. For convenience ultrasonicCalib.latest is a link to the latest calibration raw data. To re-analyze a raw data file, use the -cache option such as
inferConstellation.pl -cache ultrasonicCalib.latest

This will analyze the stored data only. If it is desired to gather some real data in addition to the stored raw data, use -continue. For instance
inferConstellation.pl -cache ultrasonicCalib.latest -continue 10.10.4.152 6
   will read in the stored data and then gather more from the Intersense hardware.

### Running a Simulation

For various testing purposes, it is possible to get range data from a simulation instead of from the Intersense hardware or a cache file. When a -simulation flag is passed in this mode is activated. All the geometry and the readings are somewhat randomized. The nominal state has 36 overhead sonistrip-based emitters. There are 16 views in a 4×4 grid. The ambient temperature (and therefore speed of sound) is constant.

### Arguments

--object

This specifies which calibration object is being used. By default the 26 cm object is assumed. The choices are
Square 26 cm-per-microphone-side square object
Wide similar to square, but twice as wide
2wands 2 wands mounted on a firm plate in opposing directions

Newer (after November 2011) cache files stores this value, so the cache file knows which object was used to create it. If reading an older cache file, this option must be given correctly.

--cache file

Loads the raw data from a given file. See §C.1 above

--cull viewindex

If reading a raw data file, specific views can be removed from the data prior to processing by passing in the -cull option. The viewindex is 1-based and multiple -cull options can be given.

--full

When getting raw reading from a data file or when running a simulation, all the data is available immediately; there's no data-gathering step that needs to happen. Thus in those modes the full calibration problem is solved once: using all data. This is in contrast to the case where the data comes from the hardware. In that case the problem is solved after every view so that the user can decide whether more views are necessary. Because of this, solving after every view takes more total computation time, but produces better performance reports. If it is desired to solve the problem after every view, pass in-full.

--continue

By default if we′re reading a raw data file with -cache, this file contains all data that is used. If we want to read the data file and gather some additional data to add, --continue should be passed in.

--vsound0 v0 -vsound1 v1

By default we solve for the optimal speed of sound and the optimal speed-of-sound variation with height. If we want to lock one or both of those down, we can pass in --vsound0 and/or --vsound1. Note that vsound0 is a speed of sound in m/s and vsound1 is a speed-of-sound rate in 1/s. For example, if we want to assume the ambient temperature is 25 degree C. and we gain 1 degree C. per meter we pass in
--vsound0 346.13 -vsound1 −0.606
   These come from the speed of sound page on Wikipedia at http://en.wikipedia.org/wiki/Speed_of_sound. Note that in Intersense's nominal coordinate system gravity is aligned with +z, so “up” is in the −z direction. Thus a negative vsound1 represents rising warmer air.
   --noplots

By defaults multiple plots will be displayed to indicate how well the calibration is going. If no graphical feedback is desired, pass in -noplots.

--sonistrips

If the emitter are mounted inside sonistrips, then we have some information about the “correct” emitter configuration. We can look at how well the computed constellation fits sonistrip, and report that to the user. Pass in -sonistrips, and the sonistrip fit will be plotted along with the other user feedback information. This works for both 2 ft and 3 ft sonistrips.

--simulation

If it is desired to test the algorithm, it's useful to get raw data with a known ground truth. Pass in --simulation to simulate all the ranges instead of obtaining them from the hardware or a cached data file. See §C.1 above for more information.

C.2 validateWands.pl

Validator for ultrasonic wands

### Synopsis

dkogan©fatty:-$ validateWands.pl -c 3 -w 9037 10.10.4.152 5002
Connecting to intersense via a network at 10.10.4.152
Using wand 9037
Sending /tmp/dRJ9u6TJsH, 0 blocks: Give your local XMODEM receive command now.
Xmodem sectors/kbytes sent: 0/0kRetry 0: NAK sector
Brytes Sent: 128 BPS: 5060

Transfer complete
Trying to reconnect . . .
Connecting to intersense via a network at 10.10.4.152
Selecting emitter 5002
Selecting station 1
Wand 9037 done.
Heard from 4 mics
Microphone 1 got 77 ranges
Microphone 1 got mean range of 1.41387111180789 meters
Microphone 1 got range rms of 0.000437512270902768 meters
Microphone 2 got 77 ranges
Microphone 2 got mean ranges of 1.41228418381183 meters
Microphone 2 got range rms of 0.000509024249125174 meters
Microphone 3 got 77 ranges
Microphone 3 got mean range of 1.48668890339988 meters
Microphone 3 got range rms of 0.0004328128104792678 meters
Microphone 4 got 77 ranges
Microphone 4 got mean ranges of 1.48785181014569 meters
Microphone 4 got range rms of 0.00048476345461581 meters

### Description

This tool is used to validate some number of ultrasonic wands before shipping them off to customers. Given a channel, and emitter, and a list of wands, this tool selects the wands one at a time, and reports all the ranges heard from that emitter. If too few or too inconsistent ranges are heard, an error is flagged.

### Arguments

--wand

For each wand that is to be evaluated, a -wand argument is expected. As many of these are necessary can appear on the commandline. Both the full 7-digit ID and a truncated 16-bit ID are acceptable.

--channel

The desired communication channel must be specified with this argument Intersense address

The first non-option argument is the address of the Intersense hardware to communicate with. This Intersense address can be a network address or a file. If it looks like an IP, it is used on port 5005. If there is a “:” in the address, it is used as a network address and a port (machine.local:5005 will connect to machine.local on port 5005 for instance). Otherwise, the address is treated as a simple file. This is useful if we want to connect over a serial connection instead of a network.

### Emitter

The next non-option argument is the emitter ID. This is required. A constellation will be uploaded containing only this emitter.

C.3 readRawIMU.pl

Reads the raw range data from Intersense

### Synopsis

dima©fatty:/tmp$ readRawIMU.pl 10.10.4.152 1
acc: [0.42763409 0.034218357 0.32475013]
gyr: [−0.50289921 0.074502174 −0.71164263] 82.5392998635749 degrees off vertical
acc: [0.041542687 0.0342183587 0.32475013]
gyr: [−0.50411994 0.075722896 −0.71042191] 82.7499758792012 degree off vertical
acc: [0.041542687 0.034218357 0.32719158]
gyr: [−0.50411994 0.075722896 −0.70798047] 82.8029241434113 degree off vertical
acc: [0.42763409 0.034218357 0.32475013]
gyr: [0.50656138 0.074502174 −0.70798047] 82.5392998635749 degrees off vertical
acc: [0.041542687 0.0342183587 0.32597086]
gyr: [−0.50534066 0.074502174 −0.70798047] 82.7765459824167 degree off vertical

[symbol]

### Description

This tool connects to Intersense hardware and reports the raw IMU readings for a given wand. Each reading is reported on 3 lines: the accelerometer vector, the gyroscope vector and a single value that reports the deviation-off-vertical, assuming all measured acceleration comes from gravity.

### Arguments

### Intersense Address

The first non-option argument is the address of the Intersense hardware to communicate with. This Intersense address can be a network address or a file. If it looks like and IP, it is used on port 5005. If there is a “:” in the address it is used as a network address and a port (machine.local:5005 will connect to machine.local on port 5005 for instance). Otherwise, the address is treated as a simple file. This is useful if we want to connect over a serial connection instead of a network.

### Station

The next non-option argument is the station to connect to. This is generally “1” or “2”, depending on whether we want to talk to the first or second wand.

C.4 sendIntersenseFile.pl

Send an arbitrary file to the intersense hardware

### Synopsis

dkogan©fatty:-$ sendIntersenseFile.pl 10.10.4.155 isradio.ini/tmp/isradio.ini
Connecting to intersense via a network at 10.10.4.155
Sending /tmp/KtilPpcIiT, 0 blocks: Give your local XMODEM receive command now.
Xmodem sectors/kbytes sent: 0/0kRetry 0:NAK on sector
Bytes Sent: 128 BPS:5025
Transfer complete

### Description

This tool sends an arbitrary file to the Intersense hardware using the XMODEM-1K protocol. Normally this is only done for uploading the isradio.ini during reprovisioning, but this tool does this generally.

### Arguments

### Intersense Address

The first non-option argument is the address of the Intersense hardware to communicate with. This Intersense address can be a network address or a file. If it looks like and IP, it is used on port 5005. If there is a “:” in the address it is used as a network address and a port (machine.local:5005 will connect to machine.local on port 5005 for instance). Otherwise, the address is treated as a simple file. This is useful if we want to connect over a serial connection instead of a network.

### Remote Filename

The following argument is the name of the file on the Intersense hardware that will be created.

### Input File

The next argument contains the name of the source file to copy. This argument is optional. If it's not given, the file is read from standard input.

C.5 selectEmitter.pl

Selects a specific Intersense emitter

### Synopsis

dima©fatty:/tmp$ selectEmitter.pl 10.10.4.152 5005
selecting emitter 5005

### Description

This tool connects to Intersense hardware and uploads a constellation containing only the emitter requested. This constellation does NOT contain the AK character, so this constellation does not persist.

### Arguments

### Intersense Address

The first non-option argument is the address of the Intersense hardware to communicate with. This Intersense address can be a network address or a file. If it looks like and IP, it is used on port 5005. If there is a “:” in the address it is used as a network address and a port (machine.local:5005 will connect to machine.local on port 5005 for instance). Otherwise, the address is treated as a simple file. This is useful if we want to connect over a serial connection instead of a network.

### Emitter

The next non-option argument is the emitter ID. A constellation will be uploaded containing only this emitter. The emitter must be specified in Intersense style: 5001, 5002, 5003, . . .

C.6 reprovision.pl

Reprovision Wands

### Synopsis

dkogan©fatty:-$ reprovision.pl 10.10.4.155 10083844 13
Connecting to intersense via a network at 10.10.4.155
Sending /tmp/Ic6k32bAh, 0 blocks: Give your local XMODEM receive command now.
Xmodem sectors/kbytes sent: 0/0kRetry 0:NAK on sector
Bytes Sent: 128 BPS:5229
Transfer complete
Trying to reconnect . . .
Connecting to intersense via a network at 10.10.4.155

### Description

This tool connects the given wand to the Intersense hardware on the given channels. One or two wand/channel pairs can be give. This tool uploads the requested configuration, reboots the Intersense hardware and scans all the available radio channels to talk to the wands. THE WANDS MUST BE ON WHEN THIS HAPPENS. When this tools exits, the requested radio link will be established, if this was possible.

### Arguments

### Intersense Address

The first argument is the address of the Intersense hardware to communicate with. This Intersense address can be a network address or a file. If it looks like and IP, it is used on port 5005. If there is a “:” in the address it is used as a network address and a port (machine.local:5005 will connect to machine.local on port 5005 for instance). Otherwise, the address is treated as a simple file. This is useful if we want to connect over a serial connection instead of a network.

### Wand ID/Channel

The following arguments are wand id/channel pairs. The wand ID can be either a full 7-digit ID or a truncared 16-bit one. One or two wands can be configured this way.

C.7 readRawRanges.pl

Reads the raw range data from Intersense

### Synopsis

dima©fatty: /tmp$ readRawRanges.pl 10.10.4.152 1 5005
50054 1.63528001308441
50051 1.79756128787994
50053 1.74342167377472
50052 1.6931391954422
50054 1.63528001308441
50051 1.79728579521179
50053 1.7400837516785
50052 1.69327700138092
50051 1.79769909381866

[symbol]

### Description

This tool connects to Intersense hardware and reports the raw range readings. The data is output in 2 columns. The first is a 5-digit integer: emitter is the first 4 digits, microphone is the last digit. The second column is the range itself. The data is reported as quickly as it comes in. This tool does not process the data at all; it's reported in its rawest available form. Do note that the ranges reported do depend on an estimated speed of sound, since the true raw data is actually a transit time, not a distance. If a full constellation is available to the hardware, it will continually update the speed of sound estimate, which will affect the reported ranges. To disable this speed of sound update, only a single emitter should be specified to the hardware (a constellation with only one emitter). This disables the speed of sound update, reporting ranges as if the ambient temperature was 21.49 degree, which corresponds to a speed of sound of 344.4 m/s.

### Arguments

--stat

This tool takes on optional -stat argument. This turns on reporting of the stat packet. The only interesting bit of information in this packet is the current estimate of ambient temperature. This is reported in a
temp 21.49
   line. As noted above, you want the temperature to be locked at 21.49 degree C., so that the speed of sound used to compute the reported ranges is predictable. This is forced by selecting only 1 emitter.

### Intersense Address

The first non-option argument is the address of the Intersense hardware to communicate with. This Intersense address can be a network address or a file. If it looks like and IP, it is used on port 5005. If there is a “:” in the address it is used as a network address and a port (machine.local:5005 will connect to machine.local on port 5005 for instance). Otherwise, the address is treated as a simple file. This is useful if we want to connect over a serial connection instead of a network.

### Station

The next non-option argument is the station to connect to. This is generally “1” or “2”, depending on whether we want to talk to the first or second wand.

### Emitter

The next non-option argument is the emitter ID. This is optional. If given, a constellation will be uploaded containing only this emitter. This will thus report raw ranges from this emitter only. The emitter must be specified in Intersense style: 5001, 5002, 5003, . . .

C.8 recvIntersenseFile.pl

Receives an arbitrary file from the intersense hardware

### Synopsis

dkogan©fatty:-$ recvIntersenseFile.pl 10.10.4.152 isense.log
Connecting to intersense via a network at 10.10.4.152
rx: ready to receive /tmp/fZyhapMC1P
Bytes received: 1024 BPS:935
Transfer complete
Failed to set memory location at 4 for RFRX1-0
Failed to enable RFRX 1-0 for write
DEVWRN: Cannot move device 1008340—not found
Failed to set memory location at 4 for RFRX1-0
Failed to enable RFRX1-0 for write
DEVWRN: Cannot move device 1008332—not found
Device communication error for MTX1-3

### Description

This tool receives an arbitrary file from the Intersense hardware using the XMODEM-1K protocol. This can be done to retrieve the connection log from the isense.log file, or to read in the current wand-provisioning state from isradio.ini. This tool is general, and any file can be received. The output is sent on standard out.

### Arguments

### Intersense Address

The first argument is the address of the Intersense hardware to communicate with. This Intersense address can be a network address or a file. If it looks like and IP, it is used on port 5005. If there is a “:” in the address it is used as a network address and a port (machine.local:5005 will connect to machine.local on port 5005 for instance). Otherwise, the address is treated as a simple file. This is useful if we want to connect over a serial connection instead of a network.

### Remote Filename

The following arguments is the name of the file on the Intersense hardware that will be read.

C.9 constellation-ToPos.pl
Convert a canonical constellation to a plain XYZ one

### Synopsis

dima©fatty:/tmp$ cat constellation
MCC
MCF1, −1.5240, −0.3048, 0.0000, 0.00, 0.00, 1.00, 5001
MCF2, −1.5240, 0.6096, 0.0000, 0.00, 0.00, 1.00, 5002
MCe
MConfigLockMode0
dima©fatty:/tmp$ cat constellation/constellation-ToPos.pl
−1.524 −0.3048 0
−1.524 0.6096 0

### Description

Converts a canonical Intersense constellation to one represented with plain-text XYZ coordinates. Note that the XYZ representation does not contain the normal vectors, so these are simply discarded. This tool is the reverse of constellation-FromPos.pl. A plain XYZ representation is useful for various visualizations or analyses. For example, to plot a constellation one could do
dima©fatty:/tmp$ cat constellation/constellation-ToPos.pl/
feedgnuplot -lines -points -3d -domain

### Arguments

There are no arguments. The input comes from a file, if given on the command line, or from standard input.

C.10 constellation-compare.pl
Reports how well 2 constellation match each other

### Synopsis

dima©fatty:/tmp$ cat constellation.old
MCC
MCF1 1.5185386, 0.305016, 0, 0, 0, 1, 5001
MCF2, 1.5282615, −0.607511, 0, 0, 0, 1 5002
MCF3, 1.5263856, −1.515853, 0, 0, 0, 1, 5003
MCF4, 0.9149666, −1.514709, 0, 0, 0, −1, 5004
MCF5, 0.9123096, −0.602383, 0, 0, 0, 1, 5005
MCF6, 0.9106346, 0.309171, 0, 0, 0, 1, 5006
MCe
MConfigLockMode0
dima©fatty:/tmp$ cat constellation.new
MCC
MCF1, 2.5358, 0.3166, 0.002, −0.31, −0.17, 0.93, 5001
MCF2, 2.5297, −0.6011, 0.0003, −0.34, −0.05, 0.94, 5002
MCF3, 2.5215, −1.521, −0.0005, −0.35, 0.18, 0.92, 5003
MCF4, 1.9099, −1.5208, 0.0015, −0.08, 0.19, 0.98, 5004
MCF5, 1.9139, −0.6037, −0.0019, −0.17, 0.06, 0.98, 5005
MCF6, 1.9175, 0.3121, −0.0023, −0.03, −0.18, 0.98, 5006
MCe
MConfigLockMode0
dima©fatty:/ tmp$ constellation-compare.pl constellation.old
constellation.new
RMS fit error 0.00848538825075035 m
0.014941953723975
0.00722303680971845
0.00485235765402212
0.00984900803155287
0.00522104071381931
0.00296125659279598

### Description

Given 2 constellations this tool does a yaw-only fit to bring the constellations together, and then analyzes the discrepancies between those two constellations.

Without --plot3d this tool prints out the distance between each pair of emitters. If the constellations were identical to each other up to translation and yaw, the distance would all be 0.

With --plot3d the original and fitted constellations are plotted together. This allows us to see whether general trends match up or not. For instance, if emitters are mounted on a slightly sloped ceiling, this visualization would hopefully show that slope in both constellations.

### Arguments

The input constellations both come from a file given on command line. The only option is --plot3d, which generates a plot of the constellation instead of spitting out the pairwise distances, as described above.

C.11 constellation-MakeNormalsStriaght.Down.pl

Set all normal of a constellation to +z

### Synopsis

dima©fatty:/tmp$ cat constellation
MCC
MCF1, −1.5240, −0.3048, 0.0000, 0.2673, 0.5345, 0.8018, 5001
MCF2, −1.5240, 0.6096, 0.0000, 0.2673, 0.5345, 0.8018, 5002
MCe
MConfigLockMode0
dima©fatty:/tmp$ cat constellation/constellation-MakeNormalsStraightDown.pl
MCC
MCF1, −1.524, −0.3048, 0, 0, 0, 1, 5001
MCF2, −1.524, 0.6096, 0, 0, 0, 1, 5002
MCe
MConfigLockMode0

### Description

Sets all the normal of a given constellation to (0,0,1). This is needed for constellation being passed into ISDEMO for a sonistrip fit report because that tools gets confused otherwise.

### Arguments

There are no arguments. The input comes from a file, if given on the command line, or from standard input.

C.12 constellation-FromPos.pl

Convert a plain XYZ constellation to a canonical one

### Synopsis

dima©fatty:/tmp$ cat constellation.xyz
−1.524 −0.3048 0
−1.524 0.6096 0
dima©fatty:/tmp$ cat constellation.xyz/constellation-FromPos.pl
MCC
MCF1, −1.524, −0.3048, 0, 0, 0, 1, 5001
MCF2, −1.524, 0.6096, 0, 0, 0, 1, 5002
MCe
MConfigLockMode0

### Description

Converts an Intersense constellation represented with a plain-text XYZ coordinated into a canonical form. Note that the XYZ representation does not contain the normal vectors, so this tool hard-codes them to (0, 0, 1). This tool is the reverse of constellation-ToPos.pl

### Arguments

There are no arguments. The input comes from a file, if given on the command line, or from standard input.

C.13 constellation-ToMCF.pl

Convert a canonical constellation to MCF format

### Synopsis

dima©fatty:/ tmp$ cat constellation
MCC
MCF1, −1.5240, −0.3048, 0.0000, 0.00, 0.00, 1.00, 5001
MCF2, −1.5240, 0.6096, 0.0000, 0.00, 0.00, 1.00, 5002
MCe
MConfigLockMode0
dima©fatty:/ tmp$ constellation-ToMCF.pl constellation
31F 1 −1.54 −0.3048 0 0 0 1 5001
31F 2 −1.54 0.6096 0 0 0 1 5002
31F 0 0.0000 0.0000 0.0000 0.00 0.00 0.00 0

### Description

Intersense constellations can be represented in 2 ways: a canonical representation that is used to send constellations to the hardware, and an MCF representation, reported by the hardware in response to the MCF command. This tool converts canonical constellations to MCF ones. This tool is the reverse of
constellation-FromMCF.pl.

### Arguments

There are no arguments. The input comes from a file, if given on the command line, or from standard input.

C.14 constellation-AlignPairToX.pl

Rotates constellation to aim a pair of emitters to +x

### Synopsis

dima©fatty:/ tmp$ cat constellation
MCC
MCF1, 1.5358, 0.3166, 0.002, −0.31, −0.17, 0.93, 5001
MCF2, 1.5297, −0.6011, 0.0003, −0.34, −0.05, 0.94, 5002
MCF3, 1.5215, −1.521, −0.0005, −0.35, 0.18, 0.92, 5003
MCF4, 0.9099, −1.521, −0.0005, −0.08, 0.19, 0.98, 5004
MCF5, 0.9139, −0.6037, −0.0019, −0.17, 0.06, 0.98, 5005
MCF6, 0.9176, 0.3121, −0.0023, −0.03, −0.18, 0.98, 5006
MCF7, 0.2976, 0.3142, −0.0029, −0.09, −0.26, 0.96, 5007
MCF8, 0.3, −0.6041, −0.0008, −0.01, 0.01, 1, 5008
MCF9, 0.3023, −1.5187, 0.0031, −0.12, 0.28, 0.95, 5009
MCF10, −0.3017, −1.5158, 0.0029, 0.05, 0.26, 0.96, 5010
MCF11, −0.3046, −0.5994, 0.0006, −0.07, 0.06, 1, 5011
MCF12, −0.3092, 0.3162, −0.0013, −0.03, −0.25, 0.97, 5012
MCF13, −0.9203, 0.3199, 0.0013, 0.05, −0.25, 0.97, 5013
MCF14, −0.9148, −0.5959, −0.001, 0.1, 0.8, 0.99, 5014
MCF15, −0.9096, −1.5103, −0.0014, 0.14, 0.26, 0.96, 5015
MCF16, −1.5189, −1.5144, −0.0034, 0.22, 0.24, 0.94, 5016
MCF17, −1.5236, −0.5944, −0.0015, 0.23, 0.06, 0.97, 50172
MCe
MConfigLockMode0
dima©fatty:/ tmp$ cat constellation/constellation-AlignPairToX.pl 2 0
MCC
MCF1, 0.328541478048302, −1.53328982818052, 0.002, −0.172407165499956, 0.308667732820051, 0.93, 5001
MCF2, −0.589178204353992, −1.53433123656993, 0.0003, 0.0526442484172549, 0.339600629950816, 0.94, 5002
MCF3, −1.50911416161872, −1.53328982818052, −0.0005, 0.177270971213643, 0.351390100550616, 0.92, 5003
MCF4, −1.51367342714113, −0.92170678958486, 0.0015, 0.189371714965627, 0.0814760920207716, 0.98, 5004
MCF5, −0.59657006804531, −0.918570113770536, −0.0019, 0.0586753022016343, 0.170461752048801, 0.98, 5005
MCF6, 0.319230995915153, −0.915143563189415, −0.0023, 0.180227999659399, 0.0285983939893781, 0.98, 5006
MCF7, 0.316506306973482, −0.295145993782751, −0.0029, −0.26069247668557, 0.0879740450334284, 0.96, 5007
MCF8, −0.601747213204956, −0.304691813805473, −0.0008, 0.00992188068669046, 0.0100775137627829, 1, 5008
MCF9, −1.51630162357562, −0.314108844736869, 0.0031, 0.279057723836073, 0.122175229762134, 0.95, 5009
MCF10, −1.51810183027844, 0.28989543443326, 0.0029, 0.260381210533385, −0.0479752561344817, 0.96, 5010
MCF11, −0.601752143399605, 0.299926454174989, 0.0006, 0.0594534675820965, 0.0704647798014341, 1, 5011
MCF12, 0.313784338889785, 0.31165119712188, −0.0013, 0.250225880232556, 0.0280536782230545, 0.97, 5013
MCF13, 0.312728858222933, 0.922761486644615, 0.0013, 0.249603347928186, −0.051943899574389, 0.97, 5013
MCF14, −0.603000614522527, 0.910135214616737, −0.001, 0.0807757431783557, −0.0993744399429971, 0.99, 5014
MCF15, −1.51733246415267, 0.897819827820928, −0.0014, 0.26092592699708, −0.117973136707638, 0.96, 5015
MCF16, −1.52617370167796, 1.50706947494354, −0.0034, 0.241704697230697, −0.218125742031098, 0.94, 5016
MCF17, −0.60623813077507, 1.51892845413941, −0.0015, 0.0617879637234831, −0.22952613694066, 0.97, 5017
MCF18, 0.310619322618807, 1.52796339498557, 0.0053, −0.228358888869973, −0.211783422094533, 0.95, 5018
MCe
MConfigLockMode0

### Description

Given a constellation and two emitters, rotate-about-yaw the constellation so that the two emitters are aligned with the x-axis as much as possible. The matching vector is from the first given emitter to the second. The emitters can be specified both as 0-based or as the intersense-style 5001, 5002, . . . .

### Arguments

The emitters are the first two arguments. The input constellation comes from a file, if given on the command line, or from a standard input.

C.15 constellation-FromMCF.pl

Convert a canonical constellation to MCF format

### Synopsis

dima@fatty:/tmp$ cat constellation.mcf
31F 1 −1.524 −0.3048 0 0 0 1 5001
31F 2 −1.524 0.6096 0 0 0 1 5002
31F0 0.000 0.000 0 0 0 0 0
dima@fatty:/tmp$ constellation-FromMCF.pl constellation.mcf
MCC
MCF1, −1.524, −0.3048, 0, 0, 0, 1, 5001
MCF2, −1.524, 0.6096, 0, 0, 0, 1, 5002
MCe
MConfigLockMode0

### Description

Intersense constellations can be represented in 2 ways: a canonical representation that is used to send constellations to the hardware, and an MCF representation, reported by the hardware in response to the MCF command. This tool converts MCF constellations to canonical ones. This too is the reverse of the constellation-ToMFC.pl.

### Arguments

There are no arguments. The input comes from a file, if given on the command line, or from standard input.

C.16 constellation-getStripFit.pl

Computes how well a constellation fits sonistrips

### Synopsis

dima@fatty: /tmp$ cat constellation
MCC
MCF1, 1.5358, 0.3166, 0.002, −0.31, −0.17, 0.93, 5001
MCF2, 1.5297, −0.6011, 0.003, −0.34, −0.05, 0.94, 5002
MCF3, 1.5215, −1.521, −0.0005, −0.35, 0.18, 0.92, 5003
MCF4, 0.9099, −1.5208, 0.0015, −0.08, 0.19, 0.98, 5004
MCF5, 0.9139, −0.6037, −0.0019, −0.17, 0.06, 0.98, 5005
MCF6, 0.9176, 0.3121, −0.0023, −0.03, −0.18, 0.98, 5006
MCF7, 0.2976, 0.3142, −0.0029, −0.09, −0.26, 0.96, 5007
MCF8, 0.3, −0.6041, −0.0008, −0.01, 0.01, 1, 5008
MCF9, 0.3023, −1.5187, 0.0031, −0.12, 0.28, 0.95, 5009
MCF10, −0.3017, −1.5158, 0.0029, 0.0029, 0.05, 0.26, 0.96, 5010
MCF11, −0.3046, −0.5994, 0.0006, −0.07, 0.06, 1, 5011
MCF12, −0.3092, 0.3162, −0.0013, −0.03, −0.25, 0.97, 5012
MCF13, −0.9203, 0.3199, 0.0013, 0.05, −0.25, 0.97, 5013
MCF14, −0.9148, −0.5959, −0.001, 0.1, 0.08, 0.99, 5014
MCF15, −0.9096, −1.5103, −0.0014, 0.12, 0.26, 0.96, 5015
MCF16, −1.5189, −1.5144, −0.0034, 0.22, 0.24, 0.94, 5016
MCF17, −1.5236, −0.5944, −0.0015, 0.23, 0.06, 0.97, 5017
MCF18, −1.5255, 0.3225, 0.0053, 0.21, −0.23, 0.95, 5018
MCe
MConfigLockMode0
dima@fatty:/tmp$ cat constellation I constellation-getStripFit.pl
0.00332184783843958
0.00553689457483986
0.00271502550116354
0.00140756166347522
0.00390553738938093
0.000211207016402204
0.00200747487130426
0.00121352654927509
0.00141940359439863
1.48730199001079e-05
0.00561396728527974
0.00252718358657034

### Description

Inferred constellations have errors. If the emitters are all mounted inside sonistrips, we can use this to assess the accuracy of a constellation. This tool reads in a constellation and compares all the consecutive pairwise distances to those that would appear in a sonistrip. The deviation is printed out for each one. This works for both 2 ft and 3 ft sonistrips.

### Arguments

There are no arguments. The input constellation comes from a file, if given on the command line, or from standard input.

C.17 constellation-Shift.pl

Translate a constellation in space

### Synopsis

dima@fatty:/tmp$ cat constellation
MCC
MCF1, −1.5240, −0.3048, 0.0000, 0.00, 0.00, 1.00, 5001
MCF2, −1.5240, 0.6096, 0.0000, 0.00, 0.00, 1.00, 5002
MCe
MConfigLockMode0
dima@fatty:/tmp$ cat constellation|constellation-Shift.pl 1 2 3
MCC
MCF1, −0.524, 1.6952, 3, 0, 0, 1, 5001
MCF2, −0.524, 2.6096, 3.0, 0, 1, 5002
MCe
MConfigLockMode0

### Description

Given a constellation and a translation vector, returns a constellation shifted by the given amount.

### Arguments

The 3D translation vector is given on the command line. The input comes from a file, if given on the command line preceding the vector, or from standard input.

C.18 constellation-AlighTo.pl

Transforms one constellation to match another

### Synopsis

dima@fatty:/tmp$ cat constellation.old
MCC
MCF1, 1.5185386, 0.305016, 0, 0, 0, 1, 5001
MCF2, 1.5282616, −0.607511, 0, 0, 0, 1, 5002
MCF3, 1.5263856, −1.515853, 0, 0, 0, 1, 5003
MCF4, 0.9149666, −1.514709, 0, 0, 0, 1, 5004
MCF5, 0.9123096, −0.602383, 0, 0, 0, 1, 5005
MCF6, 0.9106346, 0.309171, 0, 0, 0, 1, 5006
MCe
MConfigLockMode0
dima@fatty:/tmp$ cat constellation.new
MCC
MCF1, 2.5358, 0.3166, 0.002, −0.31, −0.17, 0.93, 5001
MCF2, 2.5297, −0.6011, 0.0003, −0.34, −0.05, 0.93, 5002
MCF3, 2.5215, −1.521, −0.0005, −0.35, −0.18, 0.92, 5003
MCF4, 1.9099, −1.5208, 0.0015, −0.08, 0.19, 0.98, 5004
MCF5, 1.9139, −0.6037, −0.0019, −0.17, 0.06, 0.98, 5005
MCF6, 1.9176, 0.3121, −0.0023, −0.03, −0.18, 0.98, 5006
MCe
MConfigLockMode0
dima@fatty:/tmp$ constellation-AlignTo.pl --ref constellation.old
constellation.new
RMS fit error: 0.00848538825075035 m
MCC
MCF1, 1.52681690289764, 0.317267905248748, 0.00215, −0.308866936081632, −0.172050038638604, 0.93, 5001
MCF2, 1.52679685685622, −0.600452367818245, 0.00045, −0339661285232887, −0.052251424037472, 0.94, 5002
MCF3, 1.5246914320394, −1.5203865052389, −0.00035, −0.25118430206321, 0.177677762119, 0.92, 5003
MCF4, 0.913103529181518, −1.52423839800464, 0.00165, −0.0812570062454926, 0.18946582545663, 0.98, 5004
MCF5, 0.911027596347123, −0.60713202440185, −0.00175, −0170393772950424, 0.0588724225738946, 0.98, 5005
MCF6, 0.908660282678097, 0308672390211878, −00215, −0.028806830325439, −0.180194801608152, 0.98, 5006
MCe
MConfigLockMode0

### Description

Given a reference constellation and a new constellation, the new one is rigidly transformed (rotation, translation) to fit the reference one as well as possible (in the euclidean 2-norm sense). The rotation component of the transformation is limited to rotations about the z-axis. This is useful if we have a constellation for a particular space, and we want to calibrate again to get a more accurate constellation. If we do this, the second constellation will not necessarily to be located in exactly the same spot as the old one. We use this tool to transform the newly-gathered constellation to the old one. This transformed constellation can then be used directly without needing to re-set-up the screen positions. The z-axis rotation restriction is in place because constellations use the IMU to get a correct orientation, so the rotation ambiguity is yaw-only.

### Arguments

The reference constellation must be passed with in --reference. The input constellation file comes from a file, if given on the command line, or from standard input.

C.19 feedgnuplot

Pipe-oriented frontend to Gnuplot

### Synopsis

Simple plotting of stored data:
$ seq 5|awk {print 2*$1, $1*$1}′
2 1
4 4
6 9
8 16
10 25
$ seq 5|awk ‘{print 2*$1, $1*$1}’|
feedgnuplot -lines -points -legend 0 “data 0”-title “Test plot”-y2 1
   Simple real-time plotting example: plot how much data is received on the wlan0 network interface bytes/second (uses bash, awk and Linux):

$while true; do sleep 1; cat /proc/net/dev; done|
gawk ‘/wlan0// {if(b) {print $2-b; fflush( )}b=$2}’
feedgnuplot -lines -stream -xlen 10 -ylabel ‘Bytes/sec’-xlabel seconds

### Description

This is a flexible, command-line-oriented frontend to Gnuplot. It creates plots from data coming in on STDIN or given in a filename passed on the commandline. Various data representations are supported, as is hardcopy output and streaming display of live data. A simple example:
$ seq 5|awk ‘{print 2*$1, $1*$1}’| feedgnuplot You should see a plot with two curves. The awk command generates some data to plot and the feedgnuplot reads it in from STDIN and generates the plot. The awk innovation is just an example; more interesting things would be plotted in normal usage. No commandline-options are required for the most basic plotting. Input parsing is flexible; every line need not to have the same number of points. New curves will be created as needed.

The most commonly used functionality of gnuplot is supported directly by the script. Anything not directly supported can still be done with the --extracmds and --curvestyle options. Arbitrary gnuplot commands can be passed with --extracmds, For example, to turn off the grid, pass in --extracmds ‘unset grid’. As many of these options as needed can be passed in. To add arbitrary curve styles, use --curvestyle curveID extrastyle. Pass these more than once to affect more than one curve. To apply an extra style to all the curves, pass in --curvestyleall extra style.

### Data Formats

By default, each value present in the incoming data represents a distinct data point, as demonstrated in the original example above (we had 10 numbers in the input and 10 points in the plot). If requested, the script supports more sophisticated interpretation of input data.

### Domain Selection

If --domain is passed in, the first value of each line of input is interpreted as the X-value for the rest of the data on that line. Without --domain the X-value is the line number, and the first value on a line is a plain data point like the others. Default is --nodomain. Thus the original example above produces 2 curves, with 1, 2, 3, 4, 5 as the X-values. If we run the same command with --domain:
$ seq 5|awk ‘{print 2*$1, $1*$1}’| feedgnuplot --domain

### Curve Indexing

By default, each column represents a separate curve. This is fine unless sparse data is to be plotted. With the --dataid option, each point is represented by 2 values: a string identifying the curve, and the value itself. If we added --dataid to the original example:
$ seq 5|awk ‘{print 2*$1, $1*$1}’| feedgnuplot dataid autolegend
   we get 5 different curves with one point in each. The first column, as produced by awk, is a 2, 4, 6, 8, 10. These are interpreted as the IDs of the curves to be plotted. The --autolegend option adds a legend using the given IDs to label the curves. The IDs need not be numbers; generic strings are accepted. As many points as desired can appear on a single line. --domain can be used in conjunction with --dataid.

### Multi-Value Style Support

Depending on how gnuplot is plotting the data, more than one value may be needed to represent a single point. For example, the script has support to plot all the data with -circles. This requires a radius to be specified for each point in addition to the position of the point. Thus when plotting with --circles, 2 numbers are red for each data point instead of 1. A similar situation exsist with --colormap where each point contains the position and the color. There are other gnuplot styles that require more data (such as error bars), but none of these are directly supported by the script. They can still be used, though, by specifying the specific style with --curvestyle, and specifying how many extra values are needed for each point with --extraValuePerPoint extra. --extraValuePerPoint is ONLY needed for the styles not explicitly supported; supported styles set that variable automatically.

### 3D Data

To plot 3D data, pass in --3d. --domain MUST be given when plotting 3D data to avoid domain ambiguity. If 3D data is being plotted, there are by definition 2 domain values instead of one (Z as a function of X and Y instead of Y as a function of X) Thus the first 2 values on each line are interpreted as the domain instead of just 1. The rest of the processing happens the same way as before.

### Special Data Commands

Other than the raw data, 2 special commands are interpreted if they appear in the input. This are replot and clear. If a line of data begins with replot and we're plotting in realtime with -stream, the plot will be refreshed immediately. If a line of data begins with clear, the plot is cleared, to be ref-filled with any data following the clear.

### Real-Time Streaming Data

To plot real-time data, pass in the --stream [refreshperiod] option. Data will then be plotted as it is received. The plot will be updated every refreshperiod seconds=. If the period isn't specified, a 1 Hz refresh rate is used. To refresh at specific intervals indicated by the data, set the refreshperiod to 0 or to ‘trigger’. The plot will then only be refreshed when a data line ‘replot’ is received. This ‘replot’ command works in both triggered and timed modes, but in triggered mode, it's the only way to replot.

To plot only the most recent data (instead of all the data), --xlen windowsize can be given. This will create an constantly-updating, scrolling view of the recent past. windowsize should be replaced by the desired length of the domain window to plot, in domain units (passed-in values if -domain or line numbers otherwise).

### Hardcopy Output

The script is able to produce hardcopy output with -hard copy outputfile. The output type is inferred from the filename with .ps, .eps, .pdf and png currently supported.

### Self-Plotting Data Files

This script can be used to enable self-plotting data files. There are 2 ways doing this: with a shebang (#!) or with inline perl data.

Self-plotting data with a #!

A self-plotting, executable data file data is formatted as
$ cat data
#! /usr/bin/feedgnuplot-lines-points
2 1
4 4
6 9
8 16
10 25
12 36
20 100
22 121
24 144
16 169
28 196
30 225

This is the shebang (#1) line followed by the data, formatted as before. The data file an be plotted simply with
$ ./data

The caveats here are that on Linux the whole #! line is limited to 127 characters and that the full path to feedgnuplot must be given. The 127 character limit is a serious limitation, but this can likely be resolved with a kernel patch. I have only tried on Linux 2.6.

Self-Plotting Data with Perl Inline Data

Perl supports storing data and code in the same file. This can also be used to create self-plotting files:

$ cat plotdata.pl
#! /usr/bin/perl
use strict;
use warnings;
open PLOT, “| feedgnuplot - lines - points” or die “Couldn't open
plotting pipe”;
while ( <DATA> )
{

my @xy = split;
print PLOT “@xy/n”;

}
_ _ DATA_ _{—}
2 1
4 4
6 9
8 16
10 25
12 36
14 49
16 64
18 81
20 100
22 121
24 144
16 169
28 196
30 225

This is especially useful if the logged data is not in a format directly supported by feedgnuplot. Raw data can be stored after the _Data_directive, with a small perl script to manipulate the data into a usable format and send it to the plotter.

### Arguments

--[no] domain If enabled, the first element of each line is the domain variable. If not, the point index is used
--[no] dataid If enabled, each data point is preceded by the ID of the data set that point corresponds to. This ID is interpreted as a string, NOT as just a number. If not enabled, the order of the point is used.

As an example, if line 3 of the input is “0 9 1 20” ‘-nodomain -nodataid’ would parse the 4 numbers as points in 4 different curves at x=3
‘-domain -dataid’ would parse the 4 numbers as points in 3 different curves at x=0. Here, 0 is the x-varaiable and 9, 1, 20 are the data values
‘-nodomain -dataid’ would parse the 4 numbers as points in 2 different curves at x=3. Here 0 and 1 are the data ID's and 9 and 20 are the data values
‘-domain -dataid’ would parse the 4 numbers as a single point at x=0. Here 9 is the data ID and 1 is the data value. 20 is an extra value, so it is ignored. If another value followed 20, we'd get another point in the curve ID 20
--[no] 3d Do [not] plot in 3D. This only makes sense with -domain. Each domain here is an (x, y) tuple
--colormap Show a colormapped xy plot. Requires extra data for the color. zmin/zmax can be used to set the extents of the colors. Automatically increments extraValuesPerPoint
--stream[period] Plot the data as it comes in, in realtime. If period is given, replot every period seconds. If no period is given, replot at 1 Hz. If the period is given as 0 or ‘trigger’, replot ONLY when the incoming data dictates this. See the “Real-time streaming data” section of the man page.
--[no]lines Do [not] draw lines to connect consecutive points
--[no]points Do [not] draw points
--circles Plot with circles. This requires a radius be specified for each point.
Utomactially increments extraValuesPerPoint
--xlabel xxx Set x-axis label
--ylabel xxx Set y-axis label
--y2label xxx Set y2-axis label. Does not apply to 3d plots
--zlabel xxx Set z-axis label. Only applies to 3d plots
--title xxx Set the title of the plot
--legend curveID legend Set the label for a curve plot. Use this option multiple times for multiple curves. With -dataid, curveID is the ID. Otherwise, it's the index of the curve, starting at 0.
--autolegend Use the curve Id's for the legend. Titles given with -legend override these
--xlen xxx When using --stream, sets the size of the x-window to plot. Omit this or set it to 0 to plot ALL the data. Does not make sense with 3d plots. Implies
--monotonic
--xmin xxx Set the range for the x axis. These are ignored in a streaming plot
--xmax xxx Set the range for the x axis. These are ignored in a streaming plot
--ymin xxx Set the range for the y axis.
--ymax xxx Set the range for the y axis.
--y2 min xxx Set the range for the y2 axis. Does not apply to 3d plots.
--y2max xxx Set the range for the y2 axis. Does not apply to 3d plots.
--zmin xxx Set the range for the z axis. Only applies to 3d plots or colormaps.
--zmax xxx Set the range for the z axis. Only applies to 3d plots for colormaps.
--y2 xxx Plot the data specified by this curve ID on the y2 axis. Without -dataid, the ID is just an ordered 0-based index. Does not apply to 3d plots.
--curvestyle curseID style
   Additional styles per curve. With -dataid, curveID is the ID, Otherwise, it's the index of the curve, starting at 0. Use this option multiple times for multiple curves.
--curvestyleall xxx Additional styles for ALL curves.
--extracmds xxx Additional commands. These could contain extra global styles for instance.
--size xxx Gnuplot size option
--square Plot data with aspect ratio 1. For 3D plots, this controls the aspect ratio for all 3 axes
--square_xy For 3D plots, set square aspect ratio for ONLY the x,y axes
--hardcopy xxx If not streaming, output to file specified here. Format inferred from filename
--maxcurves xxx The maximum allowed number of curves. This is 100 by default, but can be reset with this option. This exists purely to prevent perl from allocating all of the system's memory when reading bogus data
--monotonic If -domain is given, checks to make sure that the x-coordinate in the input data is monotonically increasing. If a given x-variable is in the past, all data currently cached for this curve is purged. Without -monotonic, all data is kept. Does not make sense with 3d plots. No -monotonic by default.
--extraValuesPerPoint xxx
   How many extra values are given for each data point. Normally this is 0, and does not need to be specified, but sometimes we want extra data, like for colors or point sizes or error bars, etc. feedgnutplot options that require this (colormap, circles) automactially set it. This option is ONLY needed if unknown styles are used, with -curvestyleall for instance
--dump Instead of printing to gnuplot, print to STDOUT. For debugging

### Acknowledgement

This program is originally based on the driveGnuPlots.pl scripts from Thanassis Tsodras. It is available from his site at http://users.softlab.ece.ntua.gr/˜ttsiod/gnuplotStreaming.html

### Screen Calibration Algorithm

1. Overview

This describes the algorithmic underpinnigs of the screen calibration routine. This routine is given a set of positions and orientations of the wand, as it is pointed at known screen coordinates, while the screen itself is at an unknown locations. The screen is assumed to be oriented along a Cartesian plane, generating 24 different possibilities for the rotation matrix R. I test each of these possibilities individually, so as far as the position optimization is concerned, the orientation is known. The physical dimensions of the screen (resolution, pixel pitch) are also assumed known. It is possible to compute these together with the screen position, but this information is very easy for the user to obtain, thus we require it.

For a view I have a set of wand positions {\vec{p}ᵢ}, wand orientations {\vec{v}ᵢ} and reference screen aim points {\vec{p}_{refi}}. The positions are full 3D vectors; the orientation are 3D unit vectors and the screen aim points are 2D screen coordinates scaled to use the same distance units as the positions. I assume the rotation is known and applied such that the screen normal is \hat{z}. The task is to find a vector \vec{t} that represents the world coordinate of the original pixel of the screen. This position optimization is performed in 2 stages: First I minimize a cost function based on the joint pixel error. This is solved analytically. Then, I use this analytic solution as a seed to an interactive method to minimize a weighted pixel error metric. These two steps are described in the following sections.

2. Unweighted Joint Pixel Error Minimization

For a view i and a hypothesis screen location \vec{t}, I know the screen coordinate of where the user was aiming: \vec{p}_{refi}. I can compute where the user actually did aim in the plane of the screen:

$${\vec{p}}_{i} - \vec{t} + k {\vec{v}}_{i} = ( \begin{matrix}{\vec{s}}_{i} \\ 0\end{matrix} ) \qquad ( 1 )$$

where k is the distance the plane of the screen from the wand along its pointing axis and \vec{s}_{I} is the screen location the user pointed at. From this I can compute.

$$\begin{matrix}k = \frac{{\vec{t}}_{z} - {\vec{p}}_{zi}}{{\vec{v}}_{zi}} \\ and & ( 2 ) \\ \begin{matrix}{\vec{s}}_{i} = {\vec{p}}_{xyi} - {\vec{t}}_{xy} + k {\vec{v}}_{xyi} \\ = {\vec{p}}_{xyi} - {\vec{t}}_{xy} + \frac{{\vec{t}}_{z} - {\vec{p}}_{zi}}{{\vec{v}}_{zi}} {\vec{v}}_{xyi} \\ = {\vec{p}}_{xyi} - {\vec{t}}_{xy} + ( {\vec{t}}_{z} - {\vec{p}}_{zi} ) {\vec{q}}_{i}\end{matrix} & ( 3 )\end{matrix}$$

where

$${\vec{q}}_{i} ≡ \frac{{\vec{v}}_{xyi}}{{\vec{v}}_{zi}} .$$

We can thus define our join error function as

$$E ≡ {\sum }_{i} {‖ {\vec{s}}_{i} - {\vec{p}}_{refi} ‖}^{2} \qquad ( 4 )$$

Let's minimize this error function:

$$\frac{\partial E}{\partial \vec{t}} = 2 {\sum }_{i} {( {\vec{s}}_{i} - {\vec{p}}_{refi} )}^{T} \frac{\partial {\vec{s}}_{i}}{\partial \vec{t}} = 2 {\sum }_{i} {( {\vec{s}}_{i} - {\vec{p}}_{refi} )}^{T} ( - {I}_{2} {\vec{q}}_{i} ) \qquad ( 5 )$$

At the optimum,

$$\frac{\partial E}{\partial \vec{t}} = 0 ,$$

so

$$\begin{matrix}{\sum }_{i} ( {\vec{s}}_{i}^{*} - {\vec{p}}_{refi} ) = 0 \\ and & ( 6 ) \\ {\sum }_{i} {( {\vec{s}}_{i}^{*} - {\vec{p}}_{refi} )}^{T} {\vec{q}}_{i} = 0 & ( 7 )\end{matrix}$$

This simplifies to

$$( \begin{matrix}- N & 0 & \\ 0 & - N & \\ {\sum }_{i} {\vec{q}}_{i}^{T} & & - {\sum }_{i} {‖ {\vec{q}}_{i} ‖}^{2}\end{matrix} ) {\vec{t}}^{*} = ( \begin{matrix}\vec{A} \\ - b\end{matrix} ) \qquad ( 8 )$$

Where N is the count of views that we have and

$$\begin{matrix}\vec{A} ≡ {\sum }_{i} ( {\vec{p}}_{refi} - {\vec{p}}_{xyi} + {\vec{p}}_{zi} {\vec{q}}_{i} ) \\ and & ( 9 ) \\ b ≡ {\sum }_{i} {( {\vec{p}}_{refi} - {\vec{p}}_{xyi} + {\vec{p}}_{zi} {\vec{q}}_{i} )}^{T} {\vec{q}}_{i} & ( 10 )\end{matrix}$$

Thus solving for the optimal screen offset \vec{t}* involves simply solving the linear Equation (8)

3. Weighted Join Pixel Error Minimization

We just derived an analytic solution for the screen location by minimizing the join pixel error metric in Equation (4). This metric has the undesirable property of weighting data gathered far from the screen more than data gathered nearer the screen. In reality the user is able to point far more accurately from a short distance, so this is the opposite of what is desired.

One way to resolve this is to minimize the join pointing angle error instead of the pixel error. The downside of that method is that there exists a singularity if the wand location \vec{p}ᵢ is in the plane of the screen. I resolve these two issues by minimizing a weighted pixel error cost function:

$$E ≡ {\sum }_{i} \frac{1}{{k}^{2} + ε} {‖ {\vec{s}}_{i} - {\vec{p}}_{refi} ‖}^{2} \qquad ( 11 )$$

where k is the distance to this screen, defined in Equation (2) and ε is a predefined constant set to the square of the smallest distance-to-the-screen we want to allow. The k² term of the weighing removes the undesired bias and the ε term resolves the singularity. This cost function can not be minimized analytically, so I employ an L-BFGS routine to find the optimum. I seed this numeral optimizer with the result computed in the previous section. The optimization normally converges in fewer than 10 steps.

4. Manpages

4.1 calibrateScreen.pl
Oblong's screen layout calibration routine

### Synopsis

Calibrate a single screen “center” using wand 1008437, taking to Intersense hardware directly, inferring screen parameters from X:
calibrateScreen.pl -- name center --only 1008437 10.10.4.152:5005
   Similar, but communicating via a wand pools:
calibrateScreen.pl -- name center --only 1008437 --wandreader tcp://bs2/wands
   Doing 3 screens, specifying screen parameters:
calibrateScreen.pl -- name left -- name center -- name right -only 1008437 --pitch 1964 --resolution full 1920x1080 10.10.4.152:5005

### Description

This is a routine to automate and simplify the set-up of screens for the use with Oblong's Software. This routine asks the user to point at each of the 4 screens corners in order. These pointing motions are used to compute the position and orientation of each screen in space. As many views as desired can be gathered.

The screen rotation is assumed to be aligned with the global coordinate system. This allows 24 different choices for screen orientation. The screen can be oriented horizontally or vertically, facing +-x, +-y or +-z. The screen can not be tilted or skewed in any way.

The output of this routine is the screen. Protein and fed.protein files. These files are generated but not installed; the user must copy these files to the appropriate location.

Communicating with Intersense Hardware

It is possible to talk to the Intersense hardware directly (via isense-readData internally) or though a wands pool (via peek internally). By default all incoming data is used. It is often desirable to restrict the data to only a single wand. This can be done with the -only option, such as
--only 1008437

### Direct Communication

If --wandreader is not given on the commandline, direct communication is selected. The target Intersense hardware is specificed as in isense-readData; the usual form is
IP:port
   where IP is a numerical IPv4 address such as 10.10.4.152 and port is almost always 5005

### Pool Communication

If a wandreader is already running, it is serving wand tracking data in the wands pool. To communicate through this pool, pass in --wandreader and the full pool address, such as tcp://bs2/wands). The pool address is passed to the peek command, so should be understandable by it.

### Specifying Screen Parameters

When calibrating screens, the routine must know how many screens are being calibrated, what their names are (how the screens are referred to in the output proteins), their resolution and their physical pixel pitch. For each screen being calibrated, its name must be given on the commandline using the --name parameter; thus at least one --name must be given.

Multiple screens are assumed to be parts of one large virtual screen (such is the case the Triple-head-to-go device). These screens must be named on the commandline in order from left to right, from the perspective of the Triple-head-to-go. Currently it is required that all screens have the same resolution, pitch and orientation. This does not mean that all the screens should lie in a common plane; just a common orientation is required.

If not given on the commandline, the screen resolution and pitch are inferred by querying X (make sure the DISPLAY environment variable is set to the correct X server). This works often, but failures are common, so make sure to check that the queries values are correct: they are one of the first things printed out on the console. The screen resolution is given on the commandline, as the resolution of the full virtual screen. For instance if there are 3 1920×1080 screens in a triple-head-to-go, pass in.
--resolutionfull 5760×1080

The pixel pitch represents the physical size of each screen pixel. It is given as a single value in pixels permeter. This implies that square pixels are assumed. For example, if a 1920×1080 screen is 0.5 meters high, give
--pitch 2160.0

### Gathering Data

As the program runs, it displays realtime values of TQ and CI, as well as indicating the screen corner that the user should aim at. This indication is achieved with a red button at the corresponding corner of the GUI window. Note that the target aim points are always at the screen corners, not at the indicator button itself. To gather a data point, aim at the screen corner, and press a button on the wand. Presses are shorter than 100 ms in duration are ignored. A TQ value of at least 80% is required for a press to be registered; this is indicated with the corner indicator button being grayed out.

The screen positions are computing after each new data point is gathered, if more than 3 exist. The most recent solution is displayed to the user with motion of the curser on the screen. Thus it is possible to evaluate the current solution as data is gathered, and to gather more data if desired.

There are no “undo” feature: if an erroneous button-press occurs, it is necessary to exit the program and start over.

To exit the program without saving, press escape. To accept the current solutions, press and hold a wand button for at least 1 second. This writes out the resulting proteins and exits.

### Saving and Reusing Data

As with the ultrasonic calibration routine, raw data is saved into cache files. These can be processed after the fact using the --cache commandline option. This exists mostly to aid in debugging and development, so end-users shouldn't need to use this feature. In addition to the raw data, it is possible to read in and evaluate the algorithm solution using the --show_t and --show_r options. As with the --cache these aren't meant for end users.

### Arguments

--wandreader Specifies that we are communicating with the Intersense hardware by peeking in given pool. If not given, direct communication is assumed. See section §4.1.
--only wandid Specifies which wand is being used to calibrate the screens. This isn't necessary if there is only one wand connected to the Intersense hardware, but it is almost always required for stock Oblong setups See section §4.1.
--name screen_name Specifies the name for a particular screen. This must be passed in for each screen being calibrated. If calibrating screens that are part of a virtual display, these must be given in order from left to right, from the perspective of the X server. See section §4.1.
--resolution full W×H Specifies the pixel resolution of the full screen being calibrated. If a virtual display (composed of multiple physical screens) is being calibrated, the full display resolution should be given here. See section §4.1.
--pitch r Specifies the pixel pitch of the screen being calibrated. It is assumed that this pitch applies to all screens being calibrated. Furthermore, this pitch applies to both axes, so square pixel are assumed. This value is given in pixels per meter. See section §4.1
--cache store.cache Used to read in stored raw data from a cache file. The data is then used to solve the main screen calibration problem, reporting the results to the console. Used primarily for debugging. See section §4.1
--show_t x y z Used to evaluate the given screen origin position by visualizing the cursor based on this offset. Must be given together with --show_r. Current values for --show_t and --show_r are output to the console after each successful solution computation. Used primarily for debugging. See section §4.1
--show_r index Used to evaluate the given screen origin position by visualizing the cursor based on this rotation. Must be given together with --show_t. Current values for --show_t and --show_r are output to the console after each successful solution computation. Used primarily for debugging. See section §4.1

### Calibration Procedure for an Emitter Geometry of a Tracking Space

This disclosure describes a calibration procedure to determine and modify the emitter geometry of a tracking space comprising a Spatial Operating Environment (SOE).

1. Background

1.1 An Ultrasonic Tracking System

The calibration procedure determines a model of the 3D geometry of descriptors and emitters comprising a tracking system. FIG. 1. Depicts an embodiment of a Spatial Operating Environment (SOE, discussed in 1.1) of ultrasonic operation comprising descriptors, also referred to as microphones, and emitters, also referred to as the constellation. Ultrasonic emitters are mounted around the tracking space.

When the tracking system takes a measurement, it simultaneously fires an ultrasonic emitter and sends a radio signal to a multi-modal input device (MMID). The MMID, also referred to as a “wand,” contains ultrasonic microphones. At some time later, the wand receives the ultrasonic pulse, measures the time-of-flight, generates IMU readings, and sends these data to the base receiver.

The tracking system assumes perfect knowledge of the 3D geometry o the microphone positions and of the emitters positions. The tracking system contains a Kalman filter, which fuses these geometries, the IMU readings, and the times-of-flight into the pose of an MMID in the tracking space.

1.2 An SOE

Such spatial relationships within a tracking system characterize the SOE. A Spatial Operating Environment is a computational entity that enacts real-world, 3D geometries across its comprising physical and virtual spaces. By describing the location of any object in its space (whether virtual, like a pixel on a monitor; or physical, like the monitor itself) with x-y-z coordinate data; the SOE expands human-computer interactions beyond the traditional WIMP UI.

U.S. patent application Ser. No. 12/773,605 describes components of the SOE to include at least a gestural input/output; a networked-based data representation, transit, and interchange; and a spatially conformed display mesh. These create environment characterized by high-bandwidth, data-flexible input/output.

The result is a workspace where operations are controlled across multiple screens, devices, and users. SOE capabilities include robust gestural control, where users manipulate the system with hands and fingers and with physical input devices.

This is more robust input/output relies on an understanding of the spatial relationships of an SOE, which is provided by the routine of this disclosure. US Patent Applications have described embodiments of an SOE not limited to magnetic field tracking, optical tracking, optical tracking in conjunction with EMF tracking and inertial tracking that includes infrared light sources.

2.0 Context of Emitter Geometry Calibration Procedure

As a condition of its operation, the SOE notes the 3D geometry of the microphones and the emitters in mm-order accuracy. Because the microphone geometry is set at time of manufacture of the tracking object, it can be controlled and determined very precisely. While the constellation geometry similarly may be established, by precisely measuring the tracking space itself. However, the tracking space of an SOE is not constant. Implementation

Measuring each space complicates set-up, requiring more time and effort for ultrasonic operation. In one typical scenario, a person uses . . . MORE INFO HERE.

The invention described below addresses the inadequacies and inefficiencies of traditional calibration. The procedure of this disclosure streamlines the ultrasonic installation process. It bot hallows emitters to be installed haphazardly and then quickly measures their positions after the fact, using the same equipment deployed in ultrasonic tracking.

3.0 Components of a Tracking System

3.1. Hardware of a Tracking System

One embodiment of an SOE of an ultrasonic tracking system is depicted in FIG. 1. The wands have a radio link to the tracking system via an “RF receiver” component. When tracking, each receiver user a single RF channel. One configuration uses one MMID per RF receiver and RF channel. (so a 2-MMID system utilizes two recievers on two different channels). In another embodiment pairs of wands share an RF channel and thus two wands may operate per RF receiver and RF channel.

In one such embodiment Intersense emitters connect via proprietary RJ50 connector. The RF receivers can use this same RJ40 connector, but may also use a different RJ11 connector. The “tracker interface” component of FIG. 1 is a board that interfaces the RJ50 and/or RJ11 connectors to a computer via either PCI or USB. One embodiment uses an interface of two types. One type is a PCI card from Intersense. This contains both RJ40 and RJ11 ports. It is provided as a standalone, or as part of SimTracker. In the package “SimTracker,” Intersense bundles the PCI card with tracker software (see 3.2) in a single rack-mounted computer.

The second interfact type is a USB card custom built. This contains 3 RJ50 ports.

3.2 Software Variations of a Tracking System

An ultrasonic tracking system enables spatial input for concurrent users at one location. This document describes a tracking system using Intersense hardware.

First, below is ARCHITECTURE of Tracking System. The below walks through an Intersense tracking system and its data flow. It's taken from Kagan, “Ultrasonic Operation and Calibration”. Please see FIG. 1. Of that document (emailed with this doc, Att. 2). More on Intersense components in next section. Very broadly put, in FIG. 1, everything above (and not including) the box “client software” is Intersense.

Tracking system takes measurement: Simultaneously fires an ultrasonic emitter & RF receiver sends a radio signal to wand that contains ultrasonic microphones. Emitter, RF base receiver, ultrasonic microphones are Intersense components

At some later time: Wand receives ultrasonic pulse; Wand measures time-of-flight & generates other readings; Wand sends back to RF base receiver (Intersense).

Interface Hub: RF receiver connects to tracker interface; Tracker interface is board that interfaces connectors to computer via PCI or USB (Mezz 1.0 only PCI (Intersense) USB Oblong component); Either PCI or USB can communicate with Intrackx (Below).

Pose of Wand Established

Tracking system (via Kalman filter) fuses measurements & geometries into pose of wand in tracking space. Intrackx-tracker software from Intersense. Binary executable: Communicates with all external devices; Give clients access to tracking data; can be configured to communicate w/ either PCI or USB.

### Tracking Hardware of Mezzanine

A tracking system, which enables spatial input for concurrent users at one location, is part of the Oblong product Mezzanine. A new kind of collaborative tool, Mezz is a shared workspace across multiple screens, multiple users, multiple devices. This section explains how tracking hardware changes across Mezz versions.

Sources.

Generally, tracking hardware components are sourced from Oblong, internally developed or Intersense, a provider of tracking technology.

Mezz Version.

Please see att 6. One factor in tracking hardware is the Mezzanine version. In particular, the tracker interface changed between versions. Mezz 1.0 is only deployed with the SimTracker solution noted above.

Components.

Att 7 depicts a Mezz Tracking system, and also, sources components. Intersense components include: Intersense emitter; Intersense base receiver (Intersense RS-422 driver & InterSense RF board); OBL wand incl. InterSense uTrax 4-mic/inertial board (Including 2-mic daughtercard); OBL server incl. Intersense PCI card with both RJ50 and RJ11 ports; OBL server incl. Intersense SimTracker (PCI card+tracker software intrackx)−SimTracker is in box. Oblong components include: OBL emitter pods; OBL Mezz Server; OBL interfact hub, in USB card built by OBL with 3 RJ50 ports; OBL wand design, incl. Power board, LED board, Mounting boards, 1-6 light pipes, Buttons & button covers, Mic mounting grommets, Case fasteners, Battery and contracts, and Housing components.

What are the components of the Mezzanine tracking system?

### From Hardware Team

The Tracking system for Mezzanine enables spatial input for two concurrent users at one location.

The tracking system typically includes 2 wands, 2 base receivers, 1 USB interact hub, 16-36 emitter pods and various lengths of 10p10c serial cable. Accessories typically included are 2 wand chargers and 1 wand carrying case. Optimal accessories are: Display-mounted transducer holders, 1 spare wand, 1 spare charger, 1 calibration kit, 1 receiver plate, 2 display alignment brackets and Wand repair tools.

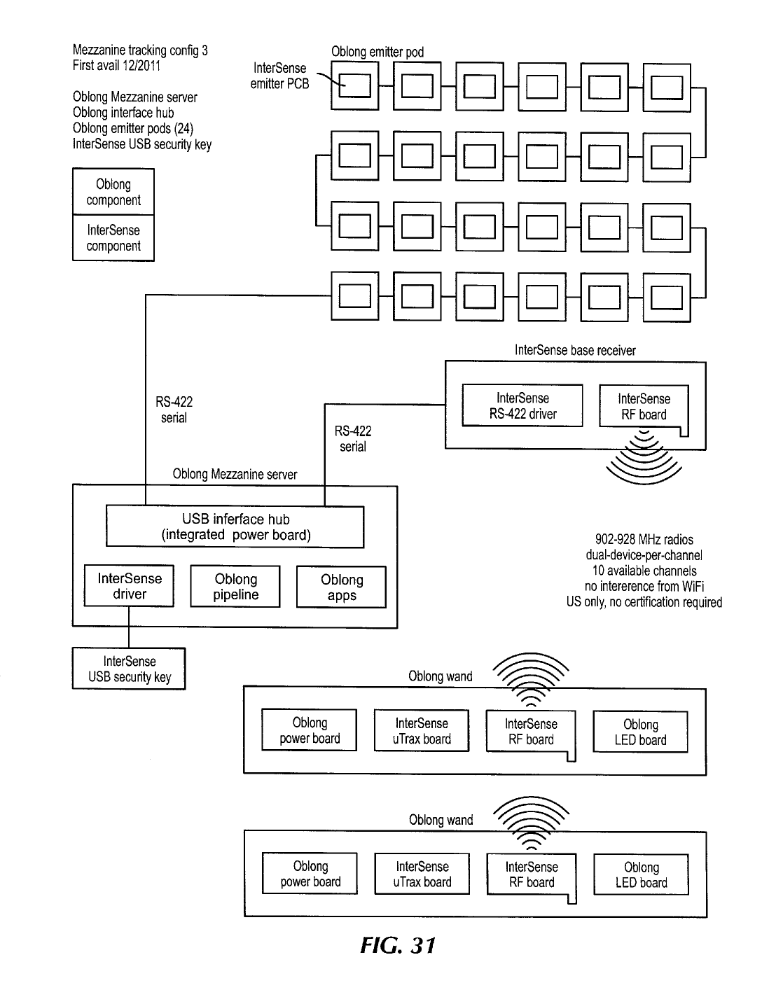

FIG. 31 is a diagram of the mezzanine tracking system components, under an embodiment.

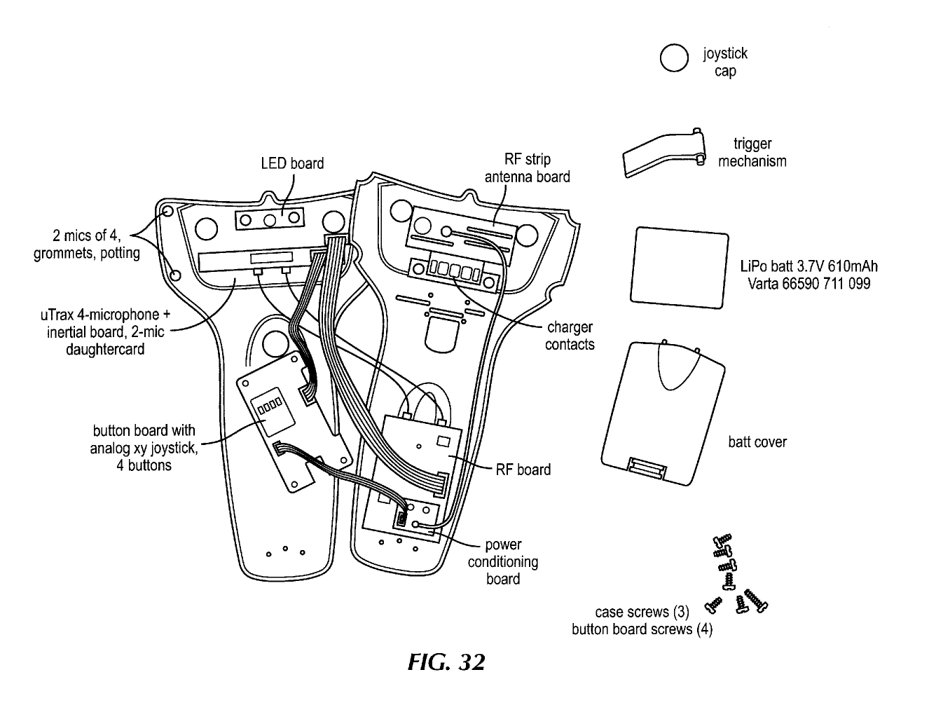

FIG. 32 is a block diagram of the MMID device, under an embodiment.

FIGS. 33A, 33B, 33C, 33D and 33E are a block diagram of the ultrasonic wand tracking system calibration rig, under an embodiment.

Calibration algorithms dataflow

### Table of Contents

1. Software components
1.1 libdogleg
1.2 CHOLMOD
1.3 L-BFGS
1.4 Ocula

2. Calibration types
2.1 Ultrasonic calibration
2.2 Optical calibration
2.3 Tag calibration
2.4 Screen calibration
   1. Software components
   1.1 libdogleg

Library lives at https://github.com/dkogan/libdogleg. Solves very large nonlinear least squares problems. Uses sparse linear algebra in its core (using CHOLMOD). The overall method is Powell's dogleg steps. I believe originally described in
M. Powell. A Hybrid Method for Nonlinear Equations. P. Rabinowitz, editor, Numeraical Methods for Nonlinear Algebraic Equations, pages 87-144. Gordon and Breach Science, London, 1970.
   but maybe even earlier. I wrote this library, but to be clear, I didn't invent anything here. It's an implementation of a known method using a pre-made matrix solver.

### 1.2 CHOLMOD

Library lives at http://www.cise.ufl.edu/research/sparse/cholmod/. This library solves elementary linear equations such at Ax=b where A is a symmetric real matrix, b is a known vector, and x the unknown vector that's being computed. CHOLMOD works with very large, sparse A. I did not write this library.

### 1.3 L-BFGS

Library described at http://en.wikipedia.org/wiki/LBFGS. This is general-purpose non-linear optimization.

### 1.4 Ocula

This is Ambrus's single-view tracking component, the subject of the previous patent filing. More specifically, Ambrus's work consist of two pieces: 1) Ocula is given an image of bunch of stuff, among which is a DLT (2 parallel 4-point-colinear tags) Ocula is able to find the DLT, and pick it out from the rest of the stuff in the image; and 2) Cortex takes in the Ocula results from multiple cameras and a camera calibration to produce a 6D pose (position, orientation) of the DLT in 3-space. I only use Ocula.

2. Calibration types

### 2.1 Ultrasonic Calibration

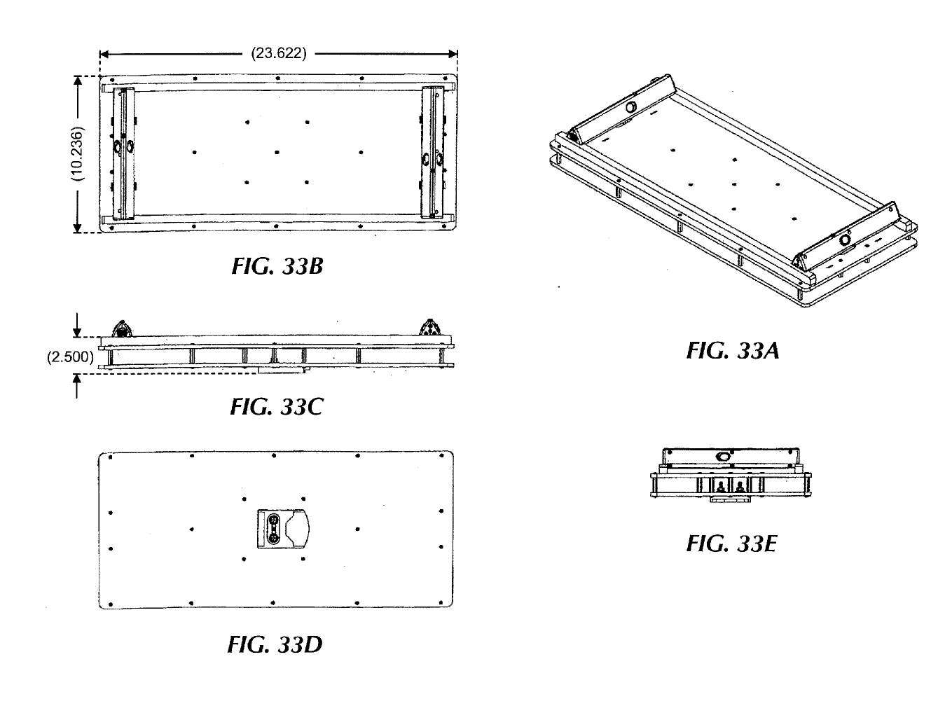

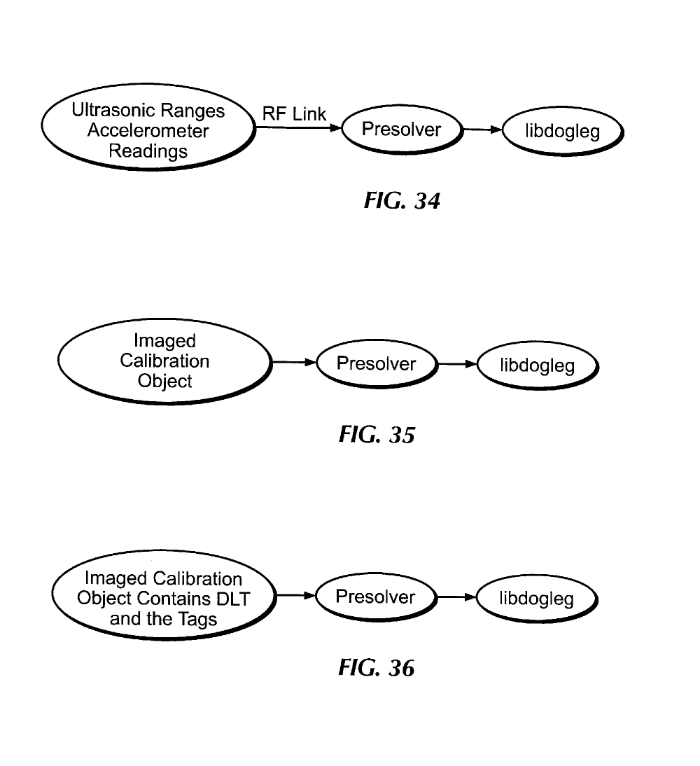

FIG. 34 shows the flow of information. This routine uses the raw readings of the accelerometer and the ultrasonic ranges to compute the positions of the emitters. The geometry of the calibration object is assumed known.

libdogleg is the library described above. The presolver filters the data to ensure consistency. It then runs an initial solve stage to compute rough estimates of the final solution. The results of this initial solve are refined by libdogleg to produce a final, accurate solution. If there's proprietary “secret sauce” anywhere, it's in this stage. Some pieces of it use L-BFGS currently. It's all fairly straightforward, through. The documentation you already have describes it all in some detail.

### 2.2 Optical Calibration

FIG. 35 shows the flow of information. This is the calibration for the classical gloved systems. This routine uses the 2D images of views of the calibration object to compute the positions, orientations and internal characteristics of the cameras. The geometry of the calibration object is assumed known. The general procedure is very similar to the Ultrasonic calibration.

Same general idea as before. The presolver here finds the calibration object in all the views. Then it computes initial estimates of the full solution. This is done with pieces of OpenCV (http://www.opencv.org). L-BFGS, and some of my own stuff again. Once again, this piece is probably the most novel, but even so, anybody “skilled in the art” should be able to come up with it. Or they aren't skilled.

### 2.3 Tag Calibration

FIG. 36 shoes information flow. Broadly, this is very similar to the optical calibration.

The differences from the Optical calibration method are as follows. Calibration object contains a DLT, so I use Ocula to find the DLT to make the Presolver's job a lot easier. I use only a single camera, so there's a lot less data to solve for. This makes the solvers much simpler. Optical calibration assumes perfect knowledge of the calibration object; it solves for the poses of the calibration object, poeses of the cameras, camera characteristic. Here I assume that I do not have perfect knowledge of the calibration object. Libdogleg is thus allowed to move around the dots in the calibration object. The final positions of the dots represent the true tag geometry. This can be compared with the tag database to see how well those match (i.e. what the manufacturing error is). This routine if more sensitive to errors, so it has a fancier verification step (uncertainty computation) after the solve is complete. It does the Schur-complement-based uncertainty computation, like the Ultrasonic calibration. Described in the “Uncertainty analysis” section of the ultrasonic calibration manual.

### 2.4 Screen Calibration

This routine works with a calibrated tracking system (optical or ultrasonic). The user points to the corners of the screen several times, and the routine computes the positions, orientations of the screen in the tracking space. At the core or this nonlinear optimization. I can use libdogleg, but it's so small and simple that L-BFGS is just fine. I have two different representations of the problem. The first makes some assumptions, but is simple enough to have an analytic solution (don't need a solver at all; can derive an equation that computes the answer directly). The second problem representation is more accurate, but has no analytic solution. I solve this second problem with L-BFGS, given it the results from the first representation as an initial estimate.

### Calibration Routine for a Display Given Position and Orientation Information of Related Input Devices

Described in the following disclosure, the calibration routine calculates the position and the orientation of one of any screen given location of one of any input device. The screen(s) and devices(s) function in a space comprising the Spatial Operating Environment, where xyz coordinate data describe all objects within the system. In a representative device example, a multi-modal input device (MMID), which communicates with the system in methods not limited to ultrasonic and optical, generates 3D information on its position and orientation. In contrast, a screen does not know its location. When a MMID, also referred as a “Wand”, is pointed at a screen, the routine is provided full 3D vectors for both position and orientation of the device, as well as 2D screen coordinates. The routine assuming a known rotation of the screen, the invention described here finds a vector that represents the global coordinate of the origin pixel of the screen. The position optimization is performed in two stages: Minimization of costs function based on join pixel error, comprising an analytic solution, and this analytic solution seeding an interactive method, for minimization of a weighted pixel error metric.

The invention, referred as “screen calibration routine” and “routine,” is described below in the following sections: background, including Context of an SOE & Context of calibration routine, and etc.

### 1. Background

1.1 Context of an SOE

The screen calibration routine establishes a model of the spatial relationships between objects. These relationships characterize the SOE, where operations are controlled across multiple screens, devices, and users. While similar to an operation system in that it is a complete application and development platform, the SOE extends beyond traditional computational systems in its design, architecture, and function.

As described in patent and patent applications noted below, all of which are incorporated herein by reference, an SOE enacts real-world geometries across its comprising physical and virtual spaces. U.S. patent application Ser. No. 12/773,605 describes components of the SOE to include at least a gestural input/output; a networked-based data representation, transit, and interchange; and a spatially conformed display mesh.

Fundamentally, the SOE realizes itself as a 3D space. Objects, even virtual ones like pixels, have a location in physical space. By using xyz coordinate data to locate all its elements, the system also characterizes the relationship between objects in a rich, “real-world” geometry. Both input and output expressed more fully, the system supports a more dynamic interaction. SOE capabilities include robust gestural control, where users manipulate the system with body parts not limited to hands and fingers and with physical input devices.

### 2. Background of Calibration Routine

Traditional systems have restricted users to low-level computational input and output. Even users frustrated with such limitations benefits at least from simple and quick installation of peripherals. For example, a user easily connects an external monitor to a computer to begin work.

To supplant old modes of input/output with high-bandwidth interaction, the SOE locates its objects within a global coordinate system. Of particular relevance here, the system operates knowing the position and orientation of each screen in space.

This disclosure describes a calibration routine that automates and simplifies this screen setup. The routine asks users to point an input device such as a MMID at each of the four screen corners in order. These pointing motions are used to compute the position and orientation of each screen in space. As many views as desired can be gathered.

2.1 Overview of Hardware Used in SOE

This calibration routine refers to use of a MMID, or wand. U.S. patent application Ser. No. 12/789,129; and '302 describe various embodiments of an MMID not limited to magnetic field tracking, optical tracking, optical tracking in conjunction with EMF-tracking, and inertial tracking that includes infrared light sources.

Include particular figures from wand application?
Include language regarding Intersense and custom hardware?

The MMID of an embodiment comprises a tracking mechanism such as the Intersense IS 900. The MMID of an alternative embodiment comprises tracking mechanism such as a custom-build USB board.

### Name

Libdogleg—A general purpose sparse optimizer to solve data fitting problems, such as sparse bundle adjustment.

### Description

This is a library for solving large-scale nonlinear optimization problems. By employing sparse linear algebra, it is tailored for problems that have weak coupling between the optimization variables. For appropriately sparse problems this results in massive performance gains.

The main task of this library is to find the vector p that minimizes
norm2 (x)
   where x=f(p) is a vector that has higher dimensionally than p. the user passes in a callback function (of type dogleg_callback_t) that takes in the vector p and returns the vector x and a matrix of derivatives J=df/dp. J is a matrix with a row for each element off and a column for each element of p. J is a sparse matrix, which result in substaintial increases in computational efficiency if most entries of J are 0. J is stored row-first in the callback routine. Libdogleg uses a column-first data representation so it references the transpose of J (called Jt) J store row-first is identical to Jt stored colum-first; this is purely a naming choice.

This library implements Powell's dog-leg algorithm to solve the problem. Like the more-widely-known Levenberg-Marquardt algorithm, Powell's dog-leg algorithm solves a nonlinear optimization problem by interpolating between Gauss-Newton setup and a gradient descent step. Improvements over LM are a more natural representation of the linearity of the operating point (trust region size vs a vague lambda term) and significant efficiency gains, since a matrix inversion isn't needed to retry a rejected step.

The algorithm is described in many places, originally in
M. Powell. A Hybrid Method for Nonlinear Equations. In P.Rabinowitz, editor, Numerical Methods for Nonlinear Algebraic Equations, pages 87-144. Gordon and Breach Science, London, 1970.

Various enhancements to Powell's original method are described in the literature; at this time only the original algorithm is implemented here.

The sparse matrix algebra is handled by the CHOLMOD library, written by Tim Davis. Parts of CHOLMOD are licensed under the GPL and parts under the LGPL. Only the LGPL pieces are used here, allowing libdogleg to be licensed under the LGPL as well. Due to this I lose some convenience (all simple sparse matrix arithmetic in CHOLMOD is GPL-ed) and some performance (the fancier computation methods, such as supernodal analysis are GPL-ed). For my current applications the performance losses are minor.

### Functions and Types

### Main API

### Dogleg_Optimize

This is the main call to the library. It's declared as
double dogleg_optimize (double* p, unsigned int Nstate, unsigned int Nmeas, unsigned int NJnz, dogleg_callback_t* f, void* cookie, dogleg_solverContext_t** returnContext);
P is the inimical estimate of the state vector (and holds the final result)
Nstate specifies the number of optimation variables (elements of p)
Nmeas specifies the number of measurements (elements of x). Nmeas >=Nstate is a requirement
NJnnz specifies the number of non-zero elements of the jacobian matrix df/dp. In a dense matrix Jnnz=Nstate*Nmeas. We are dealing with sparse jacobians, so NJnnz should be far less. If not, libdogleg is not an appropriate routine to solve this problem.
F specifies the callback function that the optimization routine calls to sample the problem being solved
Cookie is an arbitrary data pointer passed untouched to f
If not NULL, returnContext can be used to retrieve the full context structure from the solver. This can be used since this structure contains the latest operating point values. It also has an active colmod_common structure, which can be reused if more CHOLMOD routines need to be called externally. If this data is requested, the user is required to free it with dogleg_freeContext when done.
   dogleg_optimize returns norm2 (x) at the minimum, or a negative value if error occurred.
   Dogleg freeContext

Used to deallocate memory used for an optimization cycle. Defined as:
Void dogleg_freeContext (dogleg_solverContext_t** ctx);

If a pointer to a context is not requested (by passing returnContext=NULL to dogleg_optimize), libdogleg calls this routine automatically. If the user did retrieve this pointer, though, it must be freed with dogleg_freeContext when the user is finished.

### Dogleg_testGradient

libdogleg requires the user to compute the jacobian matrix J. This performance optimization, since J could be computed by differences of x. this optimization is often worth the extra effort, but it creates a possibility that J will have a mistake and J=df/dp would not be true. To find these types of issues, the user can call
void dogleg_testGradient (unsigned int var, consta double* p0, unsigned int Nstate, unsigned in Nmeas, unsigned in NJnnz, dogleg_callback_t* f, void* cookie);

This function computes the jacobian with center differences and compares the results with the jacobian computed by the callback function. It is recommended to do this for every variable while developing the program that uses libdogleg.
Var is the index of the variable being tested
P0 is the state vector p when we're evaluating the jacobian
Nstate, Nmeas, NJnnz are the number of state variables, measurements and non-zero jacobian elements, as before
F is the callback function, as before
Cookie is the user data, as before

### Dogleg_callback_t

The main user callback that specifies the optimization problem has type
Typedef void (dogleg_callback_t) (const double* p, double* x, cholmod_sparse* Jt, void* cookie);
P is the current state vector
X is the resulting f(p)
Jt is the transpose of df/dp at p. As mentioned previously, Jt is stored column-first by CHOLMOD, which can be interpreted as storing J row-first by the user-defined callback routine
The cookie is the user-defined arbitrary data passed into dogleg_optimize.

### Dogleg_solverContext_t

This is the solver context that can be retrieved thorugh the returnContext parameter of the dogleg_optimize call. This structure contains all the internal state used by the solver. If requested, the user is responsible for calling dogleg_freeContext when done. This structure is defined as:

Typedef struct
{

| cholmod_common | common; |
|---|---|
| dogleg_callback_t* f; | |
| void* | cookie; |
| // between steps, beforeStep contains the operating point of the last | |
| step. | |
| // afterStep is ONLY used while making the step. Externally, use | |
| beforeStep | |
| // unless you really know what you're doing | |
| dogleg_operatingPoint_t* beforeStep; | |
| dogleg_operatingPoint_t* afterStep; | |
| // The result of the last JtJ factorization performed. Note that JtJ is not | |
| // necessarily factorized at every step, so this is NOT guaranteed to | |
| contain | |
| // the factorization of the most recent JtJ | |
| Cholmod_factor* | factorization; |

| //Have I ever seen a singular JtJ? If so, I add a small constant to the | |
|---|---|
| //diagonal from that point on. This is a simple and fast way to deal | |
| with | |
| // singularities. This is suboptimal but works for me for now. | |
| Int | wasPositiveSemidefinite; |

} dogleg_solverContext_t;

Some of the members are copies of the data passed into dogleg_optimize; some others are internal state. Of potential interest are: Common is a cholmod_common structure used by all CHOLMOD calls, which can be used for any extra CHOLMOD work the user may want to do, and beforeStep contains the operating point of the optimum solution. The user can analyze this data without the need to re-call the callback routine.

dogleg_operatingPoint_t

An operating point of the solver. This is part of dogleg_solverContext_t. Various variables describing the operating point such as p,J,x,norm2(x) and Jt x are available. All of the just-mentioned variables are computed at every step and are thus always valid.

// an operating point of the solver
Typedef struct
{

double* p;
double* x;
double norm2_x;
cholmod_sparse* Jt;
double* Jt_x;
// the cached update vectors. It's useful to cache these so that when
a step is rejected, we can
// reuse these when we retry
double* updateCauchy;
cholmod_dense* updateCauchy_lensq, updateGN_lensq //update
vector lengths
//whether the current update vectors are correct or not
int updateCauchy_valid, updateGN_valid;
int didStepToEdgeOfTrustRegion;

}dogleg_operatingPoint_t;

### Parameters

It is not required to call any of these, but it's highly recommended to set the initial trust-region size and the termination thresholds to match the problem being solved. Furthermore, it's highly recommended for the problem being solved to be scaled so that every state variable affects the objective norm2(x) equally. This make this method's concept of “trust region” much more well-defined and makes the termination criteria work correctly.

dogleg_setMailterations

To set the maximum number of solver iterations, call
Void dogleg_setMaxIterations(int n);
   dogleg_setDebug

To turn on debug output, call
Void dogleg_setDebug(int debug);
   with a non-zero value for debug. By default, debug output is disabled.
   dogleg_setInitialTrustregion

The optimization method keeps track of a trust region size. Here, the trust region is a ball in RANstate. When the method takes a step p->p+delta_p, it makes sure that
Sqrt(norm2(delta_p))<trust region size.

The initial value of the trust region size can be set with
Void dogleg_setInitialTrustregion(double t);

The dogleg algorithm is efficient when recomputing a rejected step for a smaller trust region, so set the initial trust region size to a value larger to a reasonable estimate; the method will quickly shrink the trust region to the correct size.

dogleg_setThresholds

The routine exits when the maximum numbers of iterations is exceeded, or a termination threshold is hit, whichever happens first. The termination thresholds are all designed to trigger when very slow progress is being made. If we all went well, this slow progress is due to us finding the optimum. There are 3 termination thresholds:
The function being minimized is E=norm2(x) where x=f(p).
   dE/dp=2*Jt*x where Jt is transpose(dc/dp).
   if(for every i fabs(Jt_x[i])<JT_X_THRESHOLD)
   {we are done}
The method takes discrete steps: p->p+delta_p
   if (for every i fabs(delta_p[i])<UPDATE_THRESHOLD)
   {we are done}
The method dynamically controls the trust region.
   if (trustregion <TRUSTREGION_THRESHOLD)
   {we are done}

To set these thresholds, call
Void dogleg_setThresholds(double Jt_x, double update, double trustregion);

To leave a particular threshold alone, specify a negative value.

dogleg_setTrustregionUpdateParameters

This function sets the parameters that control when and how the trust region is updated. The default values should work well in most cases, and shouldn't need to be tweaked.

Declaration looks like
void dogleg_setTrustregionUpdateParameters(double downFactor, double downThreshold,
   double upFactor, double upThreshold);

To see what the parameters do, look at evaluateStep_adjustTrustRegion in the source. Again, these should just work as is.

What is claimed is:

1. A system comprising:
an input device;
a detector coupled to a processor and detecting an orientation of the input device, wherein the input device has a plurality of modal orientations corresponding to the orientation, wherein the plurality of modal orientations correspond to a plurality of input modes of a gestural control system, wherein the detector is coupled to the gestural control system and automatically controls selection of an input mode of the plurality of input modes in response to the orientation; and
a calibration object comprising a plurality of sensors, wherein the calibration object receives data used to calibrate the input device.
